(19) United States
(12) Patent Application Publication
(10) Pub. No.: US 2016/0253910 A1
(43) Pub. Date: Sep. 1, 2016

(54) System and Method for Computer Guided Interaction on a Cognitive Prosthetic Device for Users with Cognitive Disabilities

(71) Applicant: Cynthia A. Fisher, Overland Park, KS (US)

(72) Inventor: Cynthia A. Fisher, Overland Park, KS (US)

(21) Appl. No.: 14/633,122

(22) Filed: Feb. 26, 2015

(51) Int. Cl. G09B 5/02; G09B 19/00

(52) U.S. Cl. CPC G09B 5/02; G09B 19/00

(57) ABSTRACT

The present invention provides a computer-implemented system configured by a system user for guided interaction on a cognitive prosthetic support device of a cognitively disabled user whereby the system provides guidance in the performance of a selected task with a plurality of nodes sequentially arranged based upon the selection of an interactive visual cue.

### CROSS-REFERENCE TO RELATED APPLICATION

The present application claims the benefit of the prior filed U.S. provisional patent application No. 61/945,018 filed on Feb. 26, 2014, the contents of which are incorporated herein by reference.

### FIELD OF THE INVENTION

The present invention is broadly directed to computer based problem solving systems for guiding users through a variety of interactions and more particularly, to an improved system and method for using an integrated network of hardware and software to produce a customizable interactive guide to assist the user through a variety of customized problem scenarios.

### BACKGROUND OF THE INVENTION

Various individuals lack sufficient cognitive abilities to process simple routine tasks correctly. For example, some individuals with Autism, Asperger's, Alzheimers, brain injuries or disorders lack sufficient cognitive abilities or lack sufficient temporary, long term, short term or permanent memory. These disabilities act as barriers to encouraging independence as they enter adulthood. Caregivers who look after these individuals do not trust that the disabled individuals are able to live on their own and desire one-on-one support. In some cases the disabled individuals can still perform tasks if they are broken down into a series of simple steps. While many do not need one-on-one support for every task the current model is to provide either one-on-one support or community living without sufficient support. It would be beneficial to utilize modern computerized devices and systems to provide assistance to these disabled individuals who are able to expand their independence, but not yet ready for full independence and help reduce their anxiety and other magnified responses that may occur when problems arise.

Computerized calendar systems or task reminders are generally known and may be helpful. Some of these systems lack sufficient customization for reminding or assisting the cognitively disabled person to make decisions or perform simple problem-solving tasks in the manner of the present invention. Many of these calendar systems are not designed for addressing problems which may occur with cognitively disabled individuals who have a range of cognitive disabilities, ages and may go for prolonged periods of time with little assistance and then unexpectedly require assistance in a variety of contexts while in the middle of a task such as a misplaced personal item, work related issue or obtaining transportation.

Several methods and systems have been developed for reminding an individual to perform a plurality of periodically repeated tasks, including navigational systems, medication alert systems and schedules. Some services and products target the home environment in order to provide intermittent visual check-ins through cameras. Home monitoring systems can incorporate biosensors and geofencing to track, for example, an individual's glucose level, geolocation or activity in the home and which may trigger alerts for remote staff to check on the individual. These are generally unusable by persons with a cognitive disability or memory loss. In addition, some systems have been developed for users with cognitive defects or disabilities. However, many of these systems lack sufficient visual decision building tools, interactive guidance or the ability to monitor or provide assistance from a remote location based upon portable device data obtained during use by a portable device associated with the user.

As students transition into adult life and postsecondary education, self-determination and self-advocacy skills become paramount” (Institute for Community Inclusion at the University of Massachusetts Boston, 2012, para 1).

Barriers to encouraging the independence needed for self-determination and self-advocacy include a lack of flexible supports for students with cognitive disabilities as they transition into adulthood. Some do not qualify for support through adult services, while others are on a waiting list. Many do not need one-on-one support, but the current model is to have a caregiver present or to navigate the community independent.

College campuses most often provide disabilities services and a counseling center, peer mentors (The National Autistic Society, 2013) or a key person (Ferner, 2002). Support groups and student organizations provide opportunities for socialization. While individualized support and the potentially smaller campuses that community colleges offer are especially helpful in reducing stress in learning to navigate a new campus (Harper, 2004), they are not systematically available on a just-in-time basis.

Intended User

This technology is designed for individuals who are independent for periods of time or those individuals who have the potential to be more independent using this caliber of accommodation. Actual use would be applicable for persons with a range of cognitive disabilities, ages, and in a variety of contexts. Elementary aged students, senior citizens, and persons in unfamiliar situations may find this technology useful.

Cognitive Disabilities

Persons with cognitive disabilities are represented by a range of disabilities (Braddock, 2012). Medicaid spending on Intellectual and Developmental Disabilities is over 56 Billion under the Home and Community Based Services waiver.

According to the 2010 Census, 2.2 million college students (10% of the student population) have self-reported as having a disability, most of whom include learning disabilities, intellectual disabilities, autism, and mental health disorders.

Community Participation and Persons with Cognitive Disabilities: A Growing Market Need

Based on statistics from the Center of Disease Control, 6.7 of every 1000 students on college campuses have autism. Because of the increased prevalence rate reported in 2012, this number is expected to increase to 11.3 per 1,000 college students by 2018:

The number of traumatic brain injury (TBI) cases is on the rise. According to 2013 Department of Defense statistics, worldwide numbers for persons in the armed forces experiencing TBI has reached 273,859 since 2000. The vast majority of these cases are mild, which means that individuals are expected to return to duty.

The aging, technology-savvy baby boomer generation representing 26% of the U.S. population in 2011, according to the Pew Research Center (2010), presents a growing need for cognitive supports. Approximately 10,000 persons turn 65 years of age each day; this pace is expected to continue through 2030. As aging in place is the preferred standard for living (and more cost efficient), technologies that support independence are desirable.

Legislation and policy initiatives such as Employment First are evidence that the number of persons with disabilities participating in the community as students and workers will increase. Technology of this design would be ideal for college campus demonstration programs geared to students between the ages of 18 and 25. Additionally, workplace modifications and on-the-job supports such as include job coaching or technology (Hill et al., 2013) are recommended as part of Vocational Rehabilitation services (Hendricks, 2010).

The Problem: Persons with Cognitive Disabilities are Unable to Easily Make Decisions in Everyday Situations

Persons with autism face particular challenges when faced with unexpected situations. To gather background information for the current invention, parents of persons with autism were asked to list things they worried about. Professionals were asked to describe problems individuals with cognitive disabilities faced at work or in the community (See Table 1):

TABLE 1
Informal Survey of Parent and Professional Concerns

| | Interactions With | Academic/ | | Community |
|---|---|---|---|---|
| Skills | Others | Executive Function | Emotional | Participation |
| Parent | Conversations | Distracted Confused | Anxiety | Public dangers |
| responses | Blunt/No filter | Prioritizing | Self esteem | Concept of safety |
| | Teasing/bullying | Concentration | Self control | Easily lost |
| | Communicating | Organization | OCD | Dress for weather |
| | | Memorization Time | | Weather safety |
| | | awareness Think | | Sirens |
| | | things through | | Riding the bus |
| | | Judgement | | Ride is late Event |
| | | Impulsivity | | cancelled |
| | | | | Spending, tips |
| | | | | Concept of money |
| Professional | Communicating | Endurance | Self Control | Seeing food and |
| or non- | Social skills | Focus | Anxiety | wanting it |
| family | Dating | Attention to detail | | Not enough money |
| responses | Boundaries, types | Decision making | | for lunch |
| (employment, | of friendships | Problem solving | | Decision making on |
| friendships; | Customer Service | Quality control | | complex task |
| shopping) | Asking for help | Initiative | | What to do when |
| | Assertiveness | Taking others' point | | finished/look busy |
| | | of view | | Adjusting to |
| | | Spatial awareness | | interruptions or |
| | | Using signage to | | changes in routine |
| | | gain information | | Getting off work |
| | | Awareness of time | | early |

Persons with autism experience (Olney, 2000) difficulty in rapidly shifting attention from one sense to another; anxiety and distress; overreaction to minor frustrations; communication challenges; and anxiety when waiting, changing plans, or transitioning.

Standifer (2009) points to the difficulty a) when communicating frustrations with a situation, b) adjusting to a new aspect of a situation, or c) confusion about the goal, purpose or sequence of an activity. In order for individuals to navigate the community, they need skills and support to deal with unexpected situations.

Standifer (2009) relates these issues to Emmett's functional description of the autism spectrum disorder as: concrete thinking, a distinctive world view of how the world is organized, upset with the least amount of change, a wide range of expressive language skills, a preference for visual processing, and literal interpretations of language. Difficulties include: planning and sequencing, interpreting social signals, expressing emotion, recognizing others' thoughts and emotions, and generalizing a routine from one setting to another.

Across the lifespan, adults with disabilities require a great deal of support. According to parent responses to an Easter Seals (2010) survey, only 30% of adult children with disabilities of all types could perform independent living skills, and only 20% own or rent their residence. Most (70%) live at home, most of whom are between the ages of 18 and 34. Most (80%) parents provide a lot of support on a daily basis, most frequently helping with financial management and transportation. About 30% have paid assistants or caregivers. A third go to school, a third go to work, and a third volunteer, attend day programs for adults with disabilities, or stay home.

Adults with disabilities with some independence experience many struggles and worries. Almost two thirds (65%) of adults with disabilities report that they receive some type of government benefit (Easter Seals, 2010). Most respondents reported owning a cell phone (86%), a computer (95%), and a credit card (75%). More than a third (36%) needed a lot of support from staff, family, and friends. They worry about their financial well-being (86%), quality of life (81%) and independence (81%). Some seek advice about stress and emotion (13%). (Easter Seals, 2010). According to the 2010-2011 National Core Indicators survey, 28% of respondents needed “some” support to manage disruptive behavior, and 30% take medications for anxiety.

College Students with Disabilities

In college, young adults face complicated academic and social environments that require independence and self-sufficiency in asking for support, meeting deadlines, becoming involved in campus life, and caring for themselves (Barr, Timmons, & Opsal, 2009). The accompanying stress leads to problems with sleeping, eating, physical ailments, anxiety, and depression (Hartley, 2011).

Challenges for students with disabilities are “frequently qualitatively different and may take on greater magnitudes” (Ferner, 2002). Youth with autism frequently experience one of many forms of anxiety, most commonly social phobia (Ung, Wood, Ehrenreich-May, Arnold, Fujii, and et al., 2013). Academic resilience is largely impacted by a student's sense of fitting in socially (Hartley, 2011), of particular concern for individuals with autism who struggle to collaborate and manage social settings (Gutstein & Whitney, 2002). For example, they may “become anxious or agitated when other students break an established rule . . . and may attempt to enforce the rules on their own” (Adreon & Durocher, 2007, p. 273).

Prior Art and the Current Invention as a Flexible System of Mobile Supports

Various strategies are implemented in education, usually in combination, to promote success at school or work. New routines are introduced using a visual list of task-analyzed steps. Concepts are commonly taught utilizing graphic organizers, an effective strategy (Knight, Spooner, Browder, Smith, and Wood, 2013). In a problem-solving situation, however, the solution is contextual, necessitating a more complex graphic organizer. A flow-chart format with multiple branches is not easily memorized, nor are they practical for real-life situations.

This technology is a hybrid of established treatments for persons with disabilities. In Findings and Conclusions: National Standards Project (National Autism Center, 2009), 11 treatments were identified as Established Treatments for individuals with Autism Spectrum Disorders, based on several well-controlled studies. Features of the current invention incorporate aspects of Antecedent Package, Self Management, and Story-based Interventions, described as follows:

(a) Antecedent Package includes cueing, prompting and environmental modification of task demands.

(b) Self Management promotes independence with visual prompts.

(c) Story-based Interventions are written descriptions of specific behaviors to occur in particular situations.

TABLE 2
Relationship of Evidence-Based Treatments to Invention

| Evidence-Based | | |
|---|---|---|
| Established | Descriptors of | |
| Treatments | Treatment | Features of Invention |
| Antecedent | Cueing, prompting, | Acts as an environmental |
| Package | environmental | accommodation; modifies |
| | modification | cognitive demands by |
| | of task demands | supporting decision- |
| | | making one component at |
| | | a time. |
| | | Assists in prioritizing. |
| Self-Management | Promotes | User is independent |
| | independence | while taking initial |
| | with visual | steps to solve problem. |
| | prompting | Prompts are visual. |
| | | Celebratory feedback |
| | | provided when problem |
| | | is solved. |
| Story-based | A written | Text provides behavior |
| Interventions | description of | and, in some steps, |
| | specific | scripts to use in that |
| | behaviors to | moment. |
| | occur in | |
| | particular situations | |

Source: National Autism Center, 2009

This application organizes several effective features into one smooth process: (a) This mobile application acts as an environmental accommodation in prompting the person to solve problems one step as a time, with various types of prompts (text, audio, visual, video, and a variety of tools or resources), (b) The user is able to self-manage and receives positive, visual feedback when he or she complete each step and/or solves a problem. She or he chooses if, when, and how to ask for help, (c) The text in each step provides a written description of what needs to happen in that moment along with sample scripts, and visual or multimedia demonstrations.

Recent studies provide evidence for applications with prompting for sequential tasks, scheduling and organization, as well as navigation in the community; they have proven to increase independence in everyday life and employment (Antosh, Riddle, Izzo, and Raynor, 2012; Gentry, 2012; Hill, Belcher, Brigman, Renner, and Stephens, 2013).

Antecedent interventions and self-management skills reduce anxiety and problem behavior (Hill et al. 2013). Examples are visual schedules, task organizers, support for sensory sensitivities, choices, scripts, and advance notice of changes in routine (National Autism Center, 2009). In Hill et al.'s (2013) study, smartphone apps were utilized for organization, task prompting, behavior, anxiety, leisure, and social skills in conjunction with life coaching and therapy. Using an iPad™ as an antecedent intervention was shown to be successful in getting to work and taking medications, thus maintaining independence from family and job coaches (Hill et al., 2013).

Workplace modifications and on-the-job supports are recommended as part of Vocational Rehabilitation services (Hendricks, 2010) which may include job coaching or technology (Hill et al., 2013). Standifer (2009) refers to the usefulness of educational interventions for vocational rehabilitation issues, including a) Carol Gray's Social Stories, narrative descriptions of situations from the first person point of view and b) scripts (Krantz, 2000 and Emmet, 2009, cited in Standifer). Accordingly, prompts within the current invention: a) are written in the first person; and b) provide scripts for the app user when prompted to ask for help in his or her immediate environment.

TABLE 3
Workplace Accommodations

| Workplace Intervention | |
|---|---|
| recommended | Features of Invention |
| Routine and structure | Formatting of the app varies very |
| | little |
| Narrative descriptions in | Prompts and choices are written |
| the first person | in the first person |
| Scripts | Scripts are provided at |
| | appropriate points within the |
| | decision tree. |
| Use caution when prompting | Supports the app user in making |
| to avoid dependence; | decisions. |
| instead, use natural | Does not prompt unless the person |
| supports on the job | initiates a need. The app acts as |
| | an advisor. |
| Extra time to think and | The individual determines the pace. |
| process | |

A personal digital assistant has been utilized as a cognitive aid in persons with severe traumatic brain injury (Gentry, Wallace, Kvarfordt, and Lynch, 2008).

Assistive Technology is “any item, piece of equipment, or product system, whether acquired commercially off the shelf, modified, or customized, that is used to increase, maintain, or improve functional capabilities of individuals with disabilities” (AT Act, 1998). This invention is an AT service, which is “any service that directly assists an individual with a disability in the selection, acquisition, or use of an assistive technology device” (AT Act, 1998).

This application acts as a cognitive prosthetic support for higher level thinking skills. A cognitive prosthetic, briefly defined, is an electronic device that helps a person compensate for communication and/or cognitive impairments that interfere with his or her ability to participate in daily living activities (Institute for Cognitive Prosthetics, 2004).

Patient-Centered Design (Cole, 2013) was shown to dramatically increase cognitive functioning for persons with acquired brain injury by refining the user interface to achieve a good fit between individual user and system. This application allows for individual preferences and needs in a fluid manner.

Existing Technology/Prior Art

Products in this comparison chart (Table 4) represent (a) mobile apps that promote independence at home, in the community or at work (GPS, prompting, scheduling, communication); (b) technology that provides security (through environmental sensors, cameras, phone calls, and video chat) to support independent living at home.

TABLE 4
Comparison with Prior Art

| | Name of Application | | | | | | For use in | | Contextualized |
|---|---|---|---|---|---|---|---|---|---|
| Category | Purpose | | Secondary | | | | real-time, | | solution |
| (see key | Name of Company | Elementary | age | | Steps in | Emergency | non-crisis | Panic | suggested |
| in introduction) | or web site | age | or adult | GPS | a routine | Response | situations | button | by app |
| | Present Embodiment | | x | x | | | x | x | x |
| a | Community Sidekick (GPS) | | x | x | | | x | | |
| | Ablenet | | | | | | | | |
| | My Health (8 topics) Ablenet | x | x | | x | | | | |
| a | Visual Impact (prompting) | x | x | | x | | | | |
| a | Functional Skills System for | x | x | x | x | | | | |
| | Planning or Communication | | | | | | | | |
| | (Conover) | | | | | | | | |
| a | Agile Assyst (Android) | x | x | | x | | x | | |
| a | uChoose app for Social Skills | x | | | | | | | |
| | scenarios (InteractAble) | | | | | | | | |
| b | Therap Services for home | | x | | | | x | | |
| | monitoring | | | | | | | | |
| b | 5 Star Urgent Response | | x | x | | x | x | x | |
| | (greatcall.com) | | | | | | | | |
| | *free app available after signing | | | | | | | | |
| | up | | | | | | | | |
| b | Guardly (guardly.com) | | x | | | x | x | x | |
| b | RaveGuardian/Smart911 | x | x | | | x | | x | |
| | (ravemobilesafety.com, | | | | | | | | |
| | smart911.com by Rave) | | | | | | | | |
| b | Safe Living Technologies | | x | | | x | | x | |
| b | ADT Companion Service | | x | | | x | | x | |
| b | Sengistix (at-home medical | | x | | | x | x | | |
| | monitoring) | | | | | | | | |

| | Name of Application | | | | | Messaging | Requires |
|---|---|---|---|---|---|---|---|
| Category | Purpose | Deals with | Assist with | | Customizable | via call | purchase of |
| (see key | Name of Company | real life | solving problem | Personalized | by | or instant | specialized |
| in introduction) | or web site | scenarios | on own | user info | PROFESSIONAL | message | hardware |
| | Present Embodiment | x | x | x | x | x | |
| a | Community Sidekick (GPS) | x | | | | x | |
| | Ablenet | | | | | | |
| | My Health (8 topics) Ablenet | | | | | | |
| a | Visual Impact (prompting) | x | | | x | | |
| a | Functional Skills System for | x | | | x | | |
| | Planning or Communication | | | | | | |
| | (Conover) | | | | | | |
| a | Agile Assyst (Android) | x | | x | x | x | |
| a | uChoose app for Social Skills | | | | | | |
| | scenarios (InteractAble) | | | | | | |
| b | Therap Services for home | x | | x | x | x | x |
| | monitoring | | | | | | |
| b | 5 Star Urgent Response | x | | x | | | x* |
| | (greatcall.com) | | | | | | |
| | *free app available after signing | | | | | | |
| | up | | | | | | |
| b | Guardly (guardly.com) | x | | x | | x | |
| b | RaveGuardian/Smart911 | x | | x | x | x | |
| | (ravemobilesafety.com, | | | | | | |
| | smart911.com by Rave) | | | | | | |
| b | Safe Living Technologies | x | | x | | | x |
| b | ADT Companion Service | x | | x | | | x |
| b | Sengistix (at-home medical | x | | x | x | | x |
| | monitoring) | | | | | | |

With the current invention, the user tries to solve the problem, which encourages independence and higher self esteem through a continuum of supports which may be accessed based on the situation and the user's immediate frame of mind. He or she is encouraged to try to solve the problem, though a panic button can be utilized at any time. This is how it differentiates from other products currently available. Additional benefits include: the user accesses a smartphone or other mobile technology as peers would do, rather than using a separate, often costly, assistive technology device; it allows freedom to participate in the community independently rather than being limited to leaving home when supervision is available; it allows privacy to resolve an issue, saving embarrassment in asking for help; the user has the opportunity to try on his or her own and have a sense of confidence, yet providing a sense of security by including a safety net; families and users will have more peace of mind; and service providers have a more efficient means of providing support because staff can support several individuals through a remote help desk.

Some references speak to these issues including:
Adreon, D., & Durocher, J. S. (2007). Evaluating the college transition needs of individuals with high-functioning autism spectrum disorders. Intervention in School & Clinic, 42(5), 271-279.
Antosh, T., Riddle, I., Izzo, M., and Raynor, O. (2012). AUCD Transition Symposium: Interdisciplinary, interagency collaboration for transition from adolescence to adulthood (Presentation at 2012 AUCD Annual Conference). http://www.aucd.org/conference/detail/session_event.cfm?session_event_id=403&showday=2.
Barr, S., Timmons, J., and Opsal, C. (2009) Think College for Families: What youth and families should know about the transition to postsecondary education for students with intellectual disabilities (1). http://www.pacer.org/webinars/knowingyouroptions/ThinkCollegeForFamilies.pdf
Boman, I. L., Tham, K., Granvist, A., Bartfai, A., & Hemmingsson, H. (2007). Using electronic aids to daily living after acquired brain injury: A study of the learning process and the usability. Disability and Rehabilitation Assistive Technology, 2(1), 23-33. Doi: 10.1080/17483100600856213 http://informahealthcare.com/doi/abs/10.1080/17483100600856213
Cole, E. (2013). Patient-centered design of cognitive assistive technology for traumatic brain injury telerehabilitation. Synthesis Lectures on Assistive, Rehabilitative, and Health-Preserving Technologies. The Institute for Cognitive Prosthetics. www.morganclaypool.com doi:10.2200/S00478ED1V01Y201302ARH003

Department of Defense and Veterans Brain Injury Center (2013). Dod worldwide numbers for TBI. http://www.dvbic.org/dod-worldwide-numbers-tbi Easter Seals (2010). Living with disabilities. http://es.easterseals.com/site/DocServer/FINAL_Easter_Seals_Living_with_Disabilities_Final_Result.pdf?docID=141355
Ford, C. (2009). An investigation of support programs for college students with high functioning autism or Asperger syndrome [Dissertation]. University of Missouri-Kansas City.
Gentry, T. (2012). The Apple iPod Touch as a vocational support aid for adults with autism: Three case studies. Journal of Vocational Rehabilitation, 37(2), 75-85. Retrieved from http://iospress.metapress.com/content/HG67623860J41421 doi: 10.3233/JVR-2012-0601
Gentry, T., Wallace, J., Kvarfordt, C, & Lynch, B. (2010). Personal digital assistants as cognitive aids for high school students with autism: Results of a community-based trial. Journal of Vocational Rehabilitation, 32(2), 101-107.
Gentry, T., Wallace, J., Kvarfordt, C, & Lynch, B. (2008). Personal digital assistants as cognitive aids for individuals with severe traumatic brain injury: A community-based trial. Brain Injury, 22(1), 19-24. Doi: 10.1080/02699050701810688 http://informahealthcare.com/doi/abs/10.1080/02699050701810688
Gutstein, S. E., & Whitney, T. (2002). Asperger Syndrome and the development of social competence. Focus on Autism & Other Developmental Disabilities, 17(3), 161-172.
Harper, J., Lawlor, M., & Fitzgerald, M. (2004). Succeeding in college with Asperger Syndrome: A student guide. New York: Kingsley.
Hartley (2013). Investigating the relationship of resilience to academic persistence in college students with mental health issues. Rehabilitation Counseling Bulletin, 56(4), 243-250. Doi: 10.1177/0034355213480527
Hartley (2011). Examining the relationships between resilience, mental health, and academic persistence in undergraduate college students. Journal of American College Health, 9(7), 596-604.
Hendricks, D. (2010). Employment and adults with autism spectrum disorders: Challenges and strategies for success. Journal of Vocational Rehabilitation, 32, 125-134.
Hill, D. A. Belcher, L., Brigman, H. E., Renner, S., Stephens, B. (2013). The Apple Ipad™ as an innovative employment support for young adults with autism spectrum disorder and other developmental disabilities. Journal of Applied Rehabilitation Counseling, 44(1). 28-37.
Huskens, B., Verschuur, R., Gillesen, J., Didden, R., & Barakova, E. (2013). Promoting question-asking in school-aged children with autism spectrum disorders: Effectiveness of a robot intervention compared to a human-trainer intervention. Developmental Neurohabilitation. Doi: 10.3109/17518423.2012.739212 http://informahealthcare.com/doi/abs/10.3109/17518423 0.2012.739212
Institute for Community Inclusion at the University of Massachusetts Boston (2012). Think college: For professionals. Self determination resources. www.thinkcollege.net/for-professionals/self-determination-resources
Knight, V. F., Spooner, F., Smith, B. R., Wood, C. L., (2013). Using systematic instruction and graphic organizers to teach science concepts to students with autism spectrum disorders and intellectual disability.
Focus on Autism and Other Developmental Disabilities, 28(2), 115-126. Doi: 10.1177/1088357612475301 Lee, S. S. (2009). Think college! Policy brief: Overview of the federal higher education opportunities act reauthorization. www.ahead.org/uploads/2009/Concurrent %20Block %204/4.4%20Handout %201.pdf
Lund, M. L., Lovgren-engstrom, A., & Lexell, J. (2011). Using everyday technology to compensate for difficulties in task performance in daily life: Experiences in persons with acquired brain injury and their significant others. Disability and Rehabilitation Assistive Technology 6(5), 402-411. Doi: 10.3109/17483107.2011.574309
National Autism Center (2009). Findings and conclusions: Addressing the need for evidence-based practice guidelines for Autism Spectrum Disorders (National Standards Report). Retrieved from http://www.nationalautismcenter.org/nsp/reports.php
Olney, M. (2000) Working with Autism and Other Social Communication Disorders, Journal of Rehabilitation, 66(4), pp. 51-56.
Palmen, A., Didden, R., & Verhoeven, L. (2012). A personal digital assistant for improving independent transitioning in adolescents with high-functioning autism spectrum disorder, 15(6), 401-413. Doi: 10.3109/17518423.2012.701240 http://informahealthcare.com/doi/abs/10.3109/17518423 0.2012.701240
Perner, L. (2002). Preparing to be nerdy where nerdy can be cool: College planning for students on the Autism Spectrum. www.professorsadvice.com
Pew Research Center (2010, Dec. 29) Baby boomers retire. http://www.pewresearch.org/daily-number/baby-boomers-retire/
Sigafoos, J., O'Reilly, M. F., Seely-York, S., Weru, J., Son, S. H., Green, V. A., & Lancioni, G. E. (2004). Transferring AAC intervention to the home. Disability and Rehabilitation, 26(21-22), 1330-1334. Doi: 10.1080/09638280412331280361 http://informahealthcare.com/doi/abs/10.1080/09638280412331280361
Standifer, S. (2009). Adult autism and employment: A guide for vocational rehabilitation professionals. Disability Policy and Studies, School of Health Professions, University of Missouri. http://www.dps.missouri.edu/Autism/Adult %20Autism %20&%20Employment.pdf
Stock, S. E., Davies, D. K., Wehmeyer, M. L., & Lachapelle, Y. (2011). Emerging new practices in technology to support independent community access for people with intellectual and cognitive disabilities. NeuroRehabilitation, 28, 261-269. Doi: 10.3233/NRE-2011-0654
The Rehabilitation Engineering Research Center on Communication Enhancement (AAC-RERC) (2013) What is Assistive Technology? http://aac-rerc.psu.edu/index.php/pages/show/id/7
The National Autistic Society (2013) College and university: Supporting students with Asperger Syndrome. http://www.autism.org.uk/working-with/education/education-professionals-in-fe-and-he/college-and-university-supporting-students-with-asperger-syndrome.aspx
Ung, D., Wood, J. J., Ehrenreich-May, J., Arnold, E. B., Fujii, C., Renno, P., Murphy, T. K., Lewin, A. B., Lewin, A. B., Mutch, P. J., & Storch, E. A. (2013). Clinical characteristics of high-functioning youth with autism spectrum disorder and anxiety. Neuropsychiatry, 3(2), 147-157. doi: 10.2217/npy.13.9 http://www.futuremedicine.com/doi/abs/10.2217/npy.13.9
Yglesias, M. (2012). Within five years, all phones will be smartphones. Slate Moneybox: A Blog About Business and Economics. http://www.slate.com/blogs/moneybox/2012/04/11/allphones will be smartphones within five_years.html

### SUMMARY OF THE INVENTION

The present invention provides a computer-implemented system configured by a system user for guided interaction on a cognitive prosthetic support device of a cognitively disabled user whereby the system provides guidance in the performance of a selected task, said system comprising: a computer store processing and retrievably storing system data for each of a plurality of interactive nodes wherein each said node presents a plurality of visual cues, said nodes being sequentially arranged and said visual cues being interactive and corresponding to a discrete subpart of the selected task to be performed; said plurality of interactive nodes comprising at least a first node, a second node and a success node guide said cognitively disabled user in performing the selected task; wherein said first node is presented on the cognitive prosthetic support device with a first visual cue; said first visual cue being adapted for selection by the cognitively disabled user, whereupon selection of said first interactive visual cue presents a second node on the cognitive prosthetic support device having a second interactive visual cue; said second node being sequential to said first node; and said second interactive visual cue being adapted for selection by the cognitively disabled user, whereupon selection of said second interactive visual cue presents a success node on the cognitive prosthetic support device having a task completion cue corresponding to the performance of the selected task by the cognitively disabled user.

Upon receiving a user request, the system will provide commonly formatted step by step graphical indications about solutions to programmed tasks. Upon receiving a user request, the system will provide positive visual feedback upon the successful completion of each programmed step or task. In addition, the system will provide textual instructions in the first person point of view to guide the cognitively disabled user through the task along with the visual cues. The cognitive prosthetic support device may also utilize a variety of available information which will allow to system to generate an immediate response from a remote device which may access the mobile device to obtain a plurality of inputs including video, audio, textual and operational related data in order to provide an appropriate real-time response. The distributed architecture supports interactive communication with a remote terminal in verbal and electronic communication with a plurality of cognitive prosthetic support devices.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

FIG. 1 is a diagram of an exemplary environment in which the systems or methods described herein may be implemented.

FIG. 2 is diagram of exemplary components of a device that may be used within the environment of FIG. 1.

FIG. 3 is a flowchart of an example process for receiving and storing user information through a web portal into an example system described herein.

FIG. 4 is a flowchart of an example portable device interface process for interaction between an exemplary portable device and an example system described herein.

FIG. 5 is a flowchart of an example process for processing data information from content provider such as that shown in FIG. 3 by an example system described herein.

FIG. 6 is a flowchart of an example process for a portable device process in an example system described herein.

FIG. 7 is a flowchart of an example process for a super user web portal in an example system described herein.

FIG. 8 is a flowchart of an example process for a remote user system web portal in an example system described herein.

FIG. 9 is a flowchart of an example process for a remote user account web portal in an example system described herein.

FIG. 10 is a flowchart of an example process for a user-admin web portal in an example system described herein.

FIG. 11 is a flowchart of an example screen navigation for a user-admin in an example system described herein.

FIG. 12 is a flowchart of an example screen navigation for a sign-up process in an example system described herein.

FIG. 13 is a flowchart of an example screen navigation for an admin user in an example system described herein.

FIG. 14 is a flowchart of an example screen navigation for a cognitively disabled user in an example system described herein.

FIG. 15 is an exemplary log-in user screen in an example system described herein.

FIG. 16 is an exemplary create user screen in an example system described herein.

FIG. 17 is an alternative create user screen in an example system described herein.

FIG. 18 is an exemplary create user verification screen in an example system described herein.

FIG. 19 is an exemplary user dashboard welcome screen in an example system described herein.

FIG. 20 is an exemplary user profile account screen in an example system described herein.

FIG. 21 is an exemplary user dashboard summary screen in an example system described herein.

FIG. 22 is an exemplary user FAQ user screen in an example system described herein.

FIG. 23 is an exemplary user tutorial screen in an example system described herein.

FIG. 24 is an exemplary user profile account screen in an example system described herein.

FIG. 25 is an exemplary user profile add contact screen in an example system described herein.

FIG. 26 is an exemplary user profile contact summary screen in an example system described herein.

FIG. 27 is an exemplary user profile account screen in an example system described herein.

FIG. 28 is an exemplary super-admin user lockout screen in an example system described herein.

FIG. 29 is an exemplary email password screen in an example system described herein.

FIG. 30 is an exemplary reset password screen in an example system described herein.

FIG. 31 is an exemplary create new password screen in an example system described herein.

FIG. 32 is an exemplary super-admin accounts summary screen in an example system described herein.

FIG. 33 is an exemplary super-admin account listing screen in an example system described herein.

FIG. 34 is an exemplary super-admin account detail screen in an example system described herein.

FIG. 35 is an exemplary super-admin account detail, add contact screen in an example system described herein.

FIG. 36 is an exemplary super-admin account listing filter screen in an example system described herein.

FIG. 37 is an exemplary account profile medical information configuration screen for call center user in an example system described herein.

FIG. 38 is an exemplary account profile skill level configuration screen for call center user in an example system described herein.

FIG. 39 is an exemplary account profile trigger information configuration screen for call center user in an example system described herein.

FIG. 40 is an exemplary account profile habit configuration screen for call center user in an example system described herein.

FIG. 41 is an exemplary account profile call center tips configuration screen for call center user in an example system described herein.

FIG. 42 is an exemplary emergency contacts configuration user screen in an example system described herein.

FIGS. 43-44 are exemplary paid user display settings configuration screens in an example system described herein.

FIG. 45 is an alternative tutorial user screen in an example system described herein.

FIG. 46 illustrates an exemplary remote device welcome screen in an example system described herein.

FIG. 47 illustrates an exemplary remote device login screen in an example system described herein.

FIG. 48 illustrates an exemplary remote device password reset login screen in an example system described herein.

FIG. 49 illustrates an exemplary remote device password reset acknowledgement login screen in an example system described herein.

FIG. 50 illustrates an exemplary remote device profile screen in an example system described herein.

FIG. 51 illustrates an exemplary remote device problem screen in an example system described herein.

FIG. 52 illustrates an exemplary remote device alternative problem screen in an example system described herein.

FIG. 53 illustrates an exemplary remote device home screen in an example system described herein.

FIG. 54 illustrates an exemplary remote device problem solving screen in an example system described herein.

FIGS. 55-66 illustrates exemplary remote device I AM LOST problem solving screens in an example system described herein.

FIGS. 67-83 illustrate exemplary remote device I LOST SOMETHING problem solving screens in an example system described herein.

FIG. 84 illustrates an alternative exemplary remote device create account user screen in an example system described herein.

FIG. 85 illustrates the alternative exemplary remote device account profile configuration screen in an example system described herein.

FIG. 86 illustrates the alternative exemplary remote device visual configuration screen in an example system described herein.

FIG. 87 illustrates the alternative exemplary remote device user account upgrade screen in an example system described herein.

FIG. 88 illustrates the alternative exemplary remote device alternative user account upgrade screen in an example system described herein.

FIG. 89 illustrates the alternative exemplary remote device tutorial screen in an example system described herein.

FIG. 90 illustrates the alternative exemplary remote device remote user dashboard screen in an example system described herein.

FIG. 91 illustrates the alternative exemplary remote device color configuration screen in an example system described herein.

FIG. 92 illustrates the alternative exemplary remote device character configuration screen in an example system described herein.

FIG. 93 illustrates the alternative exemplary remote device screen settings configuration screen in an example system described herein.

FIG. 94 illustrates the alternative exemplary remote device home screen in an example system described herein.

FIG. 95 illustrates the alternative exemplary remote device MY DAY user screen in an example system described herein.

FIG. 96 illustrates the alternative exemplary remote device MY STRATEGIES user screen in an example system described herein.

FIG. 97 illustrates the alternative exemplary remote device WHERE AM I user screen in an example system described herein.

FIG. 98 illustrates the alternative exemplary remote device user FEEDBACK screen in an example system described herein.

FIG. 99 illustrates the alternative exemplary remote device user CONTACTS screen in an example system described herein.

FIG. 100 illustrates the alternative exemplary remote device CALL HELP user screen in an example system described herein.

FIG. 101 illustrates the alternative exemplary remote device CALL CENTER RESPONSE user screen in an example system described herein.

FIG. 102 illustrates the exemplary remote device graphical navigation user screen in an example system described herein.

FIG. 103 illustrates the exemplary remote device Success user screen in an example system described herein.

FIG. 104 illustrates the exemplary remote device ASK STRANGER user screen in an example system described herein.

FIG. 105 illustrates the exemplary remote device alternative ASK STRANGER user screen in an example system described herein.

FIG. 106 illustrates the exemplary remote device second alternative ASK STRANGER user screen in an example system described herein.

FIG. 107 illustrates the exemplary remote device CALL BACKUP user screen in an example system described herein.

FIG. 108 illustrates the exemplary remote device CALL BACKUP CONTACT LISTING user screen in an example system described herein.

FIG. 109 illustrates the exemplary remote device alternative CALL BACKUP user screen in an example system described herein.

FIG. 110 illustrates the exemplary remote device CALLING BACKUP user screen in an example system described herein.

FIG. 111 illustrates the exemplary remote device user survey screen in an example system described herein.

FIG. 112 illustrates the exemplary MY DECISION TREES user screen in an example system described herein.

FIG. 113 illustrates the exemplary MY DECISION TREES review screen in an example system described herein.

FIG. 114 illustrates the exemplary MY DECISION TREES configuration screen in an example system described herein.

FIGS. 115-116 are an exemplary flow chart illustrating the exemplary decision tree in an example system described herein.

FIG. 117 illustrates an alternative exemplary MY DECISION TREES configuration screen in an example system described herein.

FIG. 118 is an exemplary flow chart illustrating the exemplary decision tree in an example system described herein.

FIG. 119 is an exemplary flow chart illustrating the exemplary decision tree in an example system described herein.

FIG. 120 is an exemplary flow chart illustrating the exemplary decision tree in an example system described herein.

FIG. 121 is an exemplary flow chart illustrating the exemplary decision tree in an example system described herein.

FIG. 122 is an exemplary flow chart illustrating the exemplary decision tree in an example system described herein.

FIG. 123 is an exemplary flow chart illustrating the exemplary decision tree in an example system described herein.

FIG. 124 illustrates another alternative exemplary MY DECISION TREES configuration screen in an example system described herein.

FIG. 125 illustrates adding media in the alternative exemplary MY DECISION TREES configuration screen in an example system described herein.

FIG. 126 illustrates adding media to a configuration in another alternative exemplary MY DECISION TREES configuration screen in an example system described herein.

FIG. 127 illustrates a graphical media editor in association with a media library for the MY DECISION TREES configuration screen as further described herein.

FIG. 128 illustrates an alternative view of the graphical media editor in association with a media library for the MY DECISION TREES configuration screen as further described herein.

FIG. 129 is an exemplary flow chart illustrating the exemplary decision tree in an example system described herein.

FIGS. 130, 131 illustrate alternative views of the graphical media editor in association with a media library screen as further described herein.

FIGS. 132-134 illustrates alternative a graphical organizational editor in association with the MY DECISION TREES configuration screens as further described herein.

FIGS. 135-138 illustrates a organized popup screens in association with MY DECISION TREES configuration screen as further described herein.

FIGS. 139-140 illustrates some exemplary user forum screen as further described herein.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Introduction

In a typical invention, purely computerized applications to the extent they are considered mathematical algorithms and human cognitive functions are unpatentable. With regard to the present invention, the intended user also referred to herein as a cognitively disabled user lacks sufficient cognitive function and therefore would benefit from a prosthetic. This invention takes a task which involves complex cognitive processes and dissects them into discreet subparts which allow for a cognitively impaired user to perform the task based upon decisions made in a progressive nature using visual aids displayed on a portable electronic device which allows for system interaction in preforming the desired task., The systems provides the deficient cognitive elements which are missing from the cognitively impaired user. The systems transforms what would be otherwise normal conative skills into a format that are useable for persons that are no longer able to process information in a typical fashion. If the executive function is lacking or not functioning, the intended user can become overwhelmed with everyday situations. The present system provides for real time guidance and monitoring in a manner that a human cannot. It has the advantage of combining a variety of types of data in unique and customizable ways to assist the cognitively disabled person. In some situations some may believe that an in-person caregiver would be able to provide all of the features of the present invention. However, an in-person caregiver would not be able to provide the benefits of the present invention because they would not have all relevant information which is immediately available with the present system to assist the cognitively disabled user perform the selected task in real time. Additionally, information and aids produced in a non-technical format such as on paper are not practical or useful to individuals with limitations in cognitive function because the information would be provided all at once for all of the desired tasks which a cognitively disabled user may have to face, in a manner which it is not designed nor adapted to be portable for use throughout the day. There is no known process or system which is able to divide commonly preformed tasks into a comprehensible step-by-step guide for cognitively challenged users while remaining portable and adaptable to a number of changing environmental and contextual factors while providing for customization based on various user preferences which may be required for presentation to a cognitively disabled user.

There is currently a need for a new type of guided information that can be provided to cognitive disabled users to preform simple tasks using computer-based devices that is not available by previously existing means. Previously, cognitively disabled users were limited to having a chaperon or caregiver with them at all times or if they were able to perform some tasks independently, they were limited in terms of geography, time and complexity without regard to their specific cognitive disability.

Electronic devices offer immediate access to all sorts of relevant information in response to a specific question which is entered directly into the electronic device. In addition, modern electronic devices have a number of different sensors, inputs or outputs which can provide for remote monitor and controlling of surrounding objects and conditions. However, these new kinds of devices need a lot of personalization and configuration by the user of the device which is not typically available from a cognitively disabled user and which a cognitively disabled user would find difficult, if not impossible to utilize or configure themselves (especially via remote devices).

Some of the benefits of the current invention include providing guidance to individuals dealing with contextually-based problems through an adaptable platform that provides remote support based on individual preferences and needs; Providing for centrally managed decision trees which are stored on a database connected to a computer; Providing custom decision trees based on user characteristics which can be distributed over a network to a plurality of networked devices for real-time guidance; Allow for customization of the decision trees by a plurality of caregivers familiar with the cognitive disabled user; Provide for real-time and historical tracking of user activity and successes as well as failed attempts; Refinement of decision tree based on analysis of historical and real-time activity; Delivery of customized or configurable digital media content which can be embedded in decision trees to facilitate user performance.

As has been explained in further detail below, one embodiment of the disclosed technology provides a convenient way for a cognitively disabled user to obtain geographic guidance to complete a preconfigured task. However, additional guidance may be provided via other sensors or other system features or contact communication center. The guidance can be provided by using information which is gathered by the cognitive prosthetic support device according to the previously configured steps retrievably stored within the content database or with the additional information or guidance provided by a remote operator 130 monitoring the reaction of the cognitively disabled to the depiction of a previously configured steps such as “I AM LOST” and “MY RIDE IS LATE.”

As used herein a preconfigured task can be virtually anything that involves a routine step by step process of the user and which can be correlated to some input sensor such as but not limited to a geographic, motion, ambient, audible or other available input sensors of the cognitively disabled prosthetic device. As explained in the description below, the system 10 allows for the creation of display aids based upon the selection of standardized system provided flow trees or based upon customization of the provided flow trees or creation of customized flow trees. The system generated display aids may include, but is not limited to categorical, geographical, chronological, schedule, occupational, social or habitual graphical elements for display on the cognitively disabled prosthetic device. Further the display aids may include customized graphical cues to assist the cognitively disabled user in performing the desired task which may include but is not limited to a geographical indication, animation, text, visual presentations, photographic information, colors, patterns, or any other thing that can be associated with some process related information.

As used herein, the term cognitive prosthetic support device 114 means an hand held portable electronic device such as, but not limited to a cellphone, tablet, PDA in network communication with the system which provides a supplementation or augmentation of the impaired cognitive abilities of the cognitively disabled user 117.

The term decision tree 123 is to be interpreted broadly and can include a flow chart or diagram which maps out a task based upon a number of decisions with each decision having a discrete steps required to perform that task and may involve a number of optional choices using environmental variables.

A cognitively disabled user 117 generally includes those with disabilities caused by a impaired cognition. Generally this is a person with a cognitive disability and is associated with a cognitive prosthetic support device for networked communication with the system 110 and may include but is not limited to persons diagnosed with autism spectrum disorder, Aspergers, Down syndrome, intellectual disabilities, developmental disabilities, Alzheimers, dementia, aging, mental and/or emotional disorders, post traumatic stress disorder, traumatic brain injury, Attention Deficit Disorder, Attention Deficit Disorder with Hyperactivity, learning disabilities.

A system user 128 generally includes anyone who has a need to access the system 110 and may include a parent, guardian, caregiver, adult service agency staff, paid caregiver, unpaid caregiver, agency admin, or other professional associated with a cognitively disabled person. Generally they will have access to the app content and the social networking page. Additional app features/content and privileges for the sharing pages (media library) depend on the subscription plan and other premium purchases they have selected. Their role may include but is not limited to helping a cognitively disabled person 117 person sign up and complete a profile. They may make purchases on behalf of the user or for a group of users. They may create task flows. They may be also listed as an Emergency Contact. This person could be a family member, a case manager, a professional, an agency representative. They will have their own login info. Agency Admin: This person can buy licenses or purchase upgrades on behalf of a User or group of Users. They do not have access to personal user account information that is protected by HIPAA. Examples: a college campus administrator, an insurance company, or other person who does not have direct contact with Users.

Emergency Contact: A person who is listed in an individual account in the section labeled Emergency Contacts. The user or caregiver would determine who is an Emergency Contact. This could include family members, neighbors, Caregivers, an agency, a hotline, ask-a-nurse, the vet, school, etc.

A remote operator or remote user may include a person located at a remote location from the system 110 and who must obtain a network connection to the system 110 in order to access or provide support. This may include but is not limited to a staffing a call center who responds to requests for help when the user presses the help button. This is not an Emergency Contact but the 24/7 call center representative. An agency could license the software and run their own call center. They have access to account history but may or may not have access to financial information, depending on permissions granted in a given situation.

An admin user 129a is a person who maintains, installs, creates or manages the system 110. This person may manage the computers, network, billing features, database or database servers. They can view groups of accounts or individual accounts. They can create task flows. Generally they do not necessarily interact with the cognitively disabled user 117 unless the user 117 needs help with billing or other practical functions related to the account or the technology. The admin user 129a could be office staff, employees or contractors involved in managing the system 110.

By creating the display aid based upon the configured decision tree the cognitively disabled user's reaction to one or more task displayed at the cognitively disabled prosthetic device can be predicted in an easy and intuitive way and with the receipt of additional sensory information from the cognitively disabled prosthetic device such as location or speed, the remote operator 130 can infer and if necessary monitor and selectively assist the cognitively disabled user's performance.

The user may also create an avatar, which has a number of actual or desired associated visual characteristics. In one embodiment of this, the avatar can be displayed on the cognitively disabled prosthetic device and used to guide the cognitively disabled user to complete the tasks presented through the step by step display aid.

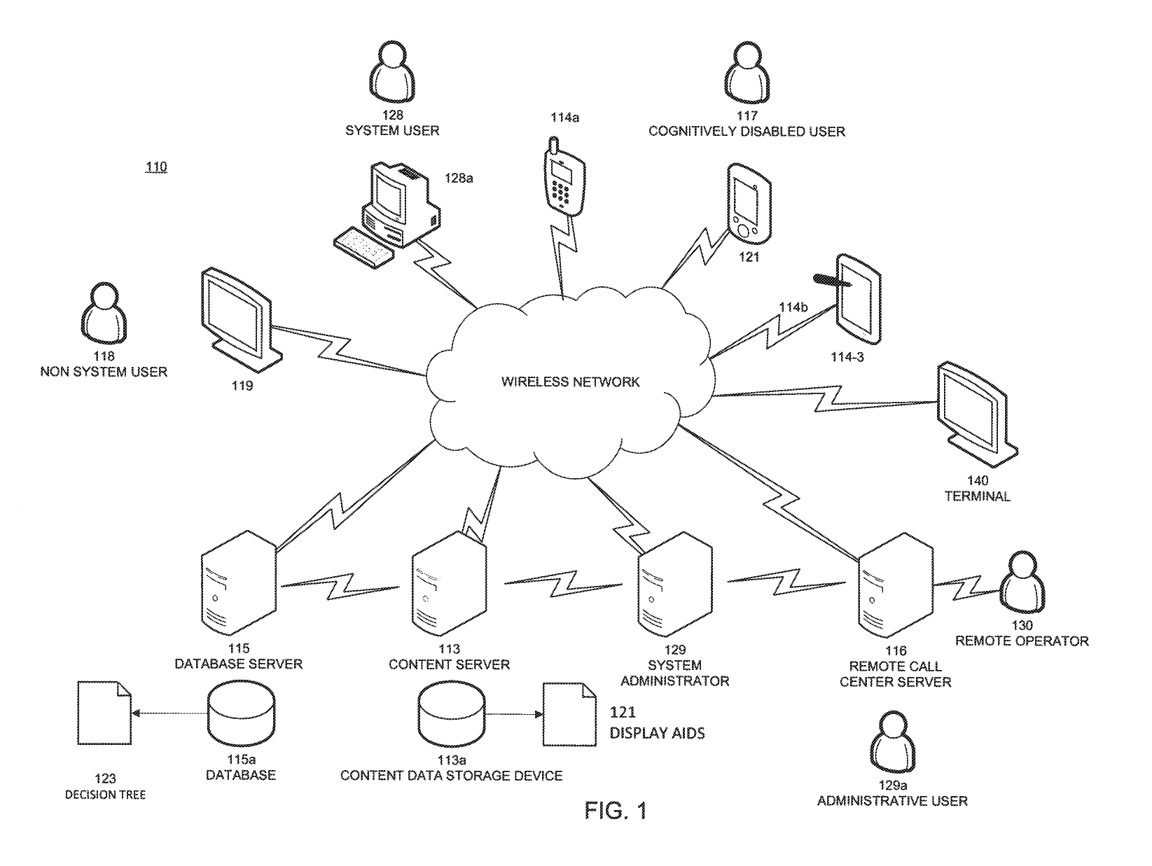

Referring to the drawings in more detail, the reference numeral 110 generally refers to an embodiment of the system and method for computer guided interaction on a cognitive prosthetic device for users with cognitive disabilities. The implementation described herein, may use one or more communication protocols to transmit and collect data for use by the system 110 to process and generate relevant display aids 121 transmitted to and displayed on a cognitive prosthetic support device 114a, 114b which as illustrated on FIG. 1 includes a PDA, phone or tablet. The communication protocols may be set by the user 117 of the device 114a, 114b; a remote operator 130, a network provider (not shown) or a third party provider to transmit data and information between the device 114 and a terminal 140 adapted for use by the remote operator 130.

The exemplary environment in which systems or methods described herein may be implement may include devices 114-1, 114-2, 114-3, . . . , 114-N (where N>1) (collectively referred to as cognitive prosthetic support devices or devices 114 or individually as cognitive prosthetic support device or device 114), and one or more content server(s) 113 in communication with a storage device 113a, a database server 115 hosting a database 115a, a remote operator 130 such as but not limited to a call center 116 or other remote operator 130 in electronic communication with the system 110 all of which can be connected to a network 111. While FIG. 1 shows a particular number and arrangement of devices, in practice, environment 100 may include addition, fewer, different, or differently arranged devices than are shown in FIG. 1. For example, each of the servers, 115, 113, 111 may be implemented as multiple, possibly distributed, devices or they may be implemented within a single device.

FIG. 1 is a diagram of an overview of an implementation described herein. As shown in FIG. 1, the cognitive prosthetic support device 114 associated with a cognitively disabled user 117 may display instructions using step by step display aids 121 which optionally may include a plurality of visual cues to guide the cognitive disabled user 117 through the performance of preselected tasks associated with system 110 provided through a plurality of decision trees 123 provided through the system administrator computer 129 to the database server 115 and retrievably stored on the database 115a. Upon completion of the display aid 121 associated with the preselected task a successful completion notice may be provided by the system 10 upon the cognitive prosthetic support device.

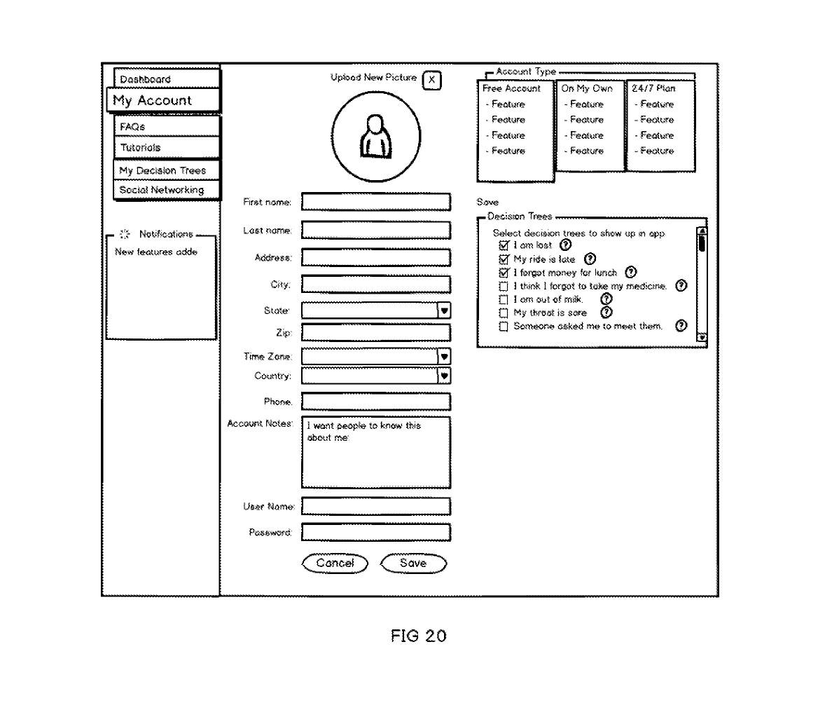

Prior to activation of the device 114 by the system 110 the decision trees are retrieved from a storage device 113a on the system 110. Each display aid 121 corresponds to a selected task from a list of available tasks. In response to the selection of a particular desired task the decision tree 123 is retrieved from the database 115a and displayed on the system computer 128a for review and if necessary modification using the system 110 as further described below. Once completed, the decision tree 123 is then processed by the system computer 128a and retrievably stored by the content database 113a. Alternatively, the admin user may customize or create various decision trees 123 associated with desired tasks for retrieval by various system users 128 as desired. The retrieved decision tree 121 will be based upon the selected decision trees from a list of decision trees as illustrated in FIG. 20. Once the system user 128 selects which the desired decision trees, the system 110 will transmit the display aids 121 from the processing by the system 110 of the selected decision trees 123. Once processed, the display aids 121 are then transmitted to the cognitive prosthetic support device 114 for display and use by the cognitively disabled user 117 to perform the desired task during non-crisis situations reducing stress, anxiety and embarrassment and encouraging independent living by the cognitively disabled user 117.

The display aids 121 are created from decision trees 123 retrievably stored on the relational database 115a by admin user 129a and as selected by each registered system user 128 using the system computer 128a. The system computer may include traditional computing components in addition to being in authenticated networked communication with the system 110 for display and configuration of various user account display screens and being in further communication with at least one cognitive prosthetic support device 114 for receipt of the selected display aids 121 processed form the decision trees retrieved form the database 115a.

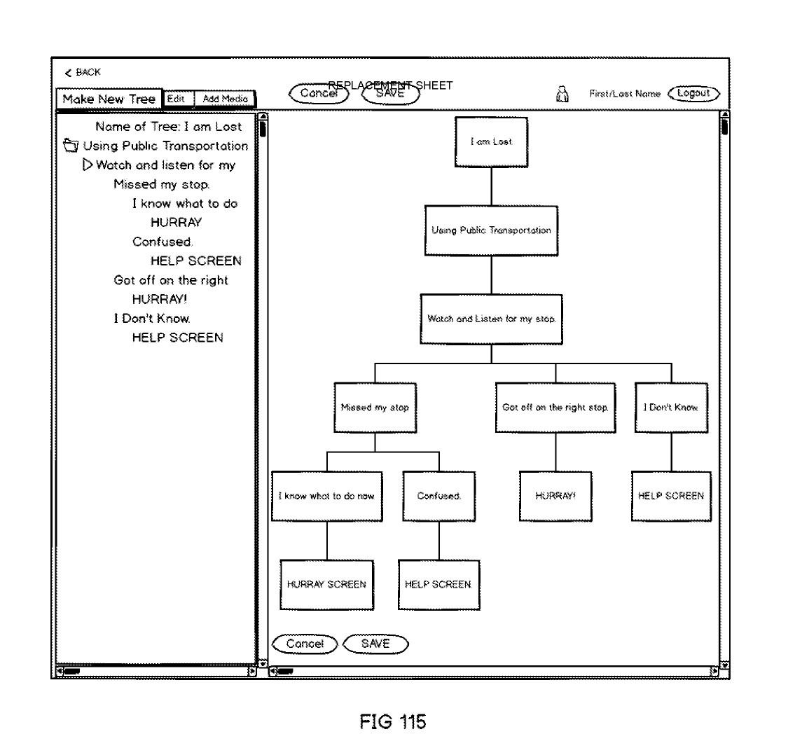

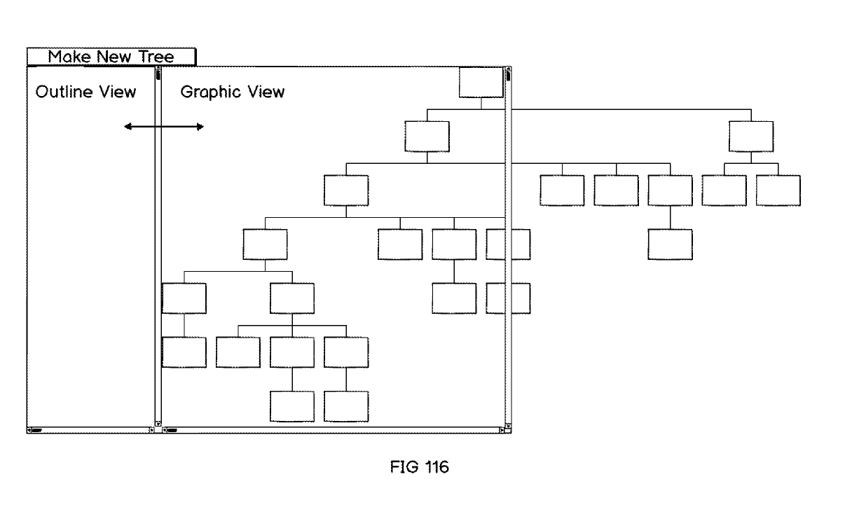

The decision trees 123 may be created using the decision tree configuration screen an example of which is illustrated in FIGS. 115-116 by an administrative user 129a using the system administrator computer 129 which is in networked communication with the system 110. Each of the display aids 121 is processed from each of the selectively configured decision trees 123 by the system user 128 with for example the web portal computer 119 in networked communication with the system 110. Once processed, content data associated with each of the display aids 121 is retrievably stored on the storage device 113a connected to the content server 113. The decision trees 123 may be in the form of a standardized template for selective configuration by the system user 128 or may be customized as desired.

As further illustrated in FIG. 1, the cognitive prosthetic support device 114 may include any device capable of communicating via a network, such as network 111. For example, device 114 may correspond to an internet device, a personal computer including desktops, all-in-ones, laptops, tablets or a mobile communication device such as, but not limited to, a cell phone, a personal digital assistant (PDA), a smartphone or another type of portable device such as wearable technology, with the ability to be networked using a wireless network 112 including telephony networks, for communication with the system 110 to receive graphical display aids 121 and assist in step-by-step cognitive support.

The network 111 may generally include logic to provide wireless access for devices 114. Through the network 111, device 114 may for instance communicate with one another, e.g. a voice call, email, visual, audio or text messaging, chat, access services through IP network and/or complete telephone calls through traditional telephone networks such as a public switched telephone network (PSTN). Network 111 may be a network that provides wireless (radio) interface to devices 114 using the 3G or 4G mobile telecommunications standards. An implementation of 4G network may include one or more elements through which devices 114 may wirelessly connect to receive telecommunication services.

Although FIG. 1 shows example components, other implementations may contain fewer components, different components, differently arranged components, or additional components than depicted in FIG. 1. Alternatively, or additionally, one or more components may perform one or more tasks described as being performed by one or more other components.

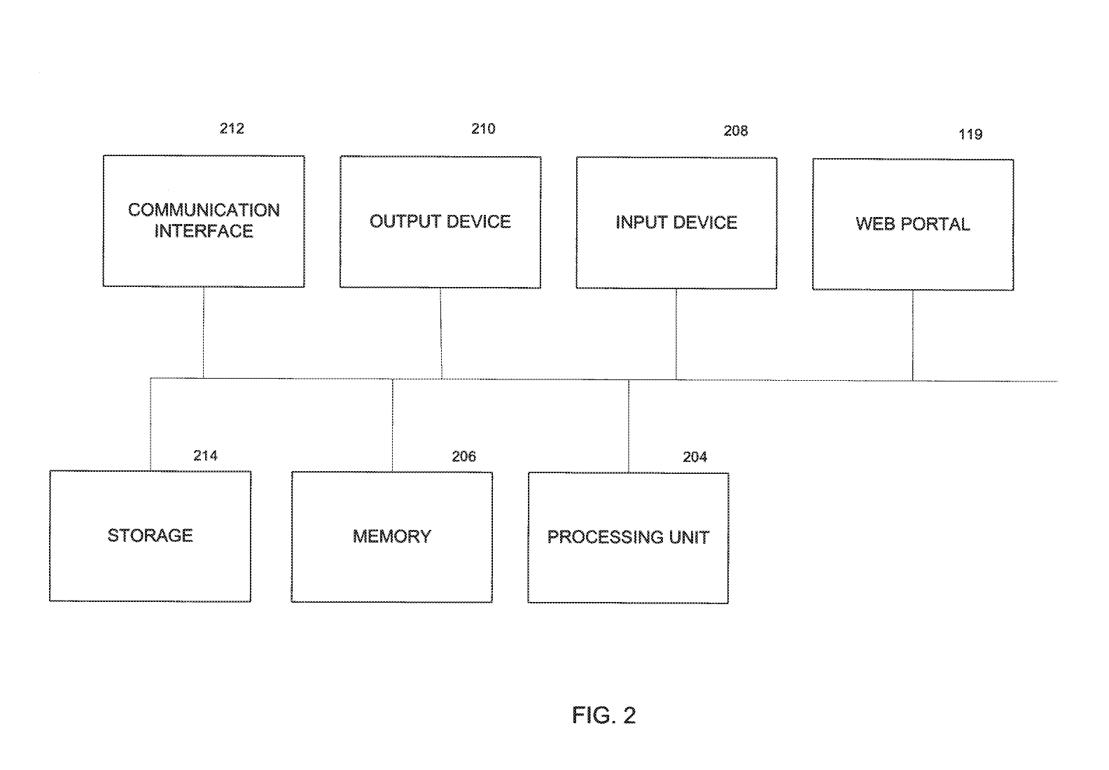

FIG. 2 is a diagram of example components of a device 200 that may be used within the environment of FIG. 1. Device 200 may correspond to a web portal 118 or a system server such as a content server 113, database server 115, remote server 116 or any other system server desirable in the present invention. Each of the above referenced servers may include one or more devices 200. Device 200 may include a bus 202, a processing unit 204, a memory 206, an input device 208, an output device 210, a communication interface 212, a storage device 214 all utilized by the web portal 118. In another implementation, device 200 may include additional, fewer, different or differently arranged components. Bus 202 may include a path, or collection of paths that permits communication among the components of device 200. Processing unit 204 may include one or more processors, sockets, fractional processors or microprocessors that interpret and execute instructions. Additionally or alternatively, processing unit 204 may be implemented as or included in one or more application specific integrated circuits (ASICs), field programmable gate arrays (FPGAs), or another type of processor that interprets and executes instructions. Memory 206 may include memory or secondary storage. For example memory 206 may include a random access memory (RAM) or another type of dynamic storage device that stores information or instructions for execution by processing unit 206. Additionally, or alternatively memory 206 may include read only memory (ROM) or another type of static storage device that stores static information or instructions for use by processing unit 204. Storage 214 is a data storage device for retrievably storing data or information for use by the system and may include various storage medium such as, but not limited to, hard drives using magnetic storage medium, flash memory, solid state, hybrid or combination technologies or removable memory such as flash memory. Input device 208 may include a mechanism that permits an operator to input information to device 200 such as a control button, a keyboard, a keypad, a touch pad, radio signal, location device like a GPS signal, one or more biometric mechanisms or other type of input device. Output device 210 may include a mechanism that outputs information to the operator, such as a light emitting diode (LED), a display, a speaker, or other type of output. Communications interface 212 may include a component that permits device 200 to communicate with other devices using any transceiver-like mechanism that enables device 200 to communicate with other device (e.g. device 114), networks 111 or 112, or the remote terminal 130, the web portal 118, the content server 113 or a backup user 126. In one implementation communication interface 212 may include a wireless interface, a wired interface or a combination of wireless interface and a wired interface.

Device 200 may perform certain operations as described in detail below. Device 200 may perform these operations in response to processing unit 204 executing software instructions contained in a computer-readable medium, such as memory 206. A computer-readable medium may be defined as a non-transitory memory device. A memory device may include space within a single physical memory device or spread across multiple physical memory devices.

The software instructions may be read into memory 206 from another computer-readable medium, such as a storage device, or from another device via communication interface 212. The software instructions contained in memory 206 may cause processing unit 204 to perform processes that will be described later. Alternatively, hardwired circuitry may be used in place of or in combination with software instructions to implement processes described herein. Thus, implementations described herein are not limited to any specific combination of hardware circuitry and software.

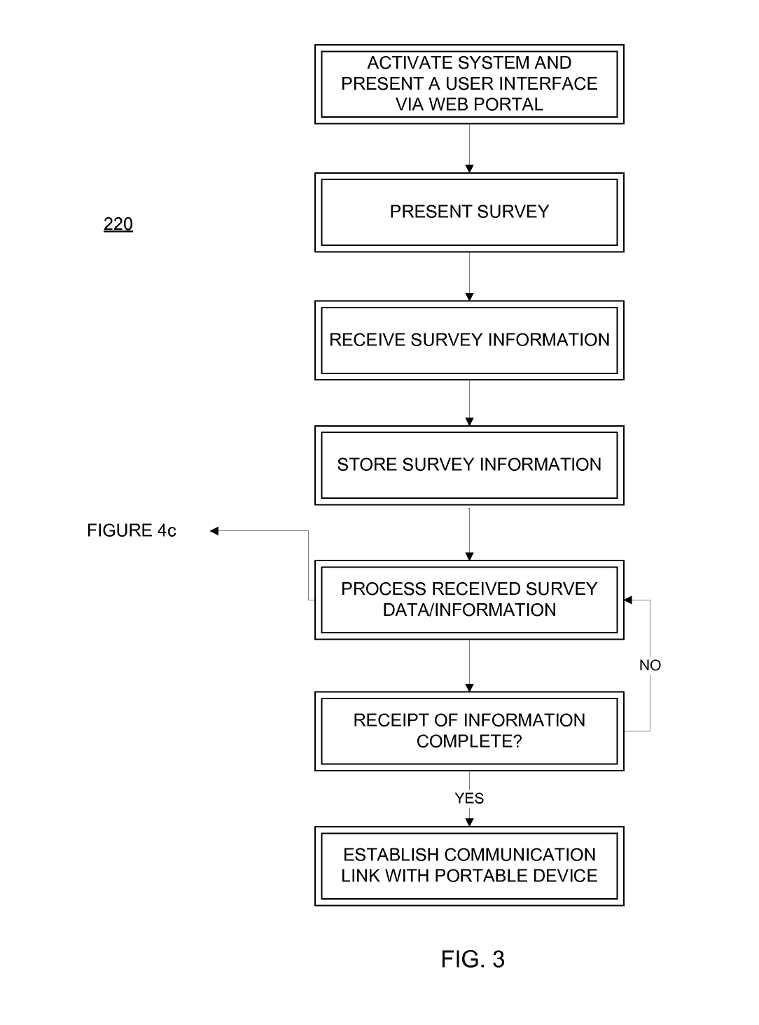

FIGS. 3-10 illustrate exemplary processes for entering, configuring or modifying data in an example system and example processes for using the exemplary system. These example processes allow for providing and interacting with a computer guided interacting on a cognitive prosthetic device for users with cognitive disabilities. In one implementation, processes 220, 250, 300, 350, 380, 400, 440 and 470 may be performed by one or more components of a device. For instance, processes 220, 300, and 470 may be performed by one or more components of the web portal device 118, such as a processing unit 204 of device 118. Processes 250 and 350 may be performed by one or more components of the cognitive prosthetic support device 114 such as its processing unit 204. Processes 380 and 400 may be performed by one or more components of a system administration device 129 such as its processing unit 204. Process 440 may be performed by one or more components of a remote terminal device 130 such as its processing unit 204. In another implementation, one or more blocks of processes 220, 250, 300, 350, 380, 400, 440 and 470 may be performed by one or more components of another device or a group of devices including or excluding a particular device. Processes 220, 250, 300, 350, 380, 400, 440 and 470 will be explained in greater detail in with reference to the associated FIGS. 3-10.

As illustrated in FIG. 3, process 220 may include activating the system and presenting a user interface 222 for a web portal user 119 at the web portal device 118 via the associated output device 210, a screen. The web portal user 119 is then presented a survey 224 from the content server 113 for the accumulation of survey information 226 at the web portal device 118 for receipt by the system 110 for example at the database server 115. The survey data is then processed 230 by the web portal device 118 until the web portal user 119 has finished entering the requested survey data 232. Once all survey data has been entered 232, then the survey data may be uploaded via the communication network to the database server 115. The web portal may then attempt to establish communication 234 with the device 114.

As further illustrated in FIG. 3, the cognitive prosthetic support device 114 for use with the current system 110 is adapted for real-time assistance based upon the initiation of a request. The cognitive prosthetic support device 114 may include various components such as display with the output device 208, a keyboard as the input device 208 as well as other generally known device input and output components such as GPS, microphone, memory connected through the communication interface 212 such as a cellular antenna for use on the telephony network 112 or other mobile communications network. The cognitive prosthetic support device 114 may also provide for live or pre-recorded text communication, chat, video-chat, video or holographic images in addition to verbal or preprogrammed commands to allow for communication with a remote operator 130. In one exemplary embodiment the display at the output device 208 would employ standardized color coding which can be customized using the web portal 118.

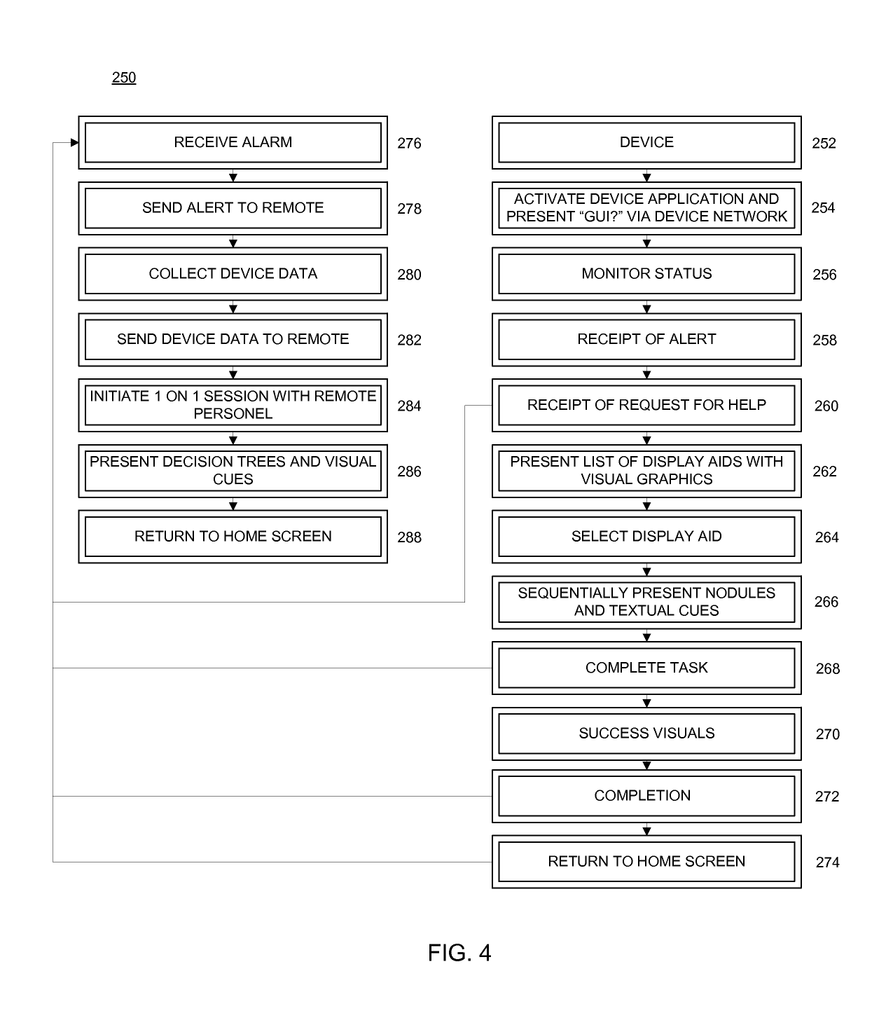

As illustrated in FIG. 4, process 250 may include providing 252 the cognitive prosthetic support device 114 based upon the desired characteristics. The cognitive prosthetic support device 114 may then have the application layer downloaded over the communication interface or using a attachable storage device with the installation software loaded. Once the software is installed on the cognitive prosthetic support device 114 it may then be activated 254 and the user is presented a device user interface screen. Once the software has been installed and the device 114 is activated 222 via the communication interface, network communicator, the device 114 is identified by the system 110 and assigned to the appropriate user account. Based upon the configured parameters by a system user 128 using the web portal 119, the system 110 associates the device 114 with the user account and transmits an acknowledgment to the device 114. In some cases this may be in the form of a welcome screen or a home screen and a list of display aids which have been selected by the system user 128 at the web portal 119.

In some cases the configuration of the device 114 home screen may include a listing of task flows or display aids which have been configured on the system administrator computer 129 by the admin user 129a using the system administration configuration tools. If the cognitive prosthetic support device 114 is not recognized by the system 110, the system 110 may transmit user prompts to notify the user that they need to create an account, that there are insufficient funds available or to contact a system administrator 129a. If the device is recognized by the system 110, a communication monitor is established to monitor 256 the status of the cognitive prosthetic support device 114 for receipt of an alert 258 or request for help. When the device 114 transmits a request for help 260 the system 110 will transmit data based upon the request. Unless the request is an alarm, such as a panic alert, the system 110 will transmit a series of visual graphics and text 262 for display on the cognitive prosthetic support device 114 to assist the cognitive disabled user 117 through a step by step process to resolve the situation through a sequential series of nodes collectively referred to as a display aid 121.

In an exemplary embodiment, the cognitively disabled user 117 will be presented with a short list of tasks 262 each task being consistent with a specific display aid 121 and each display aid having visual cues. The system 110 will wait for the cognitive disabled user 117 to select a decision tree 264 and then the nodes associated with the selected display aid 121 will be transmitted 266 to the device 114, each display aids 121 including visual, audio, audio-visual and textual elements to assist the cognitive disabled user 117. The system 110 will systematically advance the nodes associated with each display aid 121 based upon the user 117 instruction in sequence until completion, activation of a home command or transmission of a request for help. Once the cognitive disabled user 117 successfully completes the desired task 268, the system 110 will provide a completion notification such as, but not limited to a visual representation 270 or an audible response and mark the task completed 272 and return to the home screen where the task list is displayed 274. The cognitively disabled user 117 may end the process at this point or may opt to continue by asking for assistance.

As further illustrated in FIG. 4, if the system 110 receives an alarm or device communication from the cognitive disabled user 117 based upon the configuration parameters received at the web portal 118 such as email, phone or other communication information, the system may notify a previously configured contact to contact the remote call center server 116 requesting that the remote operator 130 take action. The system 110 collects information each time the user responds by making a selection on the display aid 121. Upon receipt of the alarm, or notification, the system may collect location and status information 280 about the cognitive prosthetic support device 114 available from various input device 208 components such as GPS, device status, time, visual, textual and verbal data. The system 110 may record all transaction data from the device 114 during operation conditions. This transaction data may be retrievable stored on the content server. The transaction data may be used to troubleshoot, refine or demonstrate impact of the system 110. The system 110 may also send the collected device data to the remote server 282. Once the remote server receives the alarm notification, a 1-on-1 transaction may be initiated 284 with a remote operator 130 where the remote operator 130 can provide decision tree and visual cues to assist in completion of the desired task or procedure 286. Upon completion of the desired task or procedure, the system 110 will remove the alarm and return the device to normal condition with the display of the home screen 288.

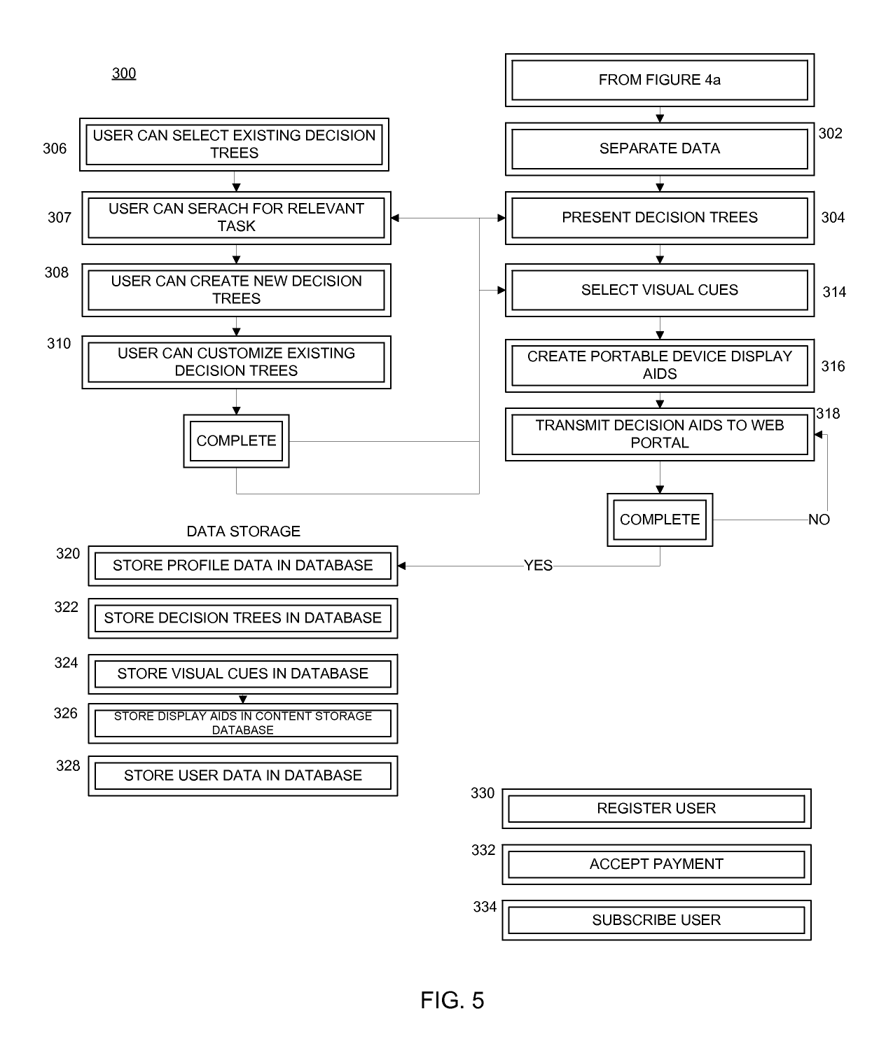

As illustrated in FIG. 5, process 300 may include processing received survey data as indicated in FIG. 3 in which the system 110 separates the data obtained from the survey at step 224 through the web portal 119. Based upon the received survey data the system 110 may present relevant decision tree 304 at the web portal 119, or the system user 128 may select an existing decision tree 306, may search for a decision tree based upon a relevant task 307, or the system user 128 may create 308 interactive graphic display aid which can be transmitted to the cognitive prosthetic support device. Each display aid 121 included a plurality of sequential nodes, each node having an interactive screen for a cognitively disabled user to make a selection. Based upon the selection, the next sequential node is presented and displayed on the cognitive prosthetic support device 114 for interactive selection by the cognitive disabled user 117. In addition, a new tree also referred to herein as a task flow or the system user 128 may customize an existing decision tree 310. Once the system 110 has presented for selection the desired decision trees 310 as illustrated on the My Account screen of FIG. 20, the system user 128 may select which display aids 121 to be displayed on the cognitive prosthetic support device 114 by selecting the associated decision tree 310 from the list of possible decision trees 310. After the system user 128 selects the desired decision trees 310, the system 110 processes the decision tree 310 to create the system user 128 may customize the desired display aids with a visual cue selected from the list of possible visual cues 314 for association with each of the desired display aid 121. The system 110 then allows for customization f the standardized display aids 121. In some cases, the display aid 121 may be based upon a standardized template in terms of visual, textual or auditory elements or arranged in a uniform manner in the form of a template. The system user 128 may also be allowed to customize the display aids 121 with various visual and textual elements.

Based upon the exemplary process illustrated in FIG. 5, once the decision trees have been processed by the database server 115 to produce the display aids 121 which are then transmitted 318 for viewing at the web portal 119 and retrievably stored on the content storage device 113a.

In addition, the system 110 will store 320 account profile data along with the decision trees also referred to as task flows 322, the visual cues 324, display aid templates 326 and user data 328 for retrievable storage in the database 115a. In addition, once the system user 128 has completed the account setup portion of the system 110 they may register as a basic user 330 and if payment is made and accepted 332 the user may be subscribed by the system 110 as a premium or subscribing user with access to additional features of the system 110.

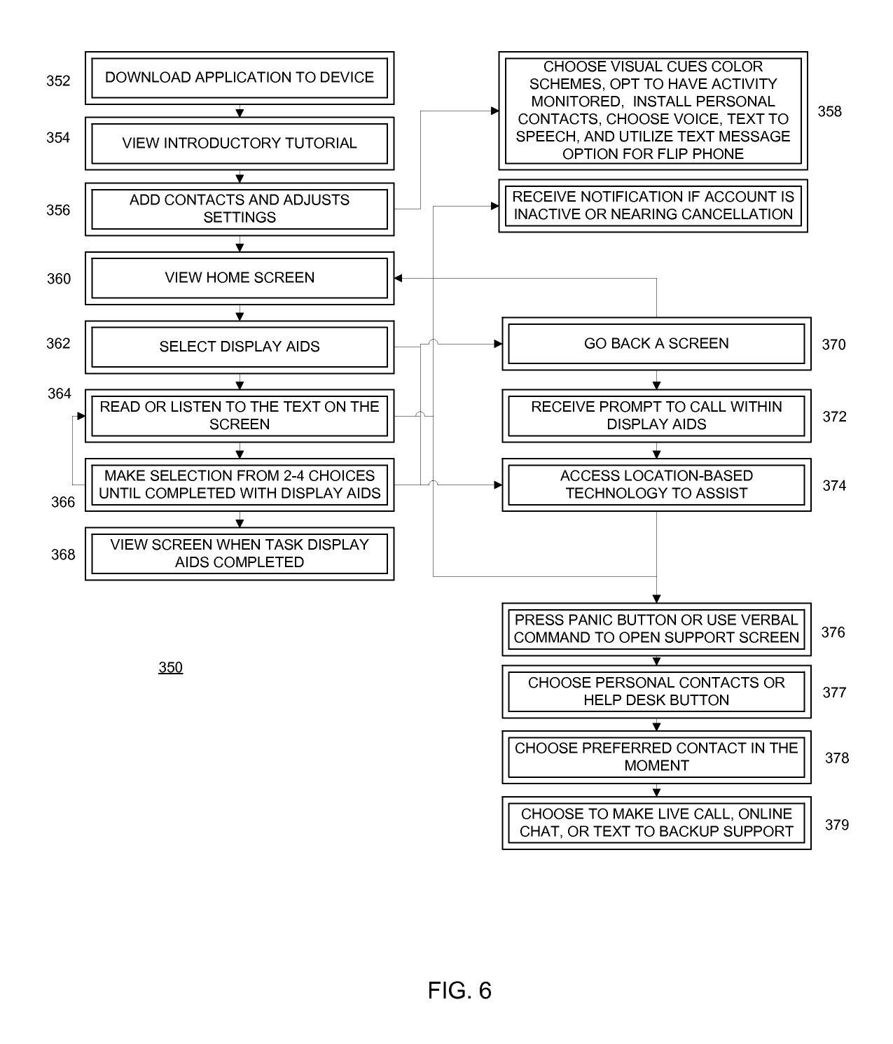

As illustrated in FIG. 6, an exemplary process 350 may include downloading 352 the client software also referred to herein as the application or app for use on the cognitive prosthetic support device 114 and then once logged in 526 may view a series of introductory tutorials 354 to familiarize themselves with features of the system 110 and to learn about various system processes. After the cognitive disabled user 117 has been presented with the tutorial screen on the cognitive prosthetic support device 114 they may add system contacts and adjust various system settings 356 if the cognitively disabled user 117 has sufficient system privileges as configured by the system user 128 when configuring the account profile screens or as configured by an admin user 129a. Alternatively, the system user 128 may view the system tutorials 354 via the web portal 119 or adding and adjusting various system settings 356. In addition, either the system user 128 or the cognitive disabled user 117 or both, as indicated in step 358, may configure various visual elements in connection with the display aids 121 such as but not limited to various color schemes or avatar settings. In addition the system user 128 may configure various system activities is to be monitored by a remote operator 130 or under what conditions a system notification is sent to a user defined contact. The system user 128 or in some cases the cognitively disabled user 117 may elect whether to provide audible cues in addition to the visual cues of the display aid 121 and whether to activate geolocation based detection features and allow for receipt of text messages from the cognitive prosthetic support device 114.

Once the cognitive disabled user 117 or system user 128 has finished adjusting the available settings and added desired contact information, a home screen 360 will be presented by the system 110 which will list the configured display aids 121 for selection by the cognitive disabled user 117 on the cognitive prosthetic support device 114.

During operation, the cognitive disabled user 117 will select 362 the desired display aid 121 from the home screen which corresponds to the task being performed. Once the desired display aid is selected based upon the configuration, the cognitive prosthetic support device 114 will present the selected display aid 121. Based upon the configuration of the system 110 the device 114 may simply display the text and/or audibly announce each step 364 in the display aid to assist the cognitively disabled user 117 perform the desired task. In one example, each screen will have two or more choices 366 until the task is performed or the display aid is terminated. Once successfully completed, the device 114 will present a celebration screen 368. Additionally, in an example process, at any point in the process, the user may navigate backwards a screen 370 or make a call 372, text or otherwise communicate with a preconfigured contact for assistance. In another example, the device 114 may use location based technology 374 to display a map to provide assistance in completing the desired step.

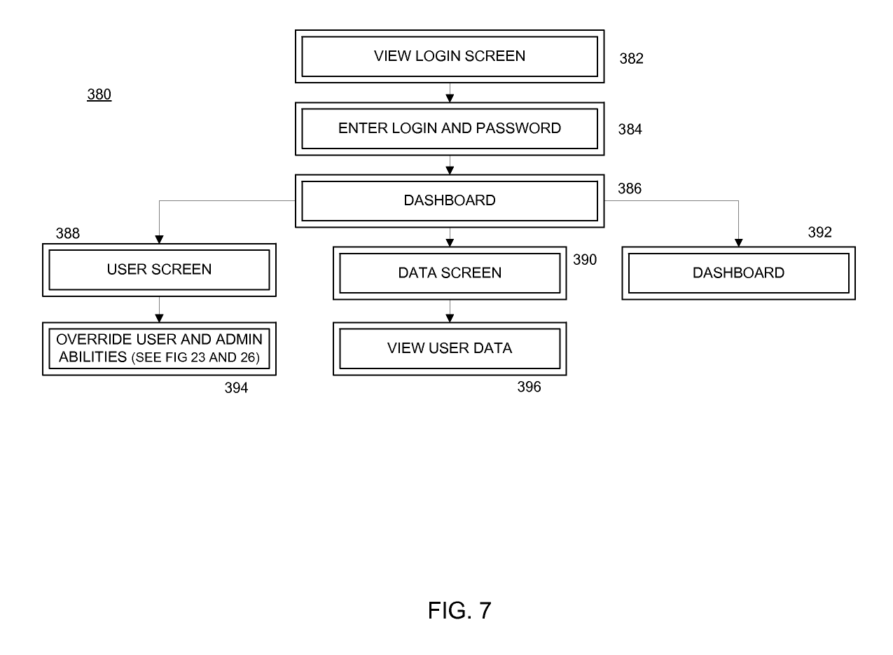

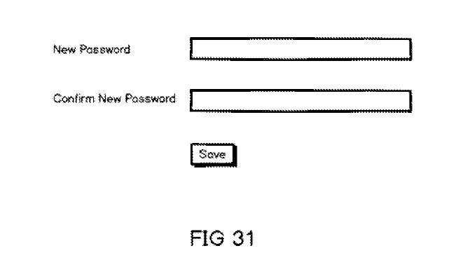

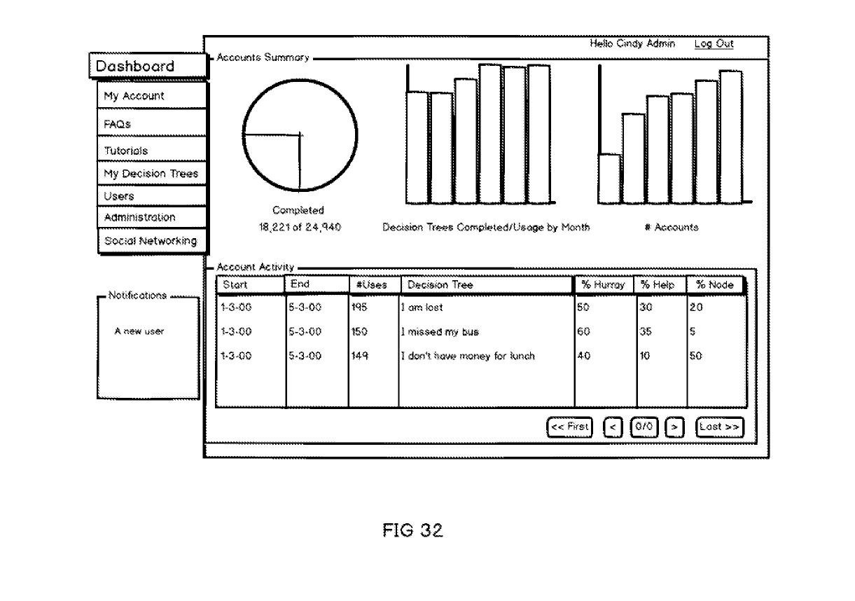

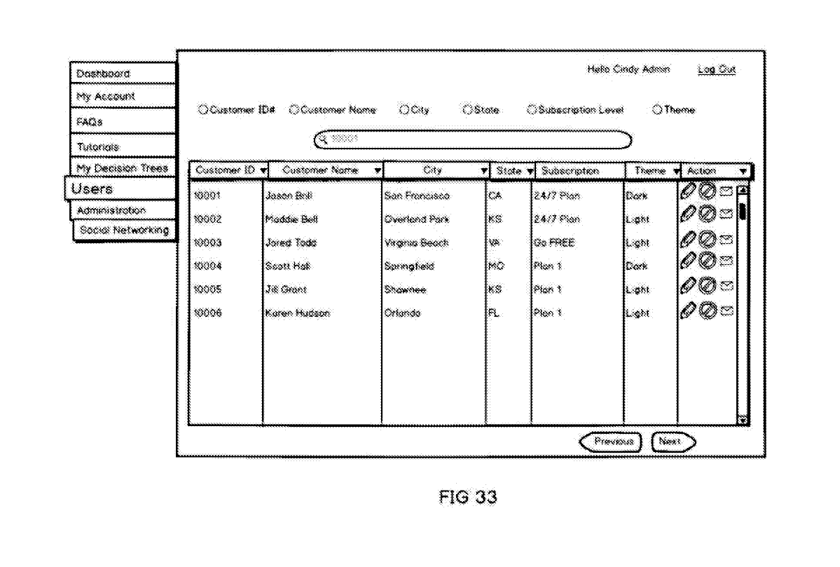

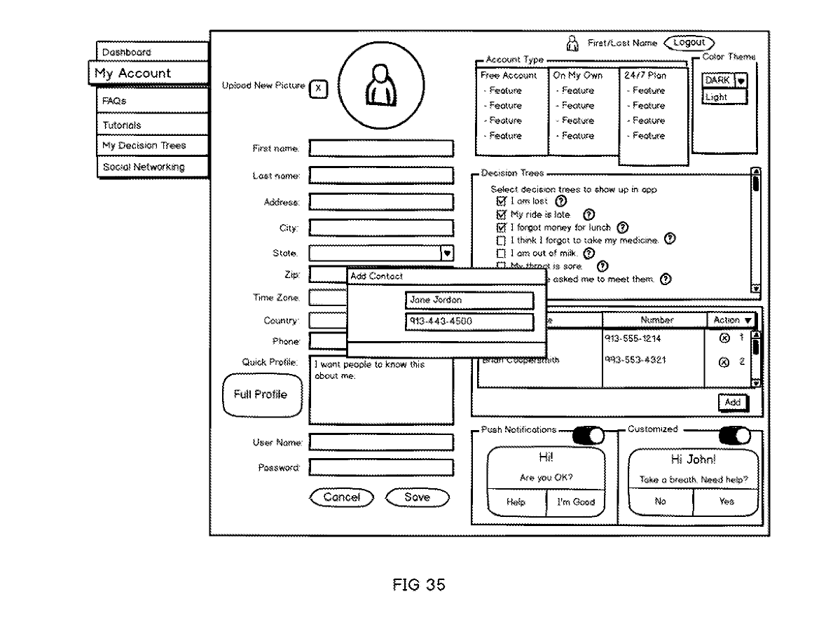

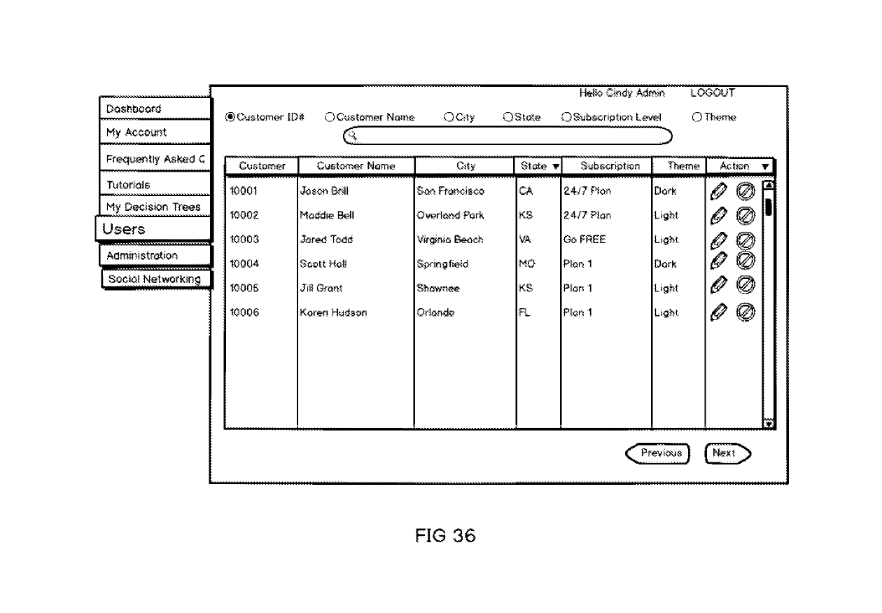

As illustrated in FIG. 7, process 380 may be utilized by a admin user 129a on the system administrator server 129 for configuration of various system parameters and viewing current system status and various system data an example of which is further illustrated on FIG. 32. As indicated in FIG. 7, the admin user 129a may access the system 110 via a system login screen 382 (an example of which is illustrated on FIG. 31) and if provided with proper credentials 384 the system 110 will display an admin dashboard summary screen 386 (an example of which is illustrated on FIG. 32). From the admin dashboard summary screen 386 the admin user 129a may select to navigate to the user listing screen 388 (an example of which is illustrated on FIG. 33) and from there the admin user 129a may select a specific system account user screen (an example of which is illustrated on FIG. 35) to view, customize or create additional user account information. Alternatively, the admin user 129a may navigate to a customer summary data screen 390 (an example of which is illustrated on FIG. 33) or go to a detailed dashboard screen 392. In addition, the system admin user may sort or select specific user data 396 or override/block the user from the system 394, an example of which is further illustrated on FIG. 36 or send and email to the account holder.

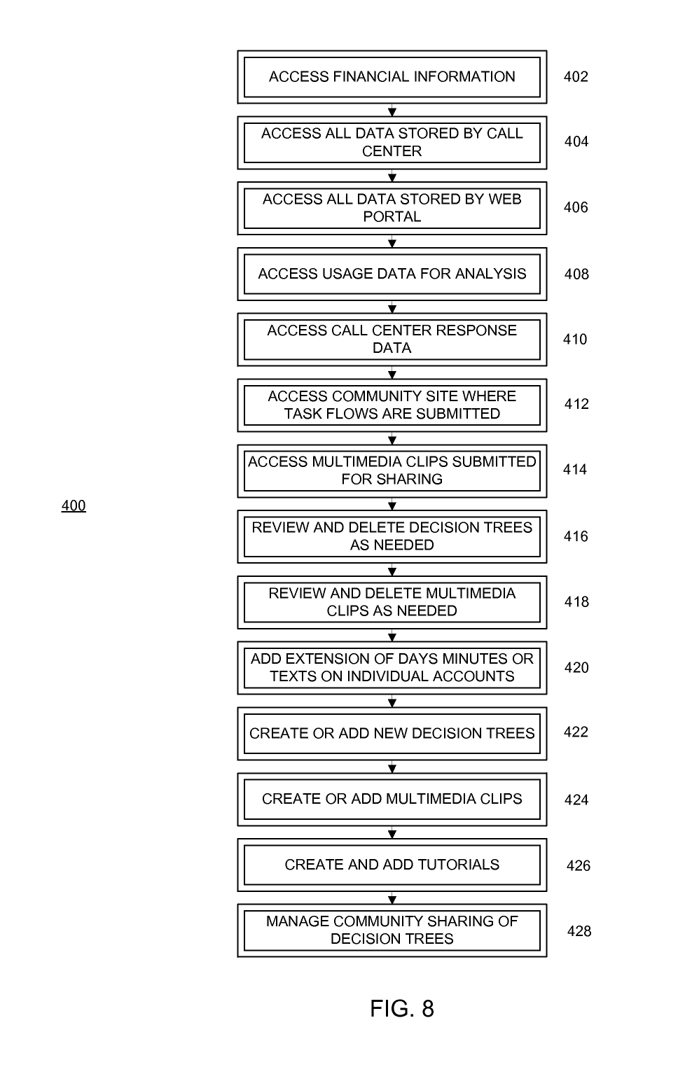

As illustrated in FIG. 8, the process 400 may be utilized by the admin user 129a or a higher level admin user (not shown) using the system administrator server 129 for configuration and viewing of system status and financial information as well as adding additional system media and templates accessible for other system users 128. In an exemplary process, the admin user 129a can access user and system financial information 402 and access remote operator data 404 obtained from the remote call center server 130 and access account and configuration data 406 stored by a system user 128 on the web portal 119. Step 408 illustrates access of usage data 408 and remote server response data 410. Differing levels of permission may be granted to enable and restrict access to certain data. By way of illustration only, in one embodiment a system user may be provided access to account usage data 408, 410 without having access to individual account data or financial data 402. Account usage data 408 may include the number of users, number of customers, completion and failed decision tree statistics, summary statistics for individual decision trees 123, and the creation of new task flows by users or customers being stored within the content server 113.

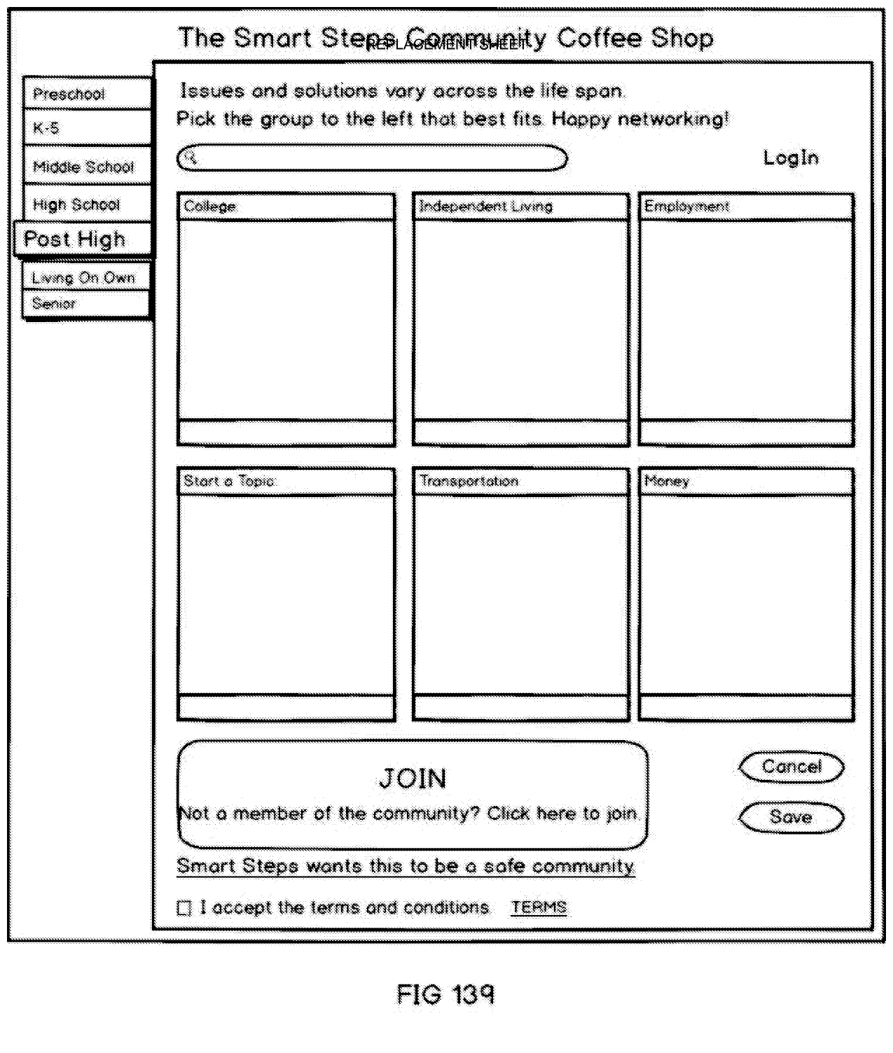

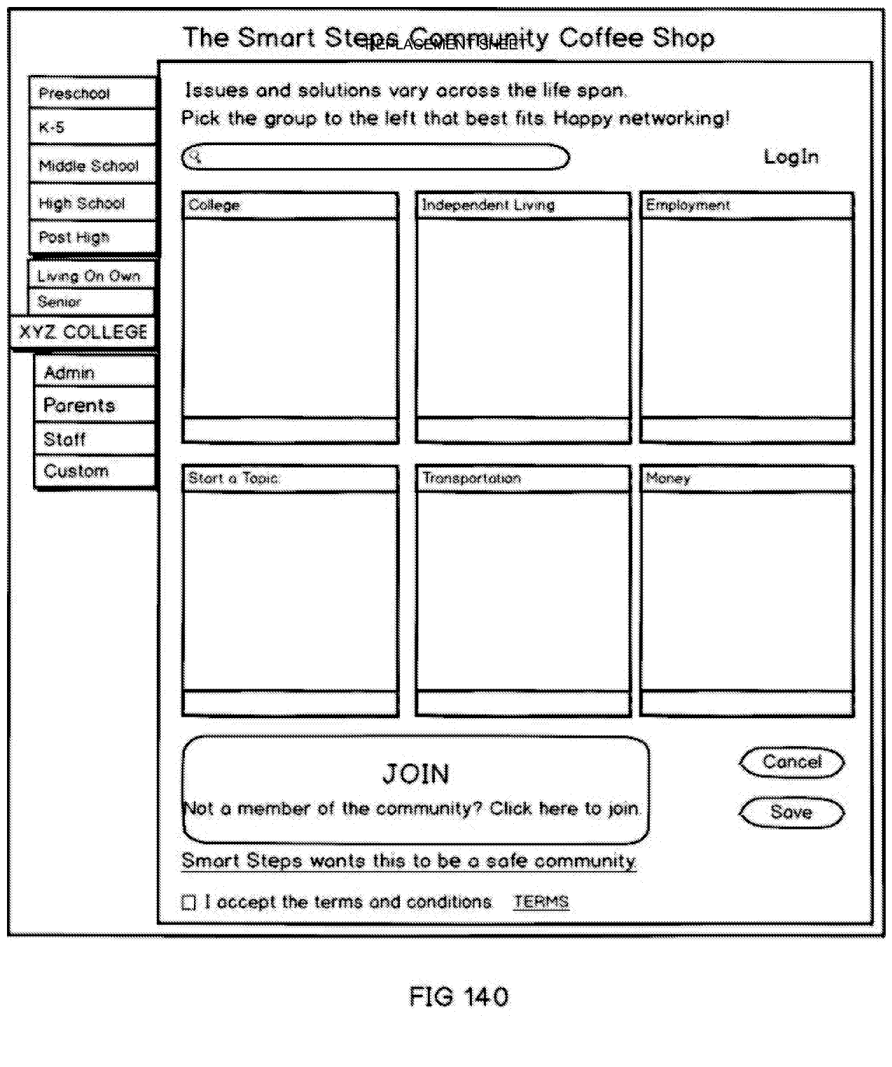

In an example of the system 110 an electronic community 412 also referred to as a forum may be provided for access by multiple users to communicate with the admin users 129a or other system users 128 using electronic messages such as email, texts, visual or audio data. An example of this electronic community is illustrated on FIGS. 139-140. The communication may include suggestions or tips as well as advise in how to create, modify or use existing system content including task flows. The communication may be in the way of forums, newsgroups, blogs, or electronic methods for storage and distribution of group communication. In addition, the electronic community may provide for access and sharing of multimedia clips 414 for use by the system in the display aids 121. The admin user 129a may manage or monitor the electronic community and manage various user messages or the sharing 428 i.e. creation, transmitting, storage and/or usage of shared multimedia clips or task flows using the provided forum. In addition to the electronic community, the admin user 129a may utilize the web portal 119 for configuration and viewing of system status and information as well as adding additional system information and other user templates accessible by other system users 128.

As further illustrated in FIG. 8, the admin user 129a may also review and selectively delete decision trees 416 from the system 110 or review and selectively delete multimedia clips 418 from the system 110. From an accounting aspect, the system 110 may invoice users based upon the amount of time, amount of data, transaction usage or on a subscription basis. In an effort to monitor and maintain proper system usage, the admin user 129a may also selectively increase or decrease 420 a system user's financial status within the system 110 also referred to herein as system funds, the available time remaining on the user's account, or remaining account transactions or provide an account credit for a variety of reasons like a prior system deduction to a specific user account or a group of user accounts based upon the desired outcome. In addition, the admin user 129a may review and approve content submitted by users as indicated in steps 412, 414, 416, 418, 426 and 428, create, modify or add system content for retrievable storage on the content server storage device 113a including, but not limited to, new task flows 422, new multimedia clips 424 or new tutorials 426.

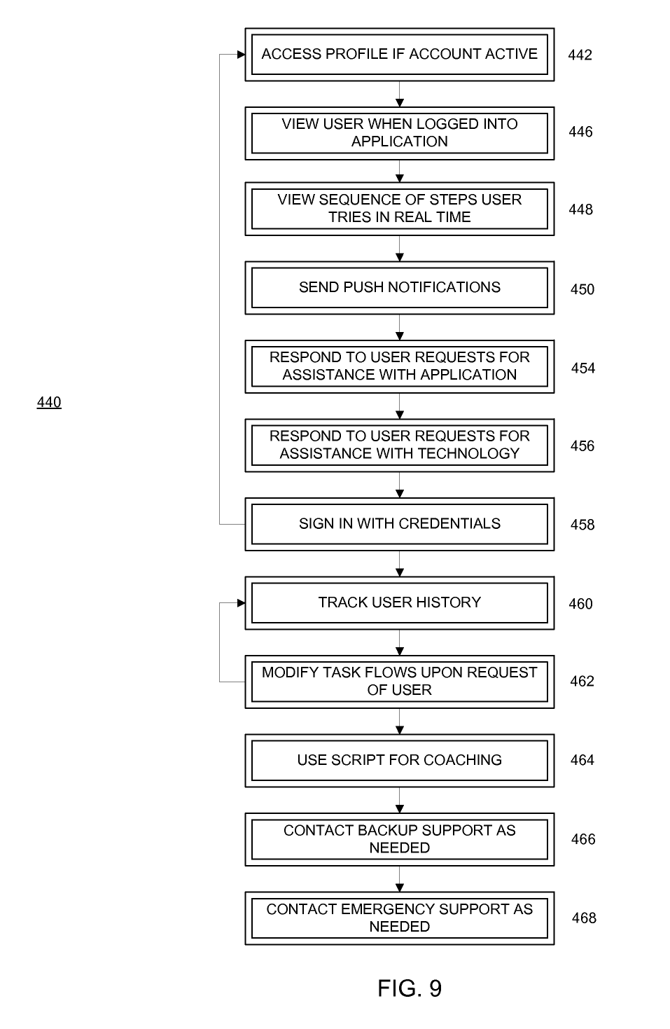

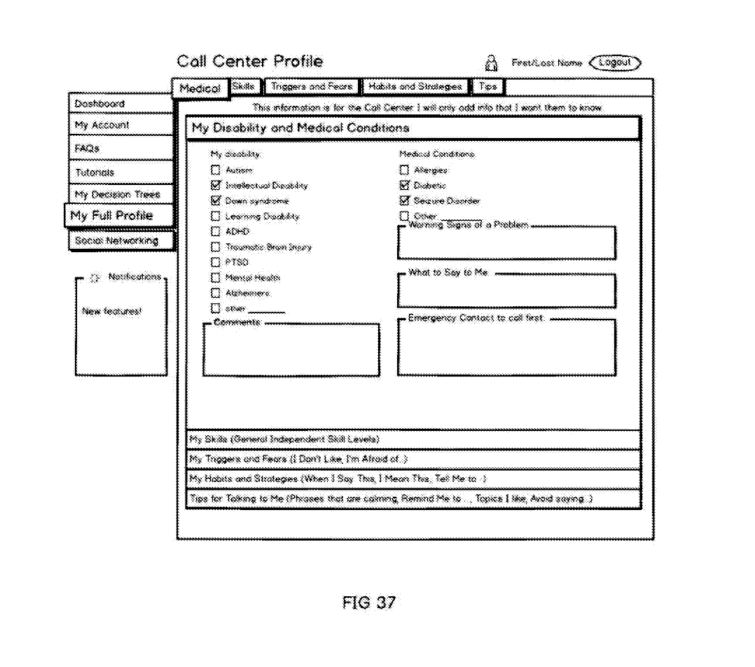

As illustrated in FIG. 9, process 440 may be remote operator 130 such as a backup user 126 in communication with the remote call center server 116 for monitoring and responding to user or system generated requests, alerts or alarms such as for example in a call center environment where accessible components include a telephone, a computer network connection and a computer having a processor, an output display device and an input device for monitoring and selectively assisting a cognitively disabled user 117 using a cognitive prosthetic support device 114. For example, for active subscribers of the system 110, the remote operator 130, once securely logged 458 into the system 110 can access 442 a system user account profile FIG. 37-41 based upon an electronic or telephone request from a cognitively disabled user 114.

In an exemplary process 440 is illustrated in FIG. 9. In general, the remote operator 130 will have restricted access to account profile information so that they have sufficient access to information required for handling remote call center access like emergency contacts and call center FIG. 37-41 profile information which is provided during the configuration of the account profile screens by the system user 128. The information available to the remote operator 130 may also be limited to active account information such as account profile information the user or admin user-created profile 442, historical information of past assistance requests 460 and the status of an account threshold balance or transactions 442. Certain information may be limited from the remote operator 130 or the remote call center server 116 such as HIPAA information or financial information to protect confidentiality or for other reasons. When the remote call center server 116 receives a request from a cognitively disabled user 117, the remote call center server 116 may collect and display 446 certain cognitive prosthetic support device information like status and location information associated with the cognitive prosthetic support device 114.

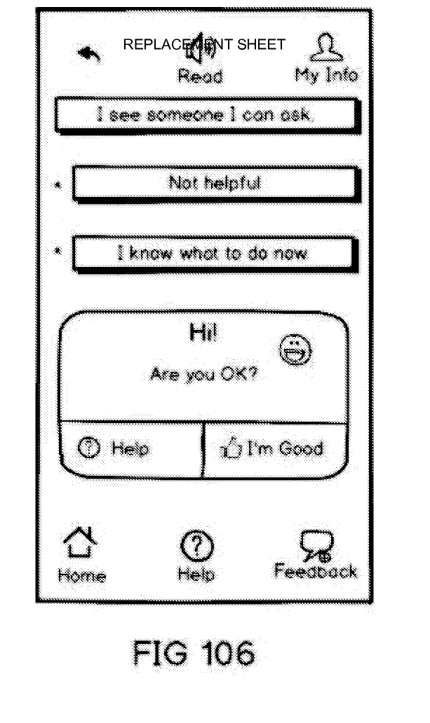

Additionally, according to the exemplary process 440 of FIG. 9 the system 110 may display the current status 448 of the display aid 121 including current steps, attempted steps or failed steps within the current task 448. The remote operator 130 via the remote call center server 116 can transmit an electronic or textual message such as a preconfigured push notification 450 or notice to assist the cognitively disabled user 117 such as to encourage the user 117 to call for help if a threshold amount of time has passed without action or to reward the user 117 if they have successfully completed the current display aid 121. The remote operator 130 may also send a customized notice (FIG. 35, 43) to the cognitively disabled user 117 for assistance in performing the display aid 121. An example of a customized notice is displayed on FIG. 106. The customized notices can be sent manually or sent based upon a schedule as selected by the remote operator 130 using a remote terminal 140 in communication with the remote call center server 116. Scheduling of the customized notice may be scheduled to occur at a particular time or date or based upon a period of time from a current time. In addition, the customized notices may be reoccurring or single instances, again as selected by the remote operator 130 using the remote portal on the remote call center server 116.

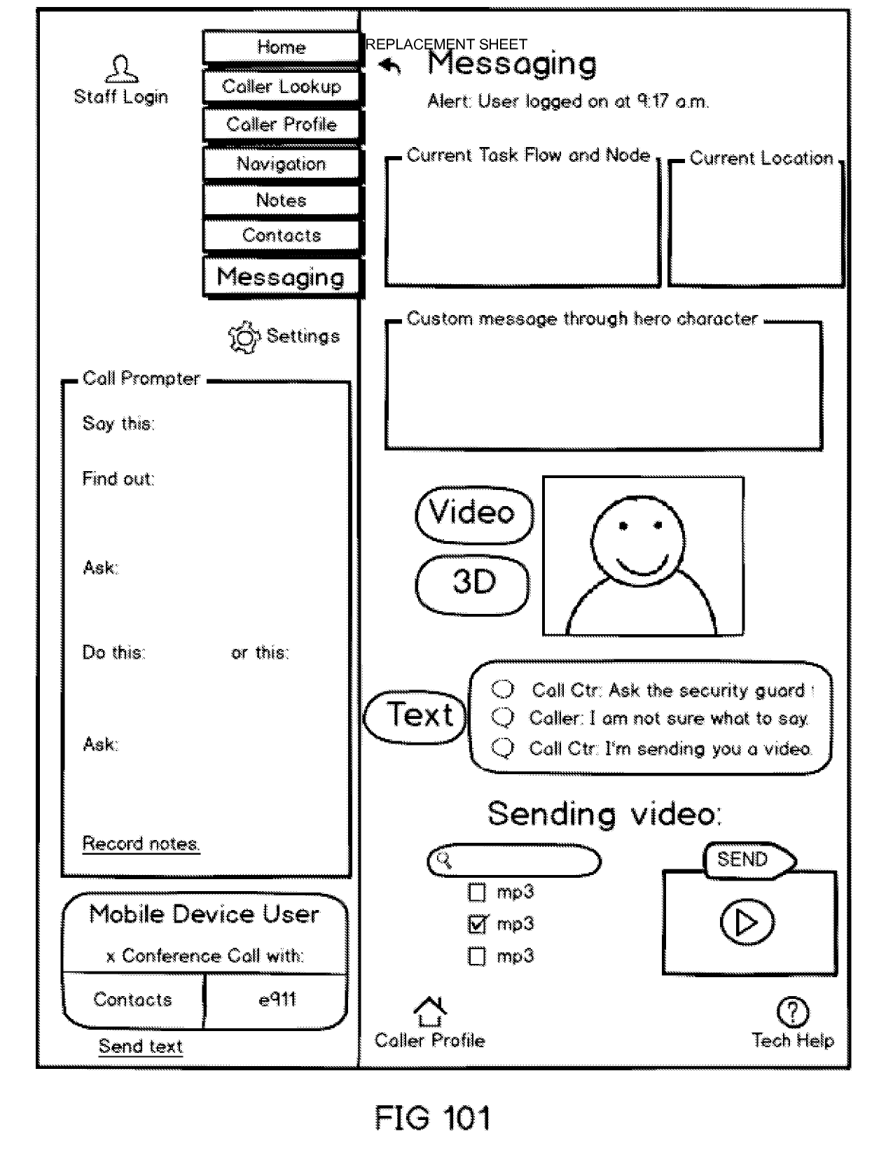

In addition to sending textual communications, the remote operator 130 can respond to a request from a cognitively disabled user 117 for help 456 using the cognitive prosthetic support device 114 or for help 454 using a help button on a specific display aid 121 or for help in configuring the device 114. Additionally, the remote operator 130 can record historical information 460 about a remotely located cognitively disabled user 117, or view account summary FIG. 101 obtained from the content server 113 or historical user transaction information retrievably stored on the remotely located database 115a such as calling history, number of calls made, length of calls made, dates of calls made, purpose of calls made, specific screen or node associated with display aid 121 when calls are made (FIG. 101) indicating why the user called. In addition, the remote call center server 116 may track the specific display aid 121 being utilized when a call to the remote operator 130 is made as well as changes to display aid 121. The remote call center server 116 may also provide for modification 462 or customization of a particular display aid 121 such that the cognitively disabled user 117 may submit 310 or request a modification to a specific display aid 121.

The remote call center server 116 may also provide for the creation, storage and retrieval of notes, scripts or processes 464 for assisting a specific cognitively disabled user 117, issue or a more generalized issue or user in response to the remote server call from a cognitively disabled user 117. In addition, the remote call center server 116 may automatically initiate communication 466 with the cognitively disabled user 117 or the remote operator 130 may initiate communication with a selected contact from a list of the cognitively disabled user's contacts 468 accessible by or transmitted from the content server 113 to the remote call center server 116.

Additionally, the remote operator 130 may initiate communication with selected emergency response personnel 468 either programmed into the system 110 or selected based upon the cognitively disabled user's 117 location as obtained from the cognitive prosthetic support device 114. The remote call center server 116 may also allow for entry, storage and retrieval of customized notes and recorded input in association with a remote operators 130 communication with the cognitively disabled user 117 for storage on a storage media in association with the remote server database.

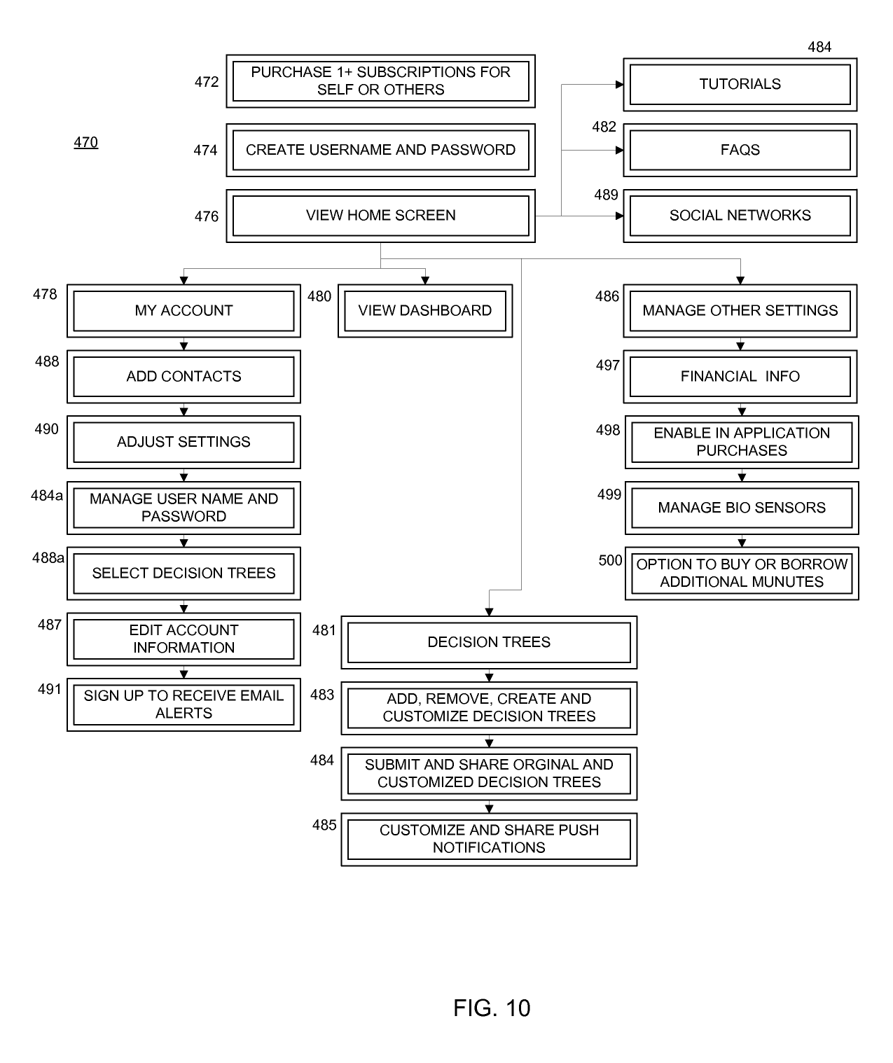

As illustrated in FIG. 10, process 470 may be utilized by a system user 128 such as a guardian, parent, cognitively disabled user or other authorized person who has access to configure a subscriber's account which is associated with at least one cognitively disabled user 117 having a cognitive prosthetic support device 114 which is in communication with the system 110 for receiving display aids associated with a step by step guidance for the performance of a specific task. The system user 128 can provide payment information 472 to be associated with one or more user accounts which is further associated with at least one cognitive prosthetic support device 114 in association with at least one cognitively disabled user 117.

As further illustrated in FIG. 2, the system user 128 would typically access the system 110 directly or indirectly via the web portal 119 using an input device 208 such as a keyboard and/or mouse and an output device 210 such as a display screen with both electronically connected to a processing unit 204 having storage 214 and memory 206, the processing unit 204 in communication with the system 110 via a communication interface 212.

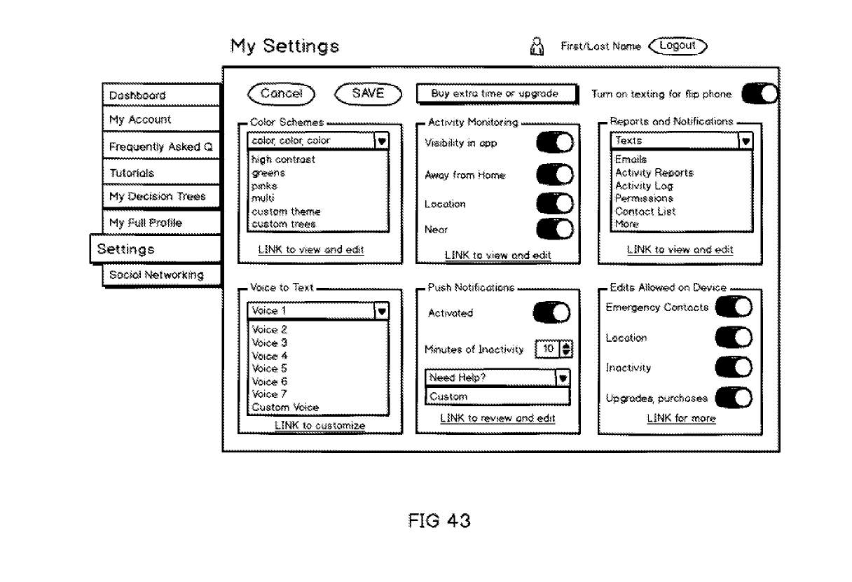

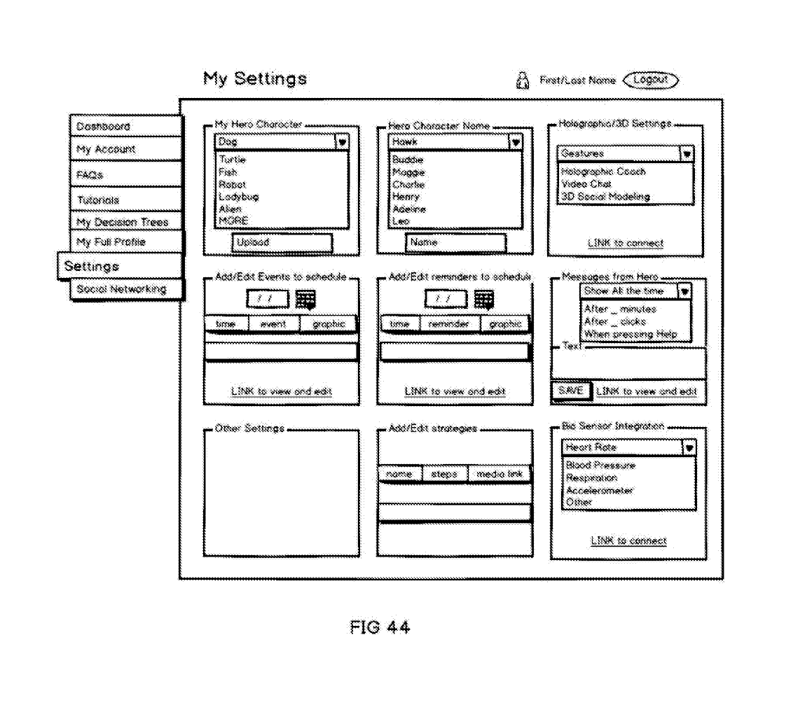

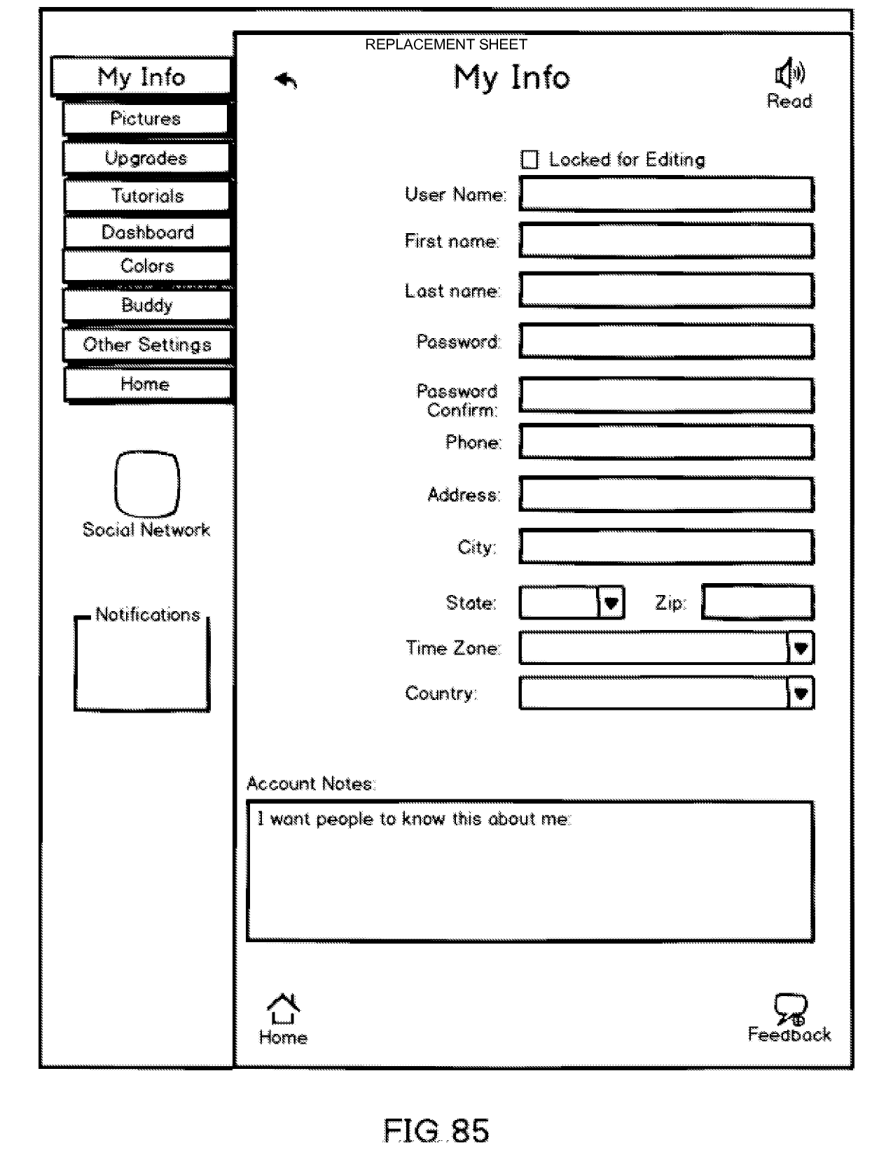

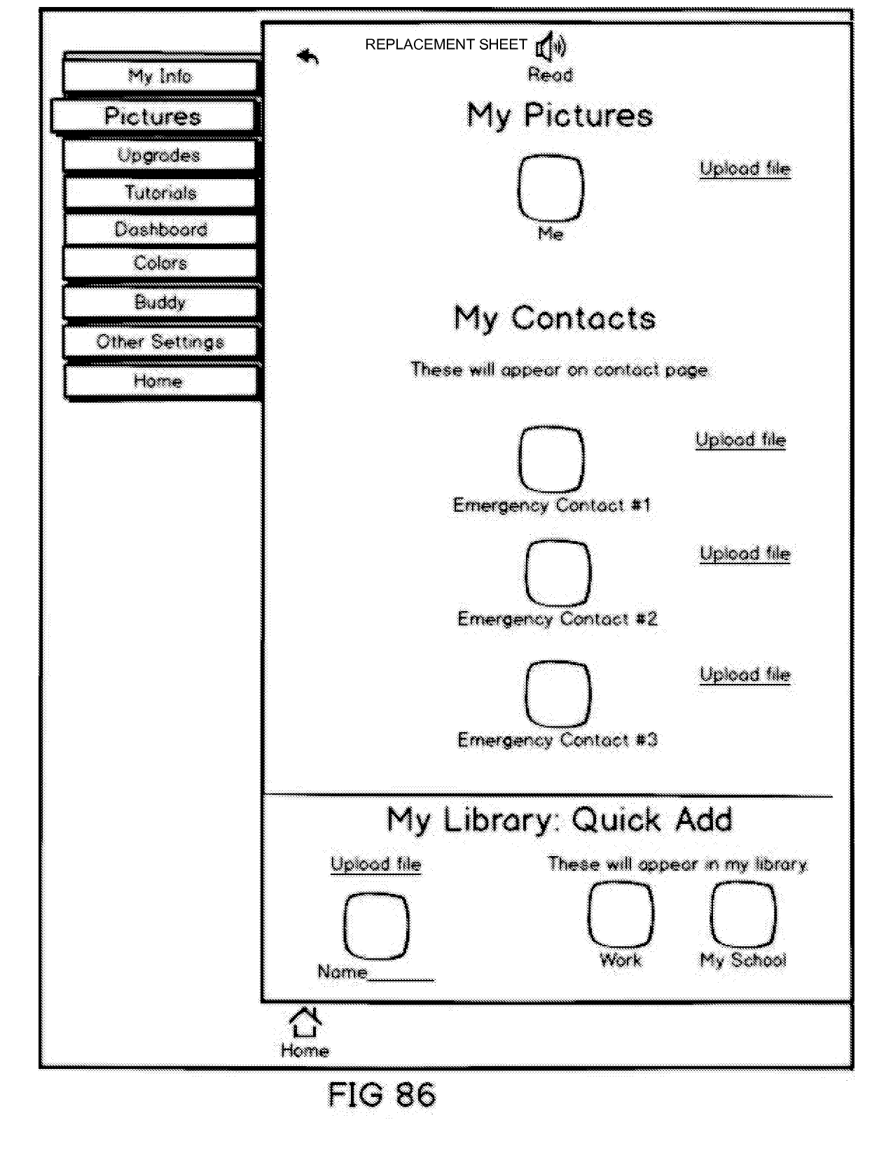

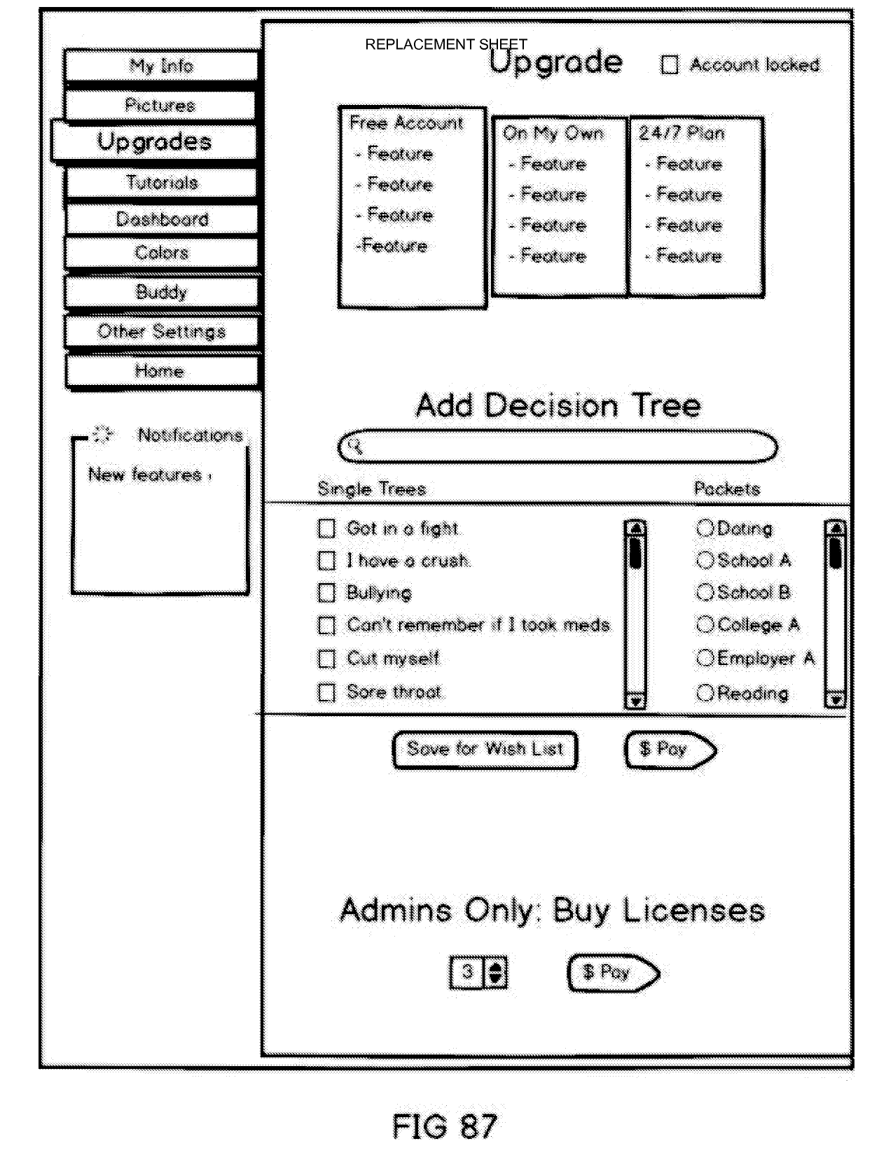

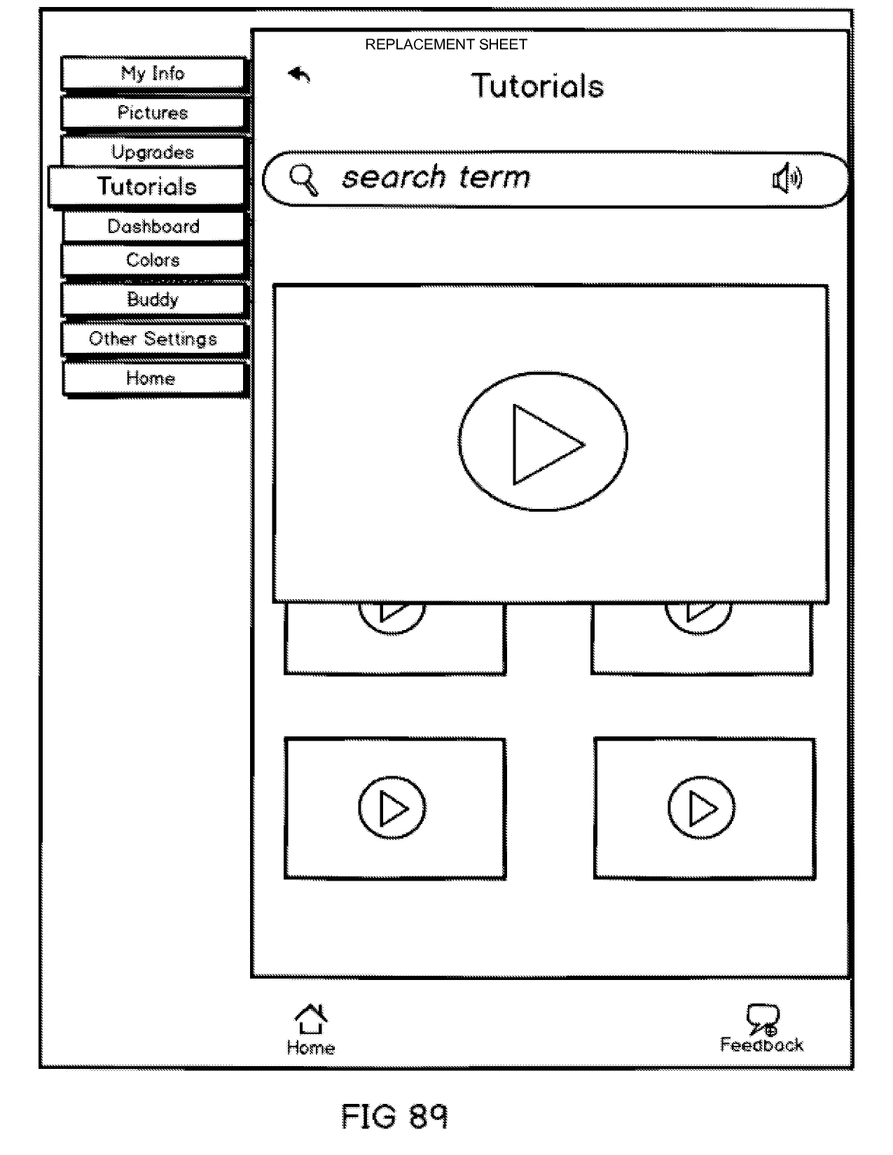

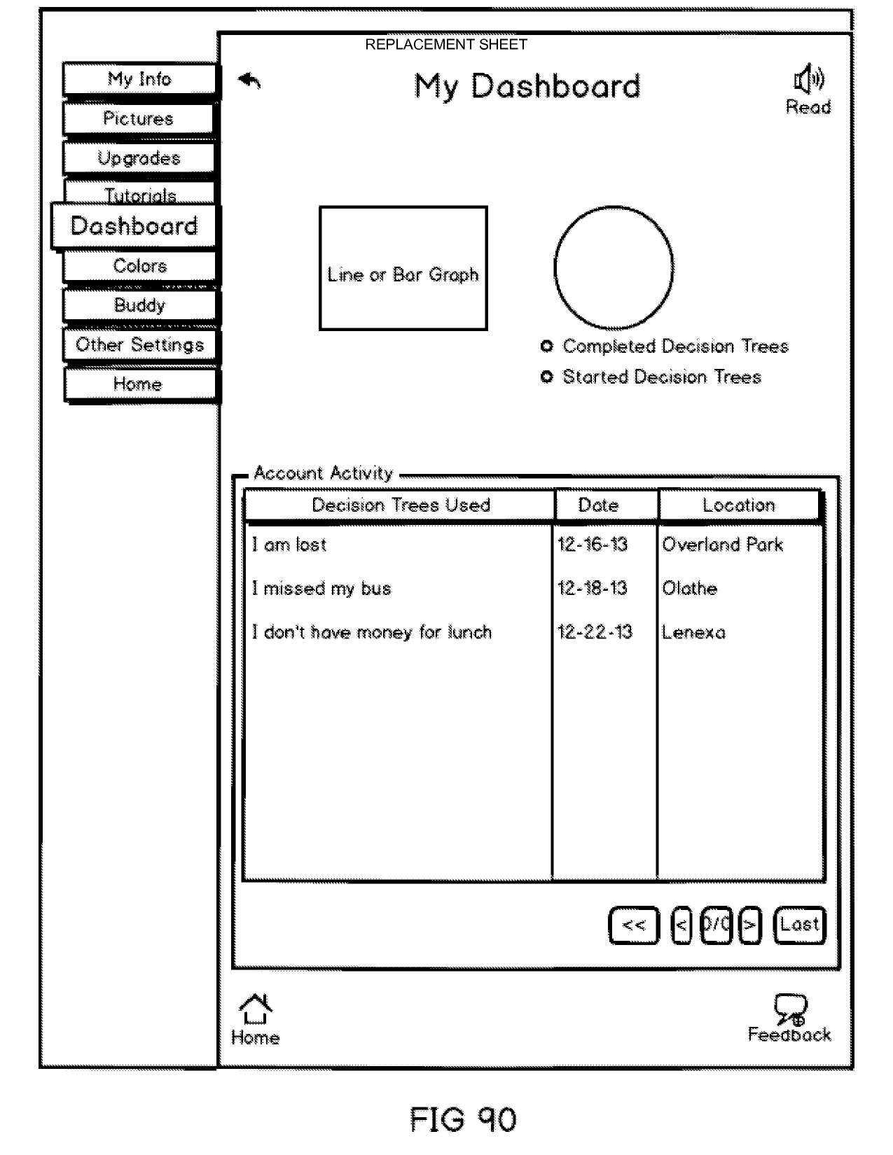

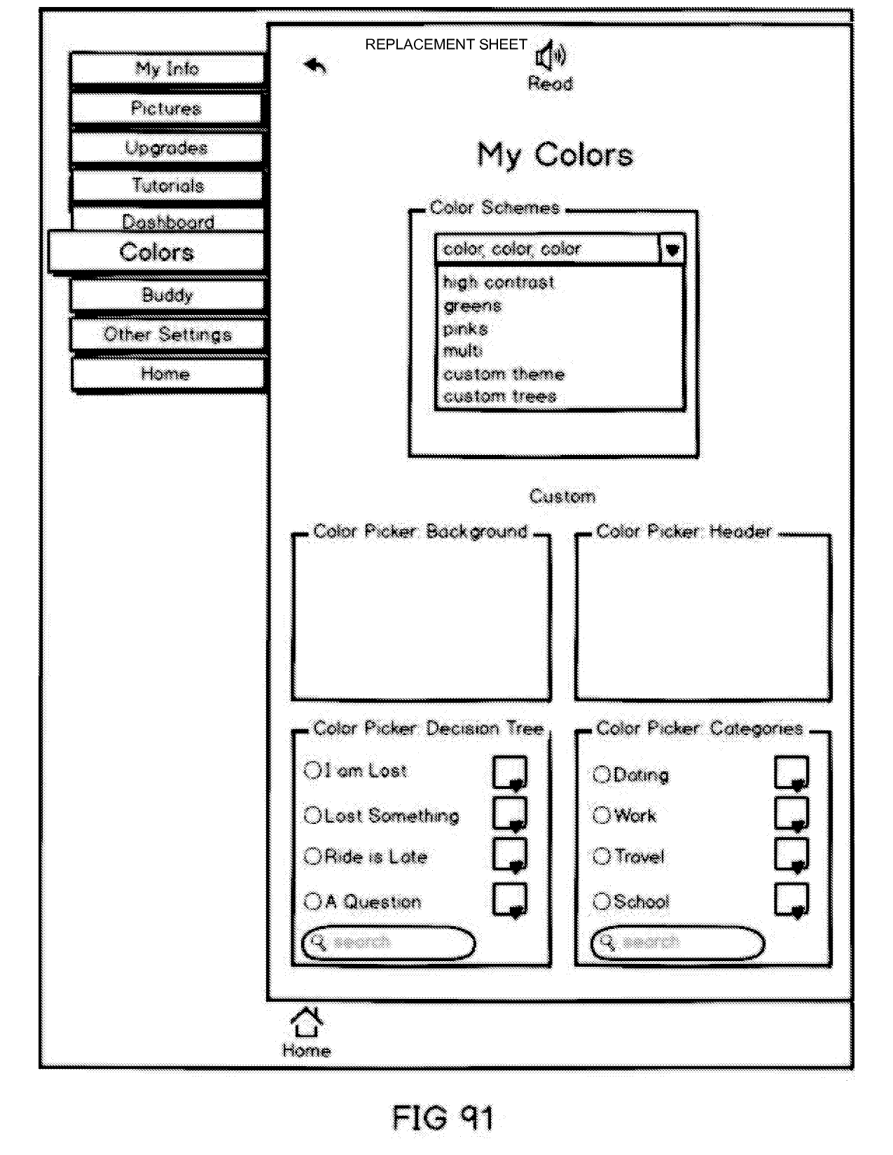

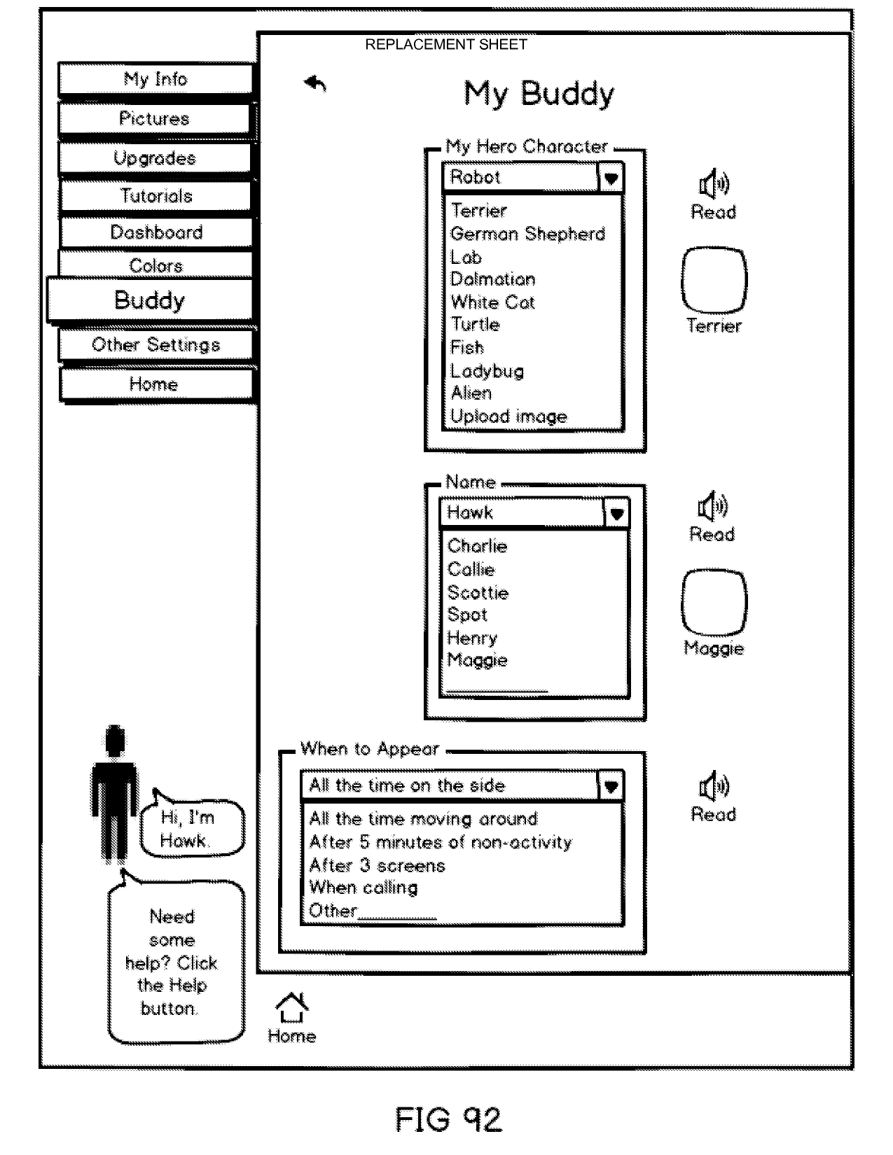

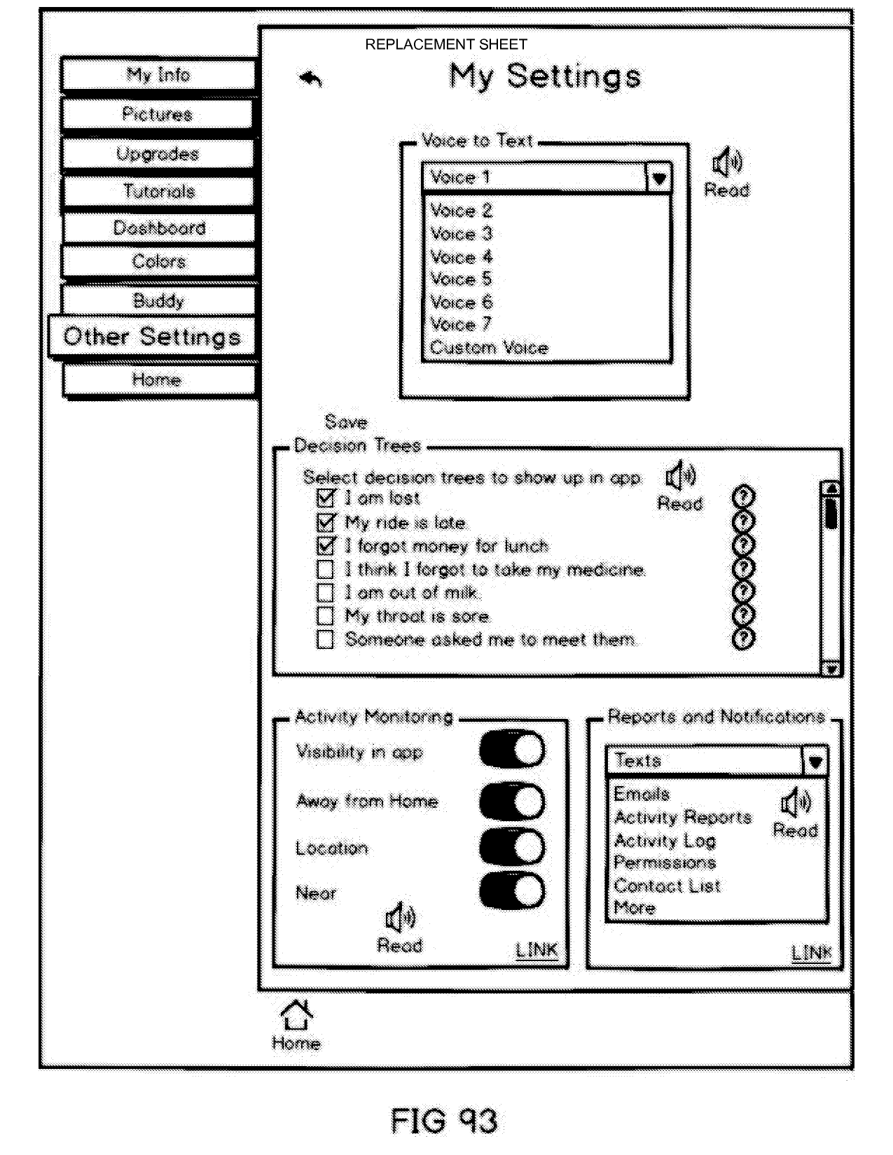

As illustrated on FIG. 10, once the system user 128 has registered an account or has been otherwise provided authorized access to the system 110, a username and password 474 may be created and the user may gain access to the user's account home screen 476 (FIG. 20, 85) for configuration. The default user home screen on the web portal may include tabs associated with my account 478, my dashboard 480, FAQs 482, my decision trees 481, My Full Profile 478, Social Networking 489 and Other Settings 486. On the mobile device (FIG. 85), tabs might be associated with pictures (FIG. 86), upgrades (FIG. 87, 88) tutorials (FIG. 89), my dashboard (FIG. 90), colors (FIG. 91), Buddy or avatar (FIG. 92) and other settings (FIG. 93). These are comparable to customization options described relative to the web portal FIGS. 43 and 44 with the exception to pictures (FIG. 86) which allows the user to upload pictures to the media library or the contact list. From My account 478, Add contacts 488, adjust settings 490, manage user name and password 484a, select trees 488a, edit account information 487 and email alerts 491 may be selected. From Decision Trees 481, the system user 128 can add, remove, create and customize trees, submit and share trees 484, or customize and share notifications 485. From managing other settings the system user 128 can access financial information 497, enable in app purchases 498, manage bio sensors 499 or buy or borrow additional minutes 500. System tutorials 484 may include additional instructions, screens or videos to educate the system user 128 about the system 110.

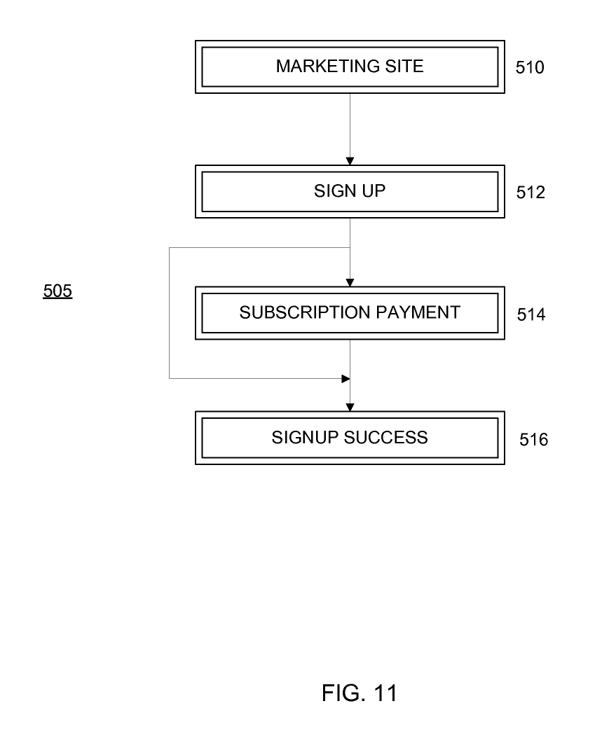

FIGS. 11-14 are exemplary screen navigation flowcharts. FIG. 11 illustrates an exemplary sign-up screen process 505 whereby a system user such as an admin-user or cognitively disabled user may enroll into the system 110. As illustrated in FIG. 11, a system marketing screen 510 may be displayed allowing the user to sign-in or sign-up 512 and submit payment 514. Upon successful completion of the user sign-up a user success screen 516 may appear indicating the sign-up was successful. The user may sign up for a complimentary account, thereby bypassing payment 514.

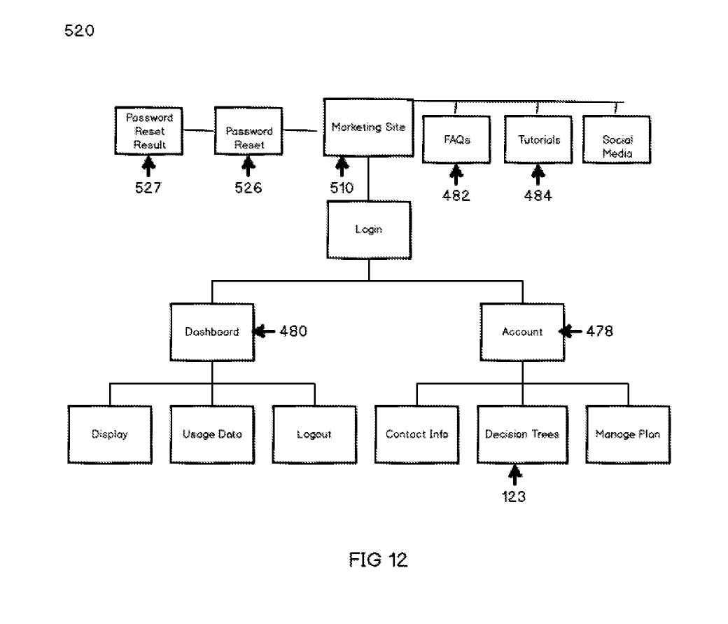

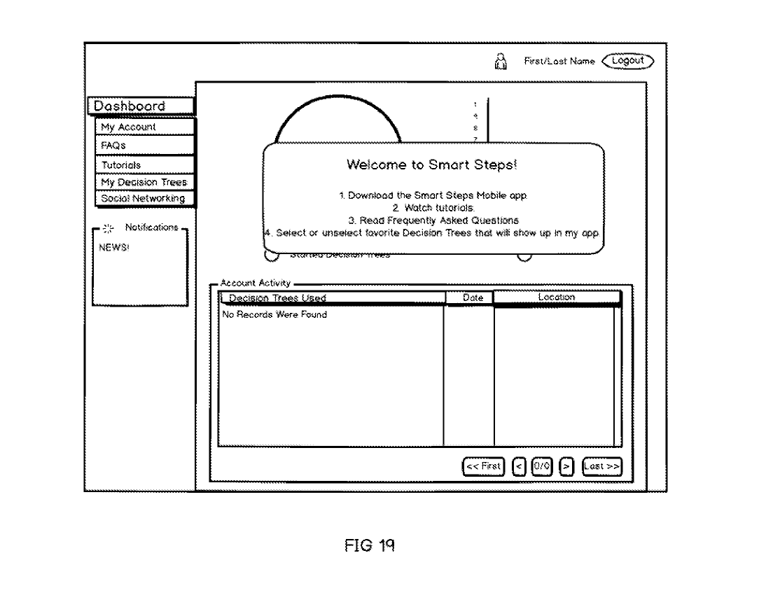

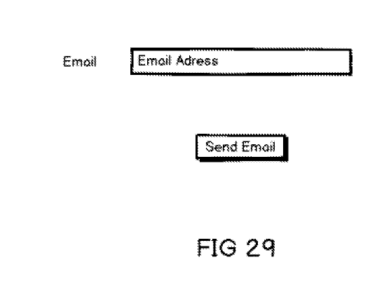

FIG. 12 illustrates an exemplary system user or admin user screen flow process 520 whereby a system user such as the admin-user may utilize various system 110 features further discussed above and below. As illustrated in FIG. 12, a system marketing screen 510 may be displayed allowing the user to sign-in 522. If successfully signed-in the user dashboard 480 screen may be displayed showing various account information discussed above and below (FIG. 19). The system 110 can also provide other commonly utilized sign-in features such as password reset 526 (FIG. 29, 30, 31) to facilitate resetting the user password and resetting the use password to a system generated password with an email being sent to the user email account associated with the account with a link to sign-in or a new password for the previously registered user to sign-in to the system 110. From the dashboard 480, the user can navigate to other screens such as the My Account screen 478, the tutorials 484, the FAQs 482, Decision Trees 123. My Full Profile (FIGS. 37-41) and Settings (FIGS. 43-44).

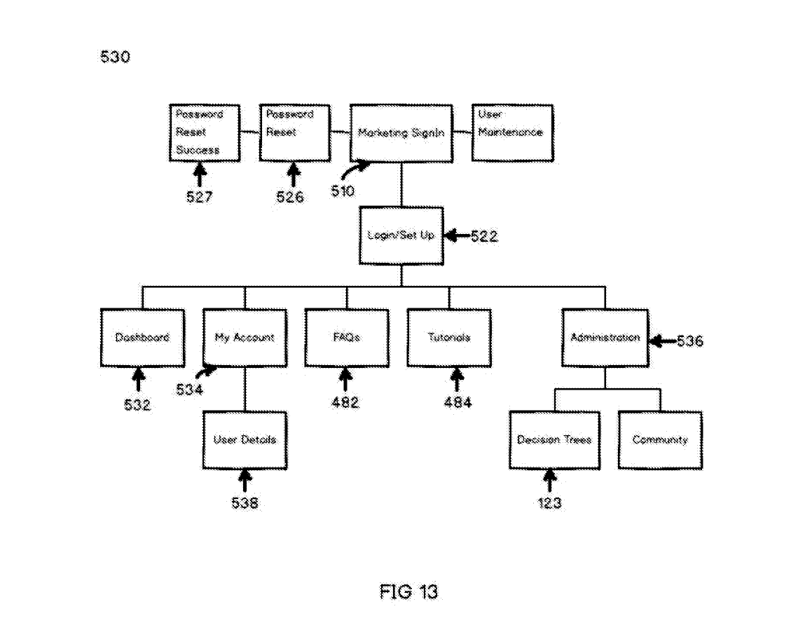

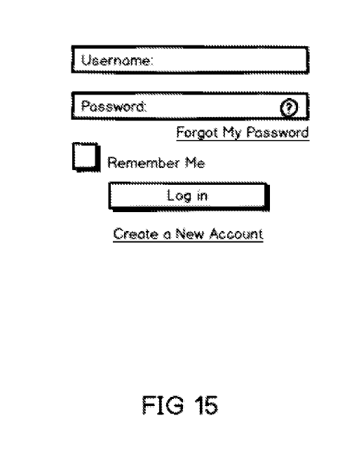

FIG. 13 illustrates an exemplary admin user 129a screen flow process 530 whereby a higher level administrative user such as the admin user 129a or a system administrative user (not shown) may utilize various system 110 features further discussed above and below. As illustrated in FIG. 13, a system marketing screen 510 may be displayed allowing the admin user 129a to sign-in 522. A representative sign-in screen is illustrated in FIG. 15. If successfully signed-in the admin user dashboard 532 screen may be displayed showing various system information such as that depicted in FIG. 32 showing system account summary charts and various system notifications. In an embodiment of the system, a single admin user may have access to the admin dashboard screen. Alternatively, the admin dashboard screen may be shared with plural organization users within a single organization or within affiliated organizations as desired such as a business, a university, a medical center or other organizations. Plural organizations admin users may have shared access to the admin user dashboard 532 or they may have partially restricted access to various subareas of the admin dashboard screen depending on the particular system configuration. Generally, the organization users who would have access to the administrative features of the system would be the ones who are involved in managing the organizations access to the system 110, its users and clients. An account notifications area is illustrated on a number of screens. The account notifications area may be used to indicate when a new user signs-up, upgrades to their account or that the account is disabled. In addition, the notifications area may provide an indication of the system status in general or with regard to specific situations.

The system 110 can also provide other commonly utilized sign-in features such as password reset 526 to facilitate resetting the user password and resetting the use password to a system generated password with an email being sent to the user email account associated with the account with a link to sign-in or a new password 527 resulting from the request for the previously registered user to sign-in to the system 110.

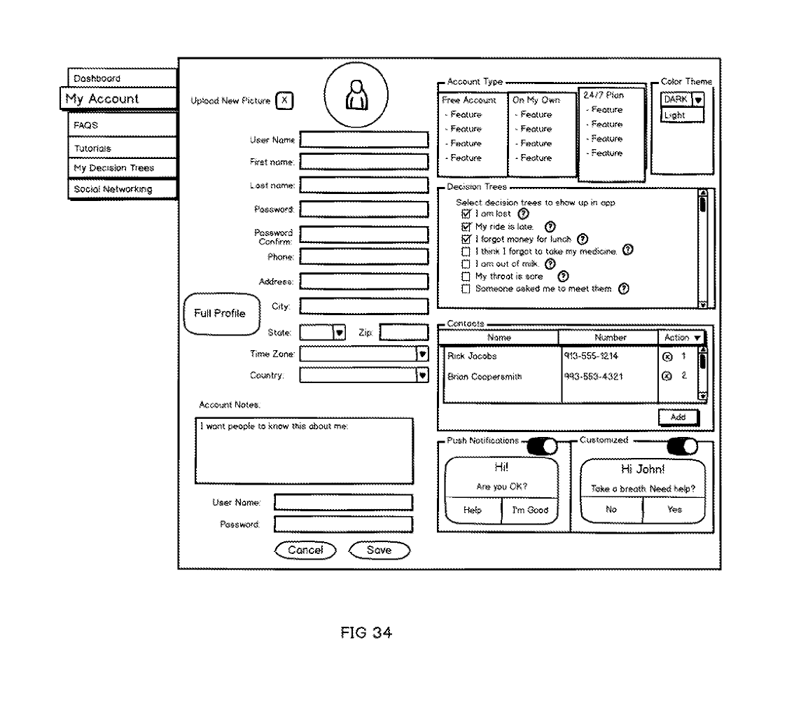

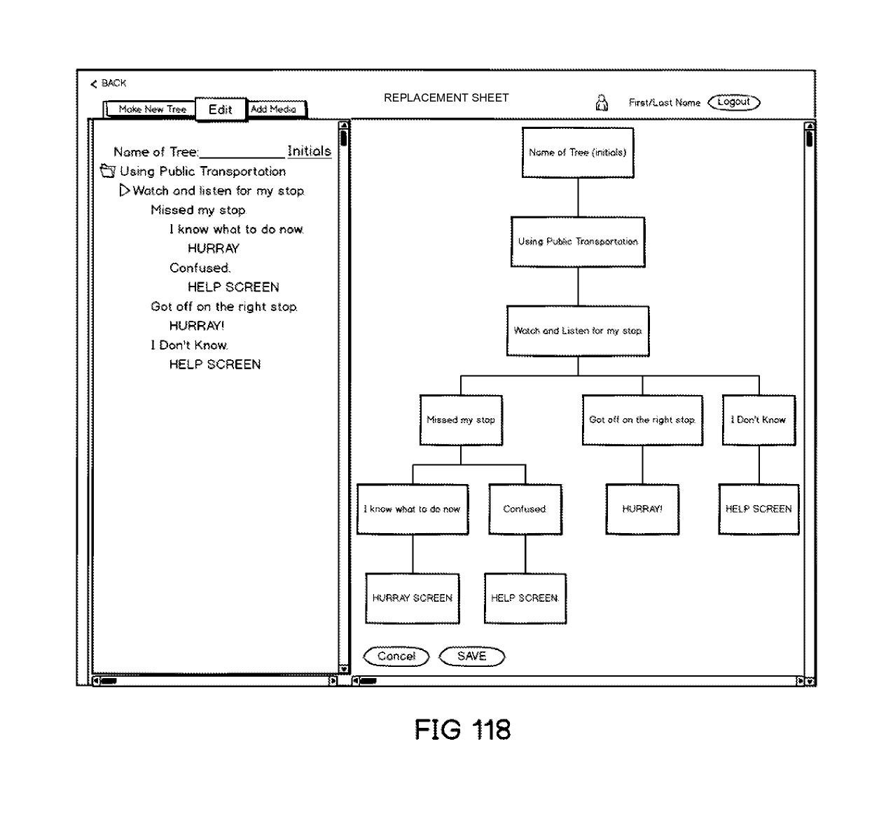

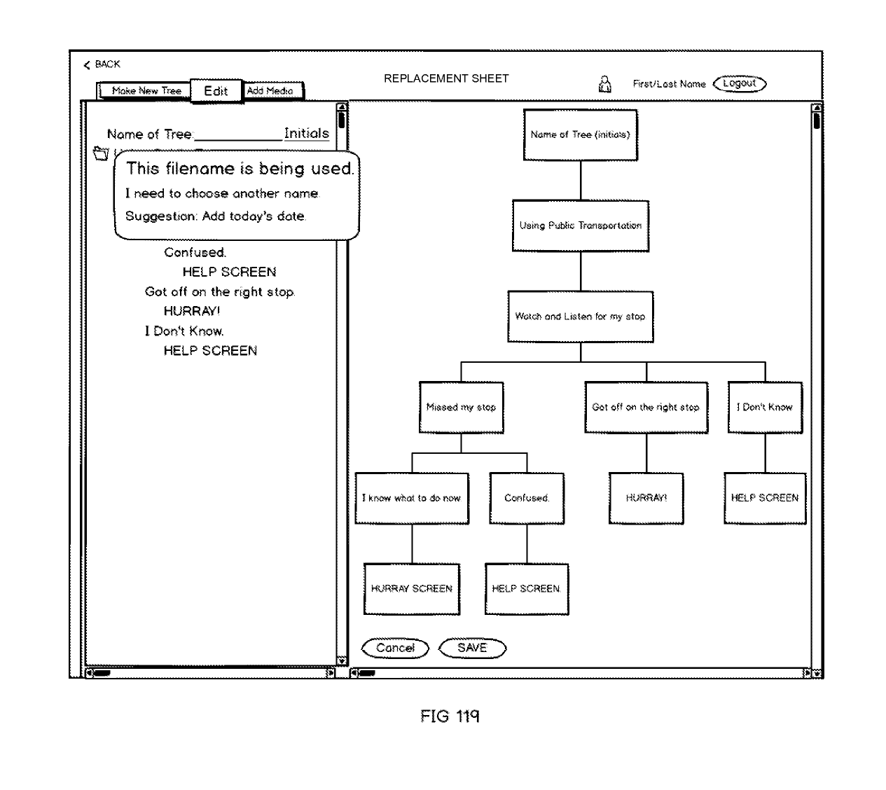

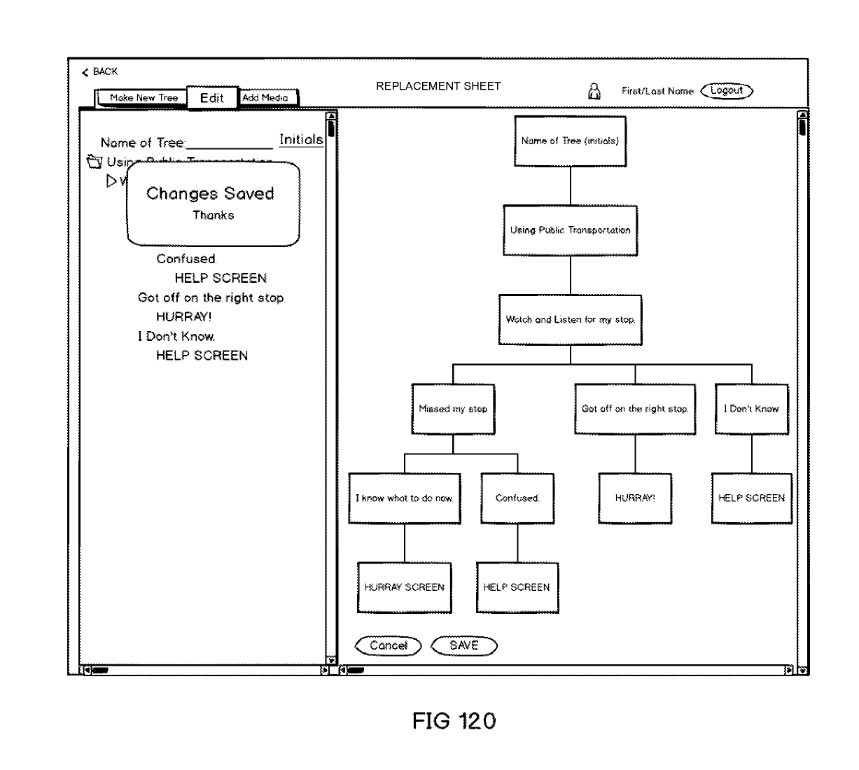

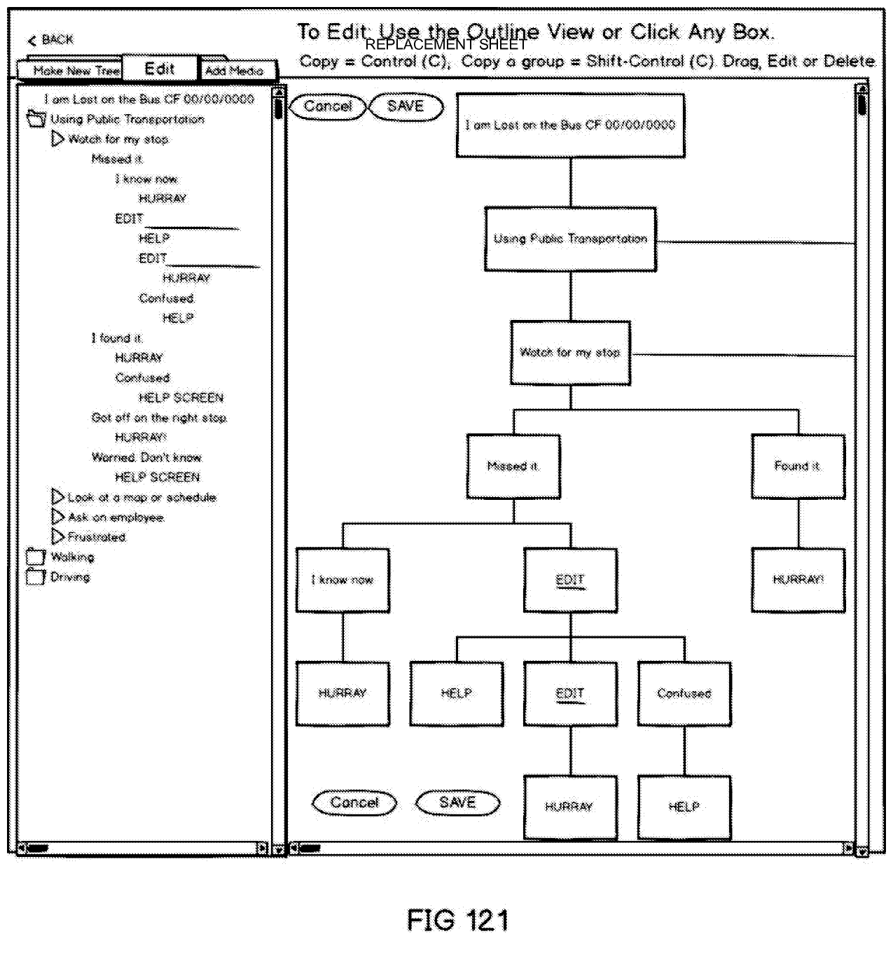

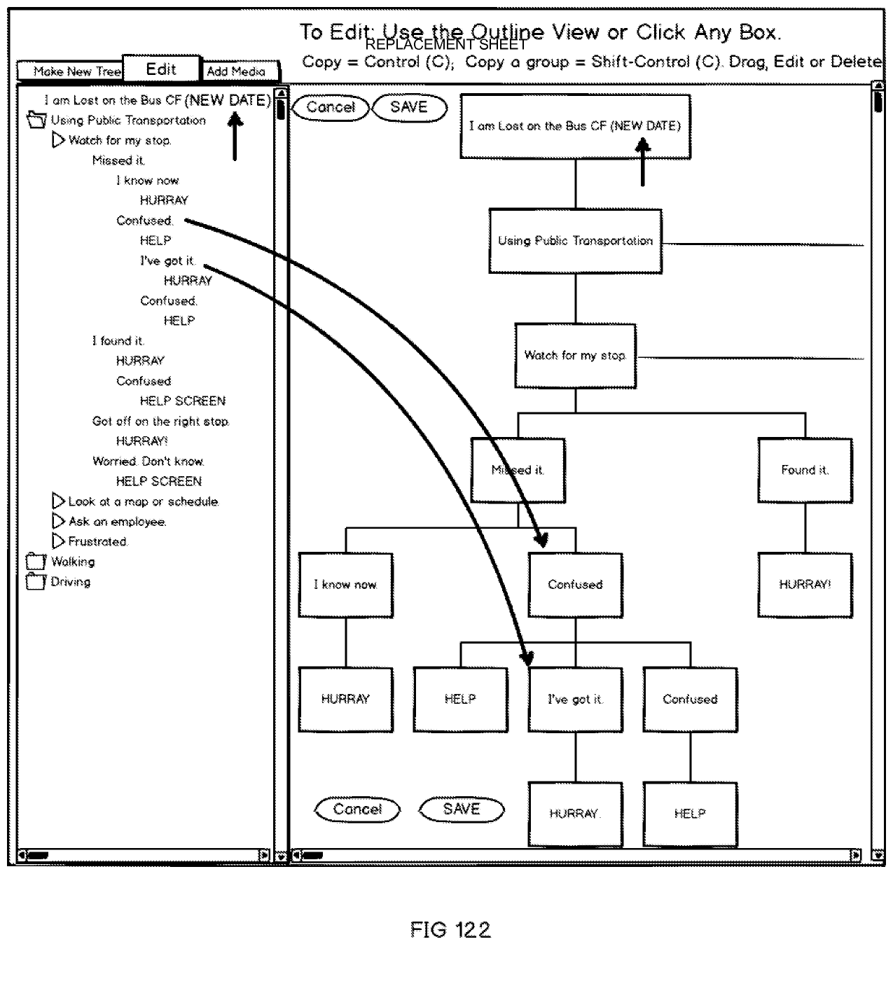

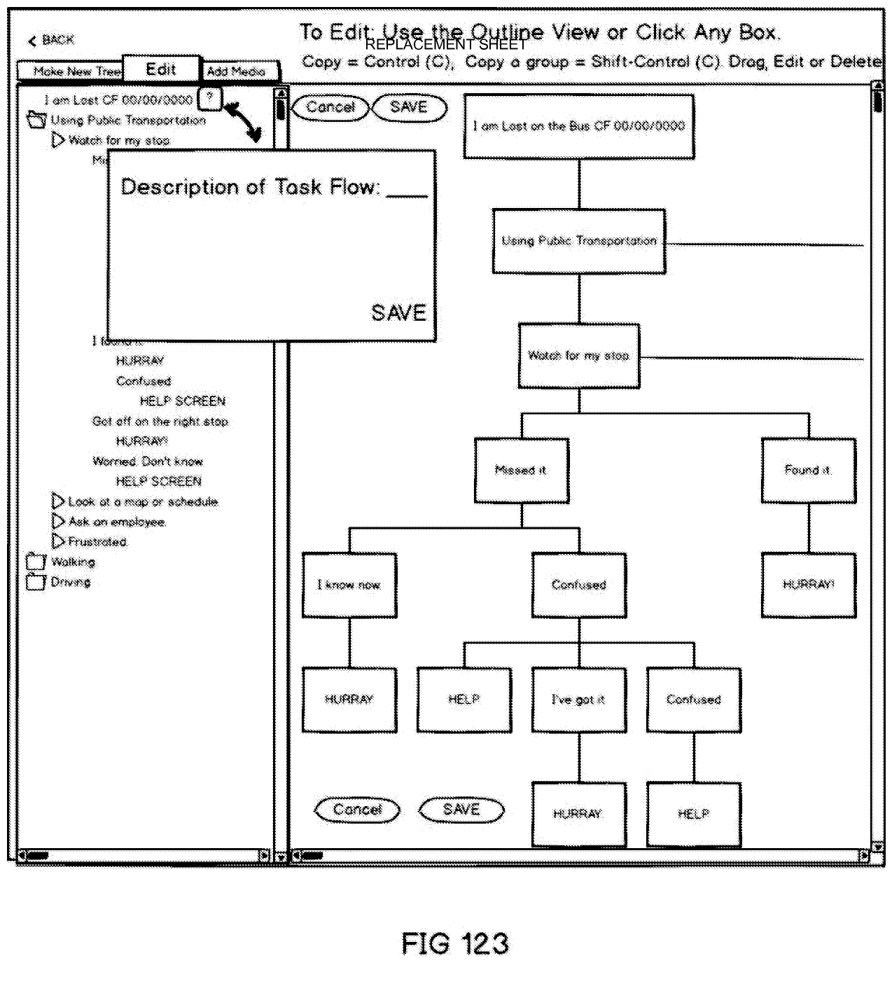

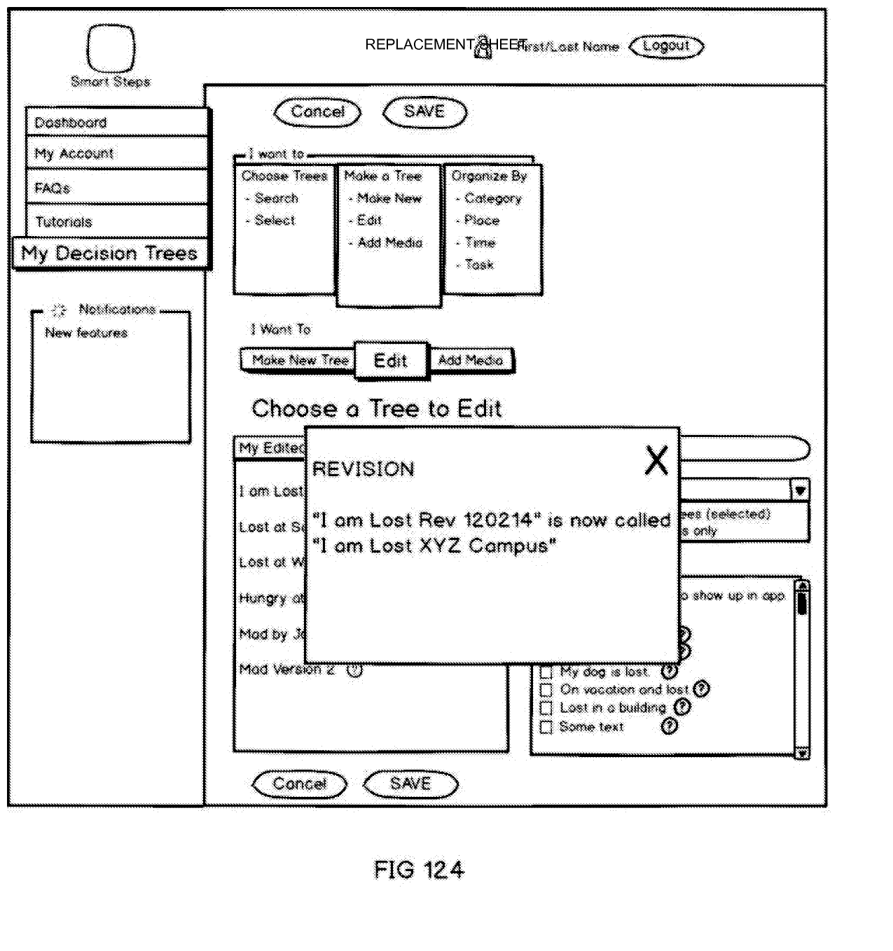

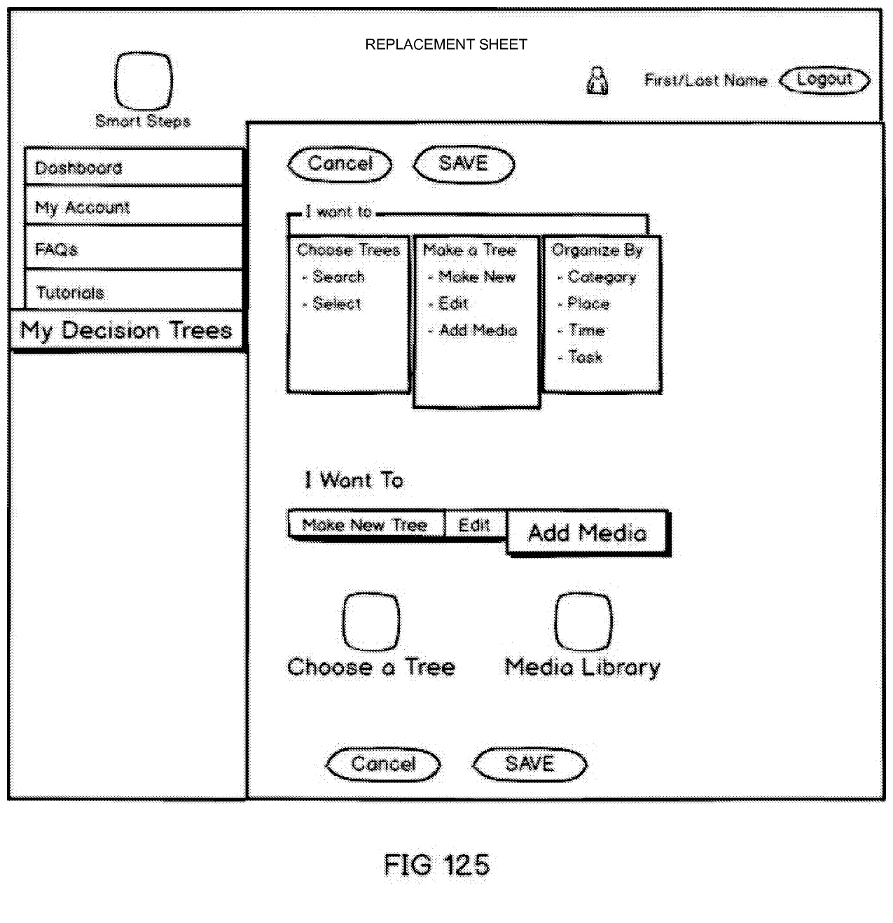

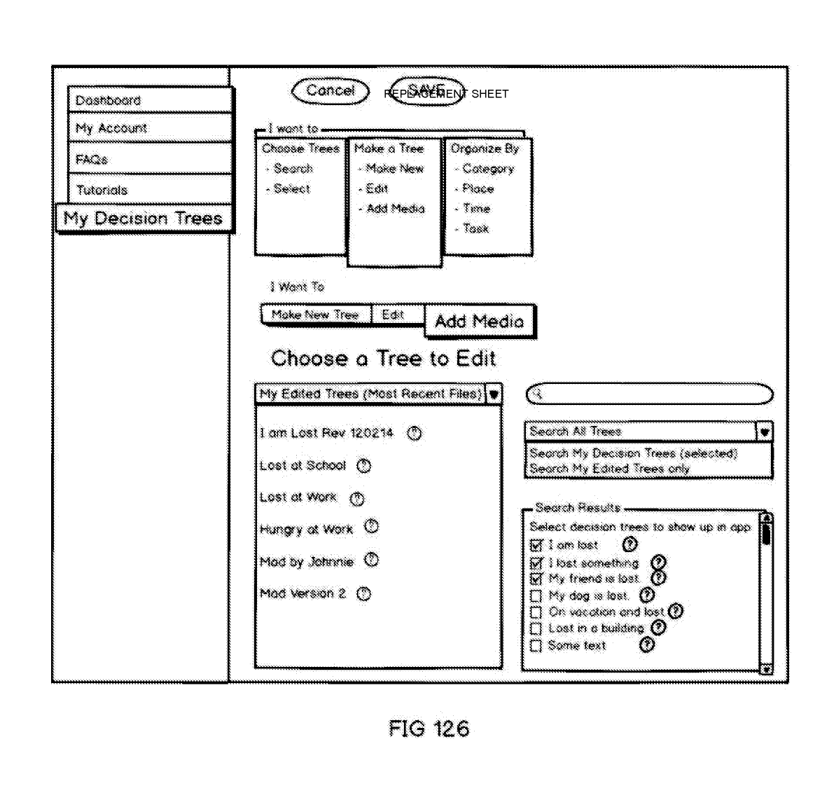

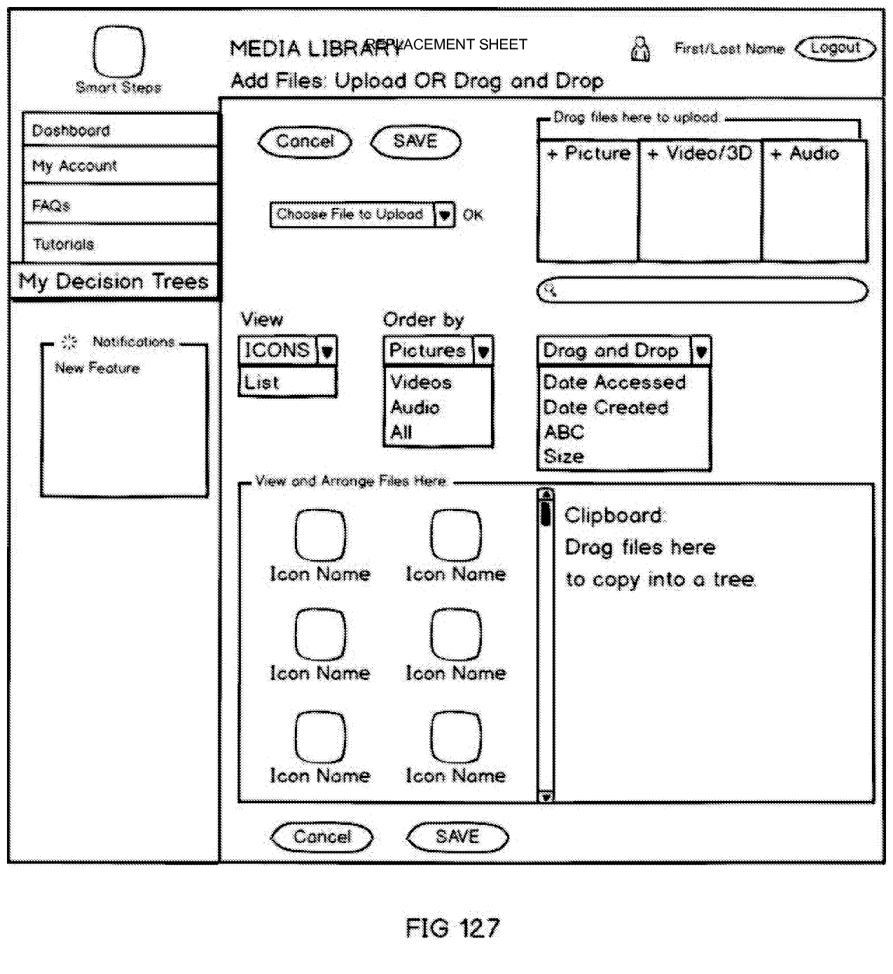

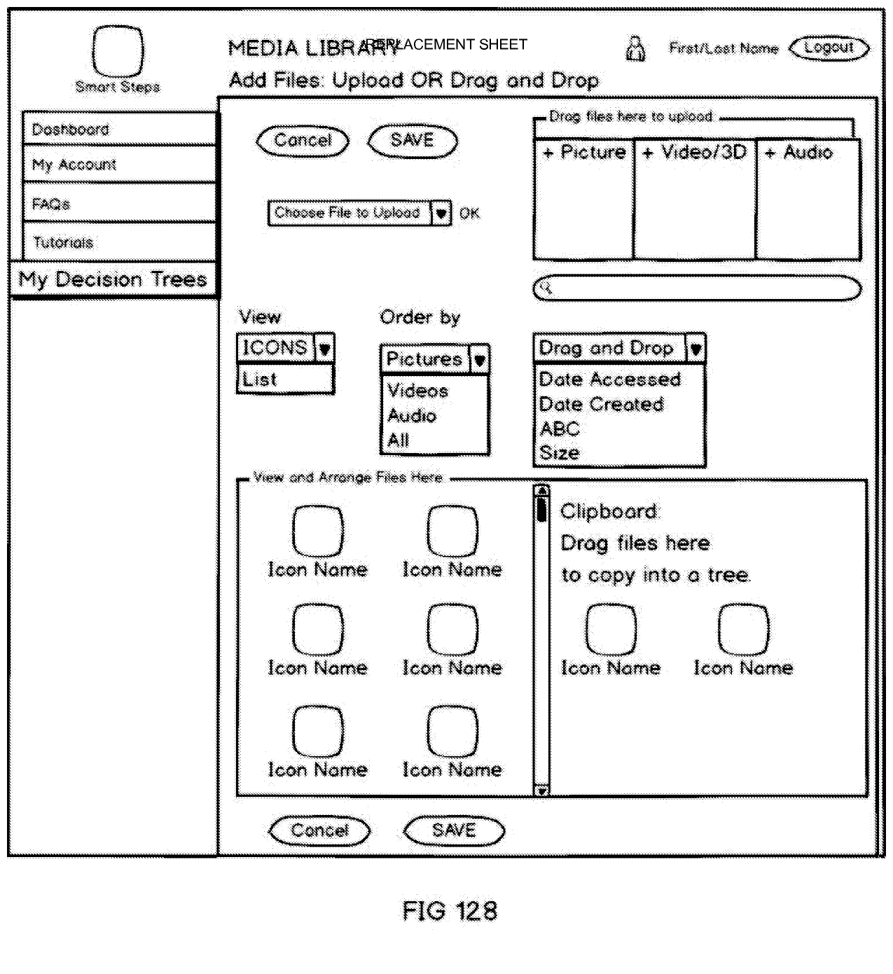

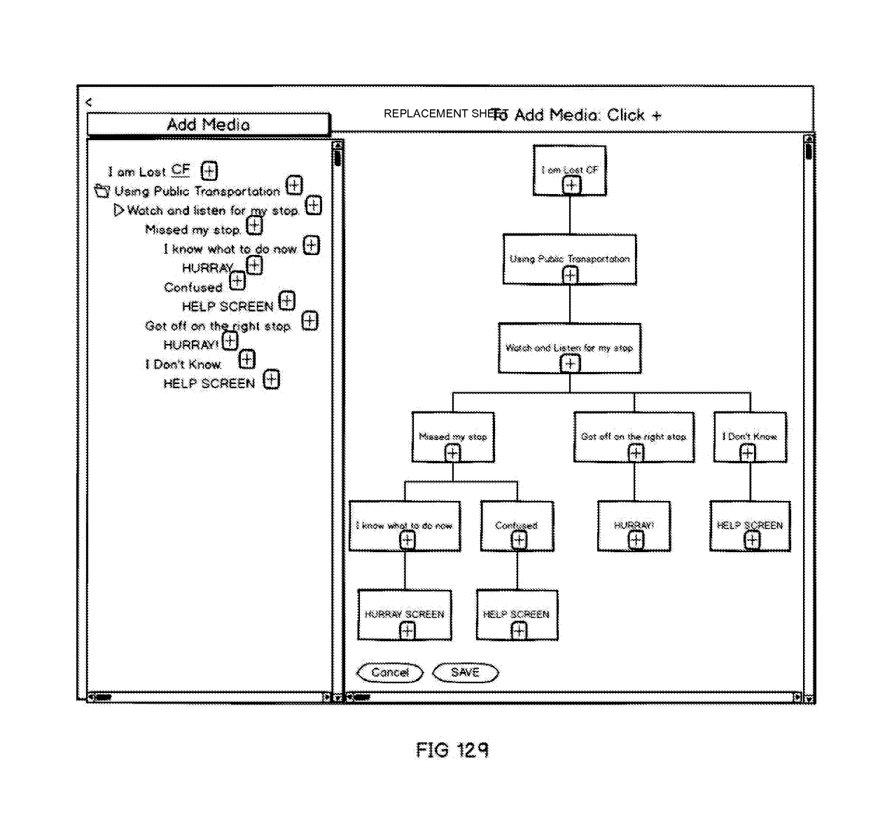

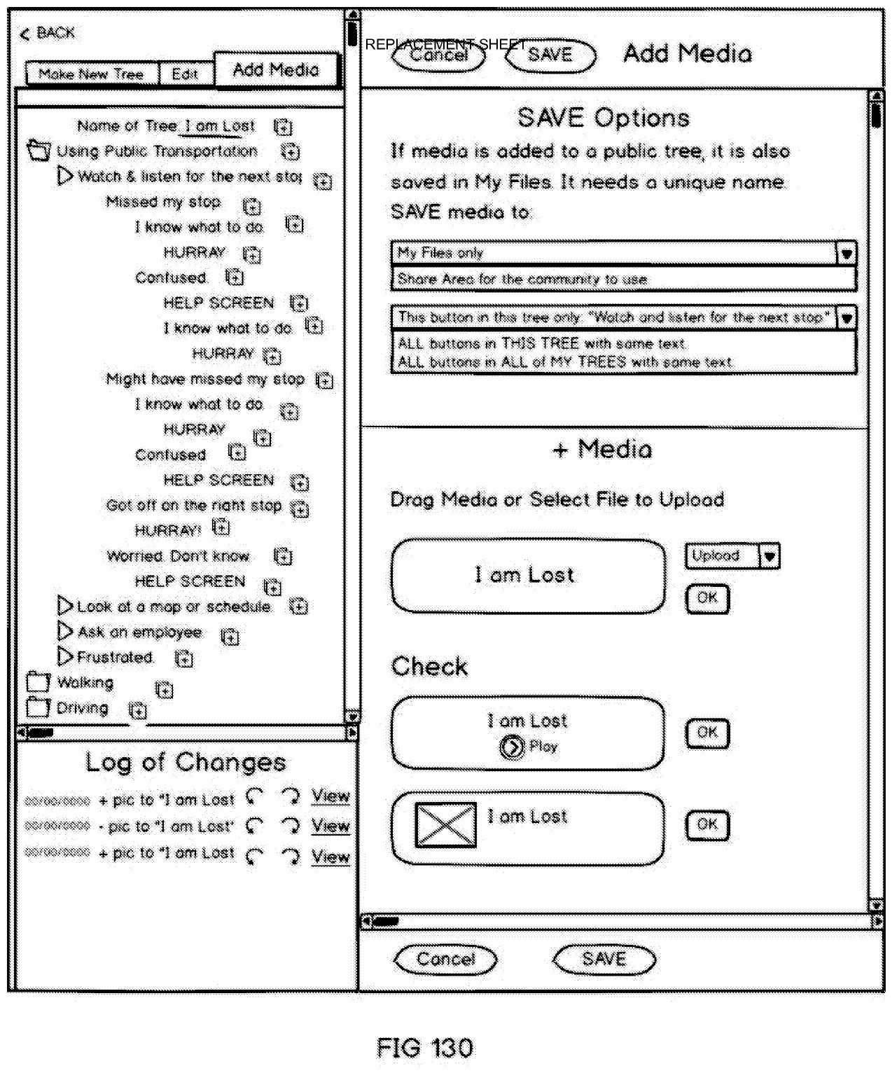

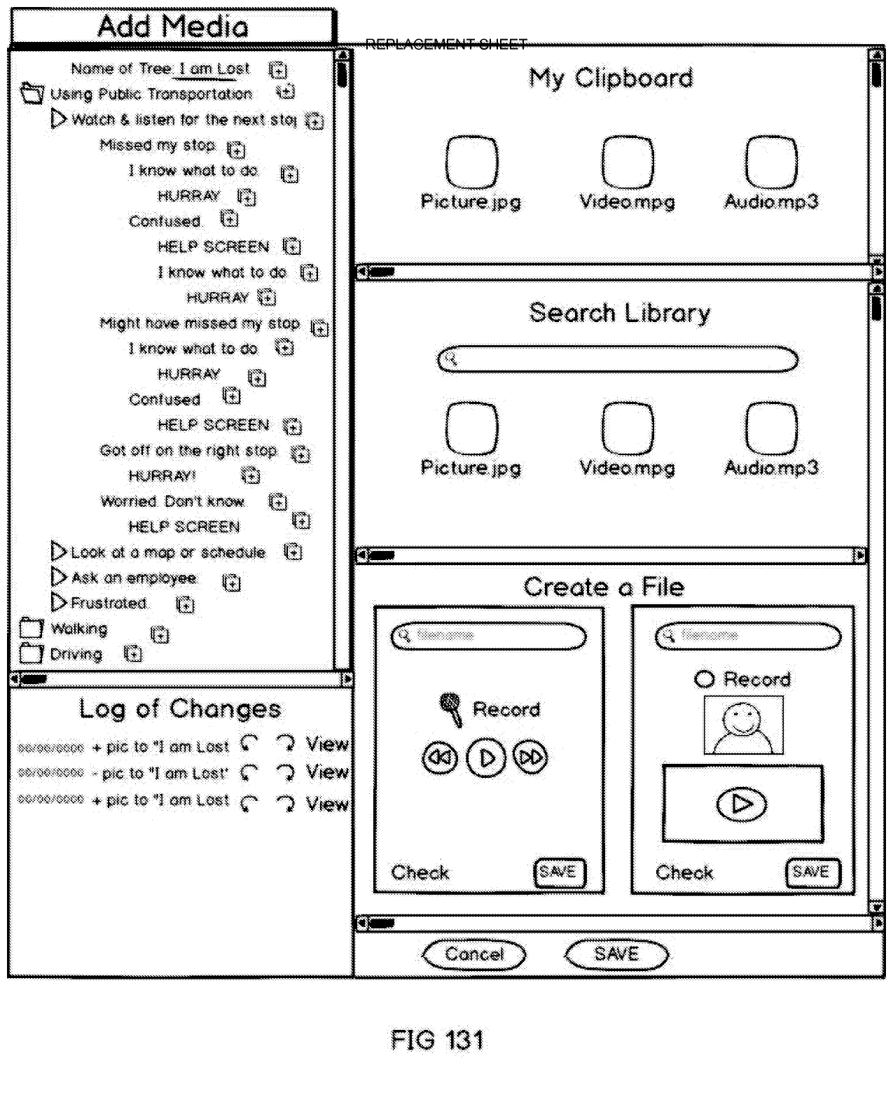

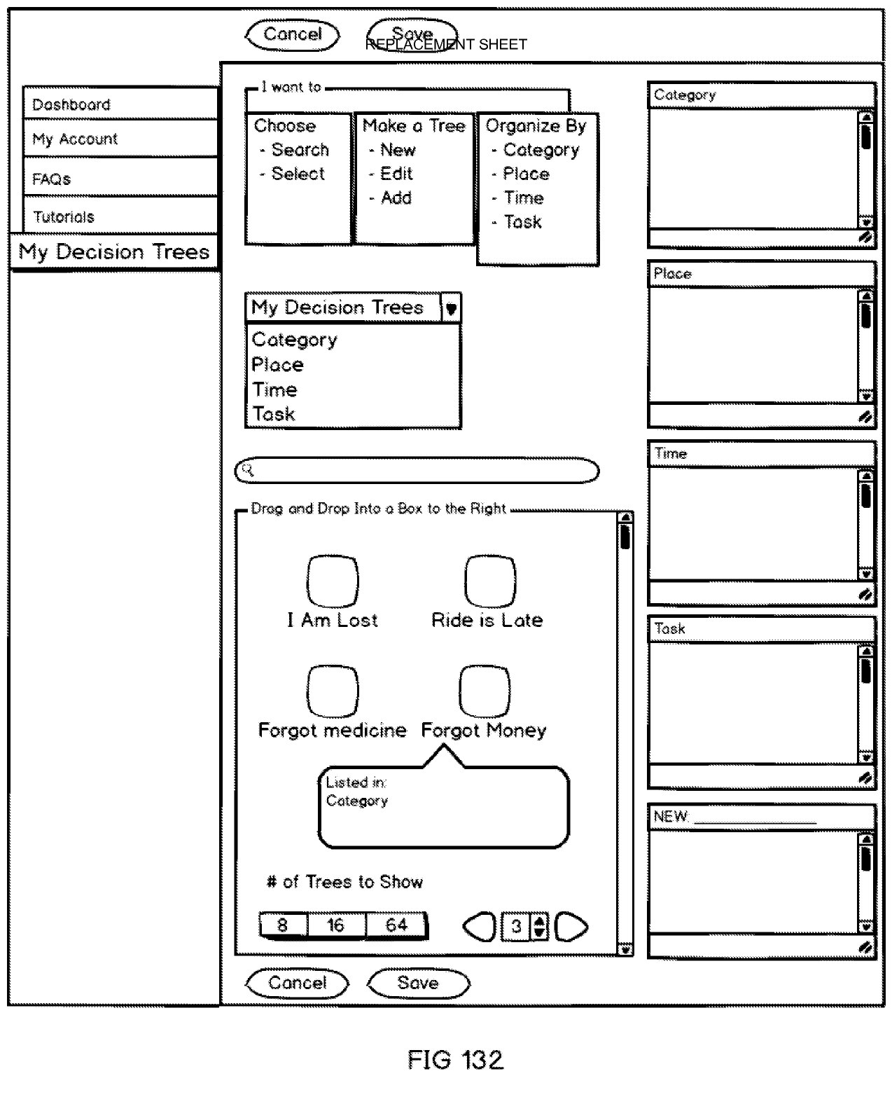

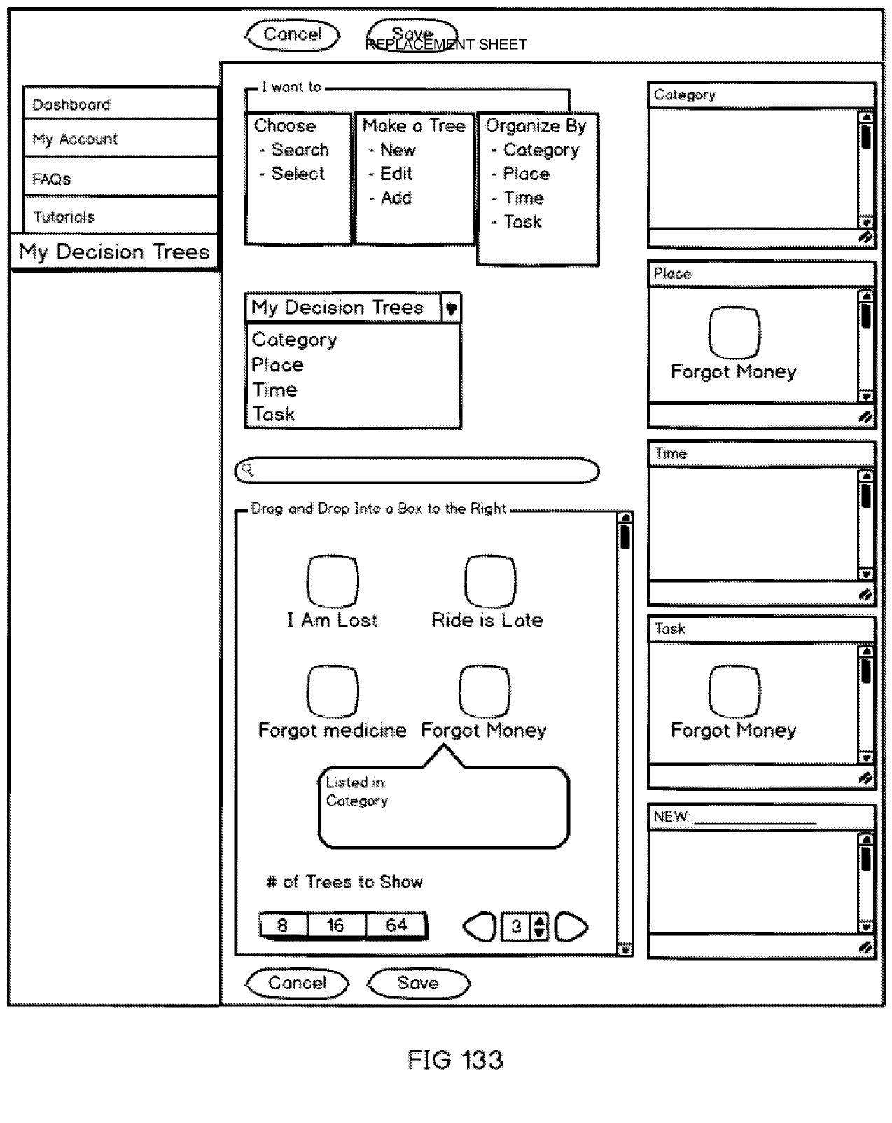

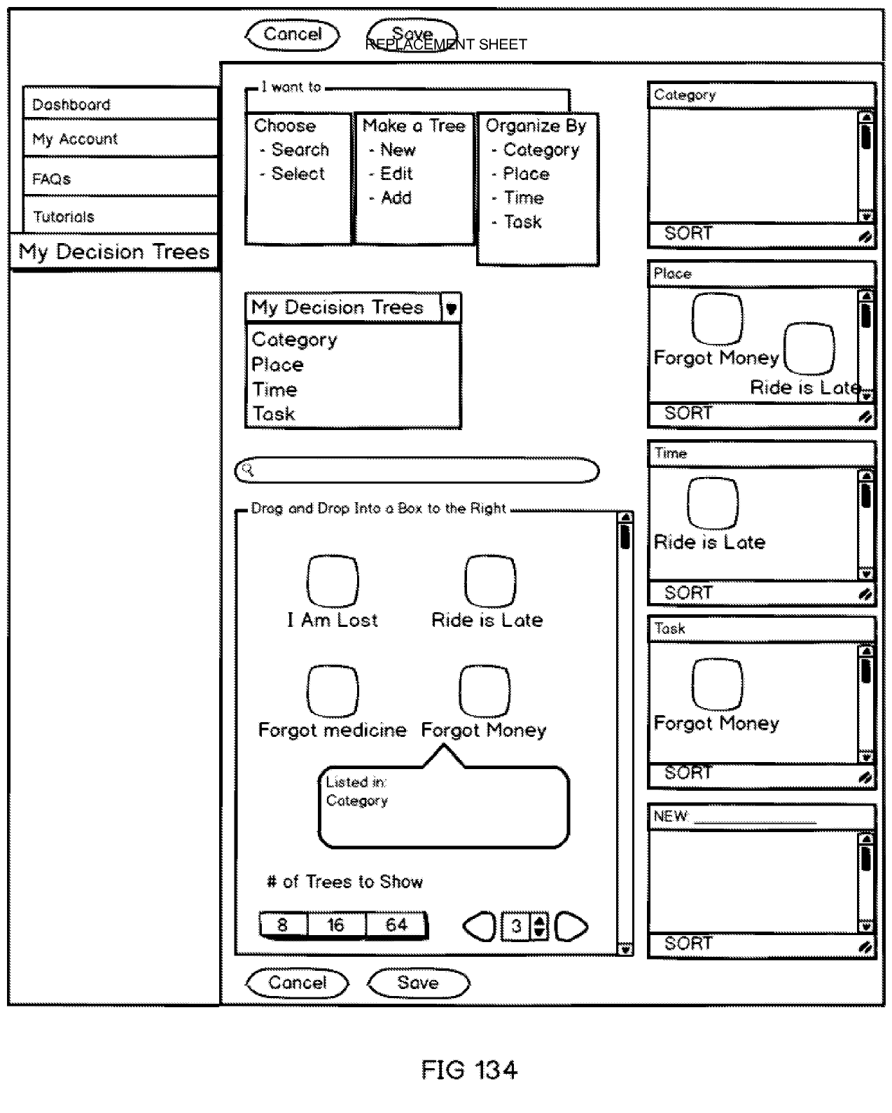

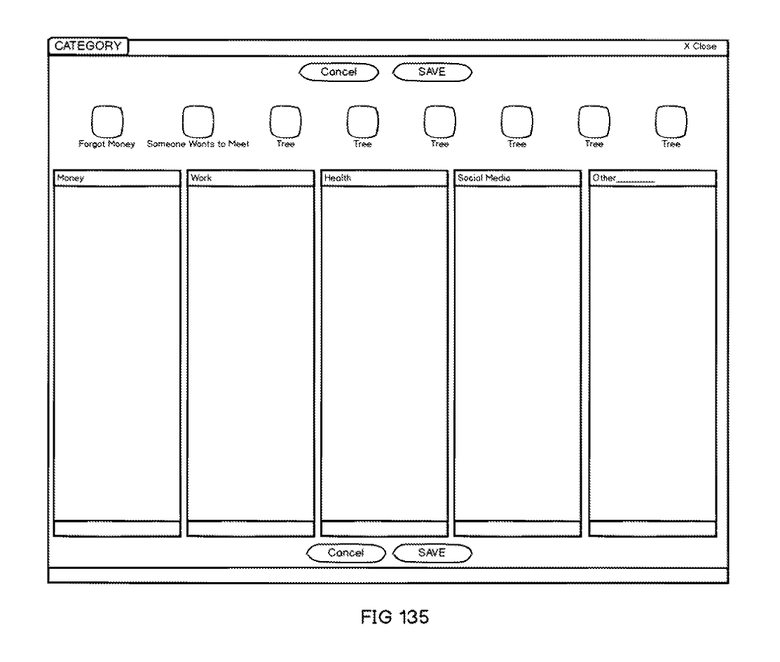

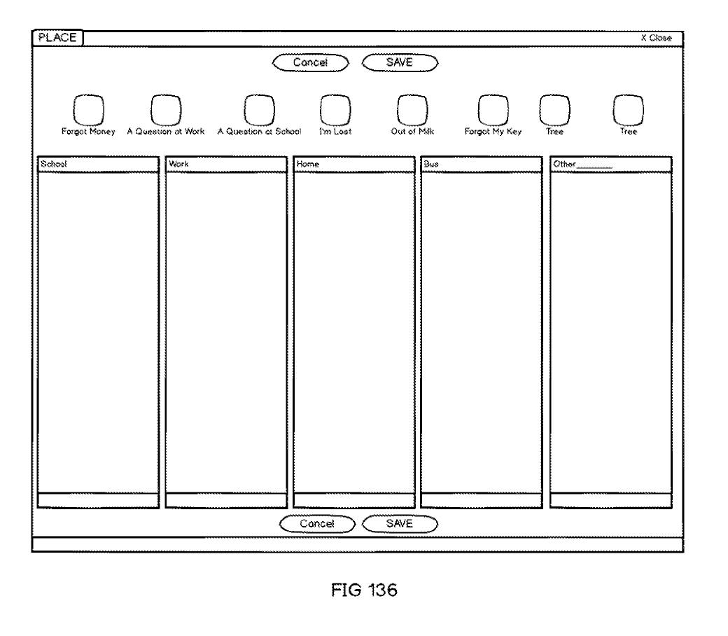

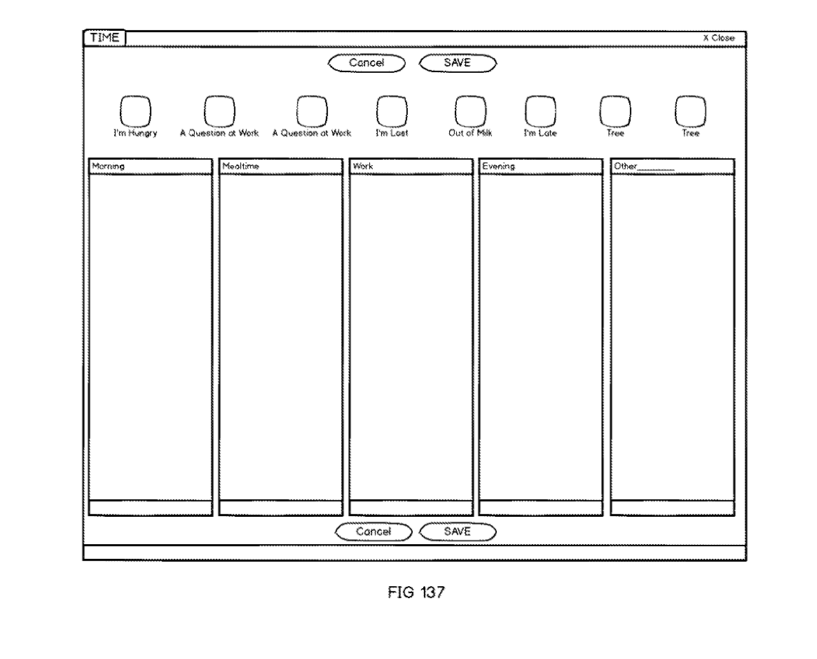

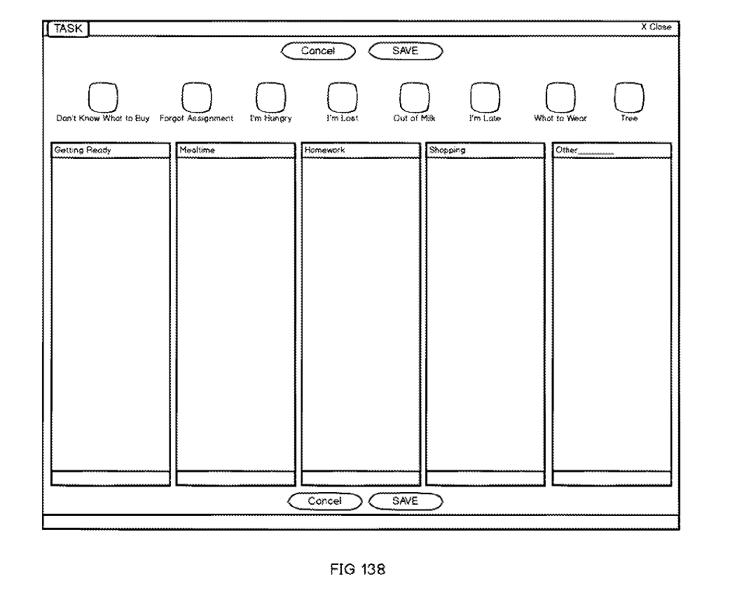

From the admin dashboard 532 illustrated in FIG. 32, the admin user 129a can select a different tab such as users 534 or an administration display screen 536. An example of the display screens which may be associated with the tab for Users 534 is provided in FIGS. 34-36 with a user listing summary screen being provided in FIG. 33, a specific account detail screen being presented in FIGS. 34 and 35 and a sorted account listing screen being provide in FIG. 36. As illustrated in FIG. 33, the admin user 129a may select a particular account to review user details 538 or perform other user functions as further discussed below. An example of the display screens which may be associated with the administration tab is provided in FIG. 118-122. The admin user 129a is generally involved in configuring various system features and managing the social networking page.

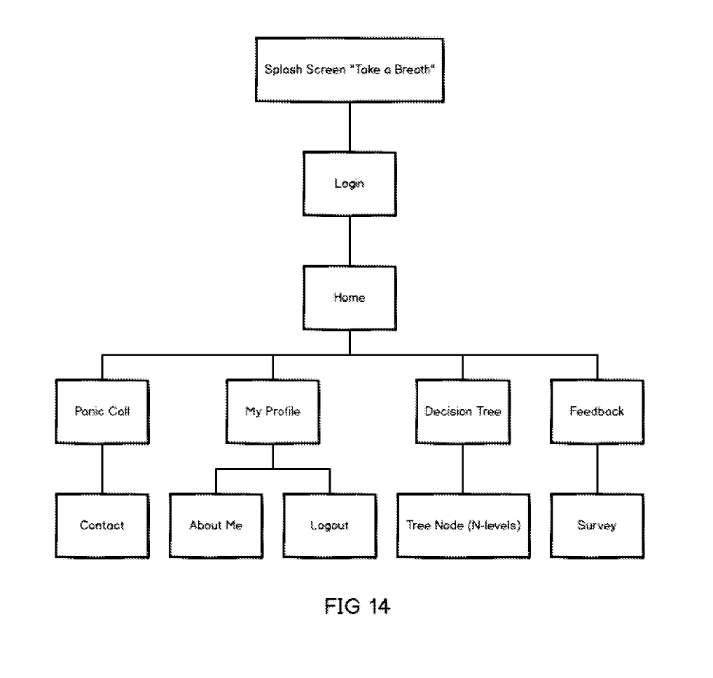

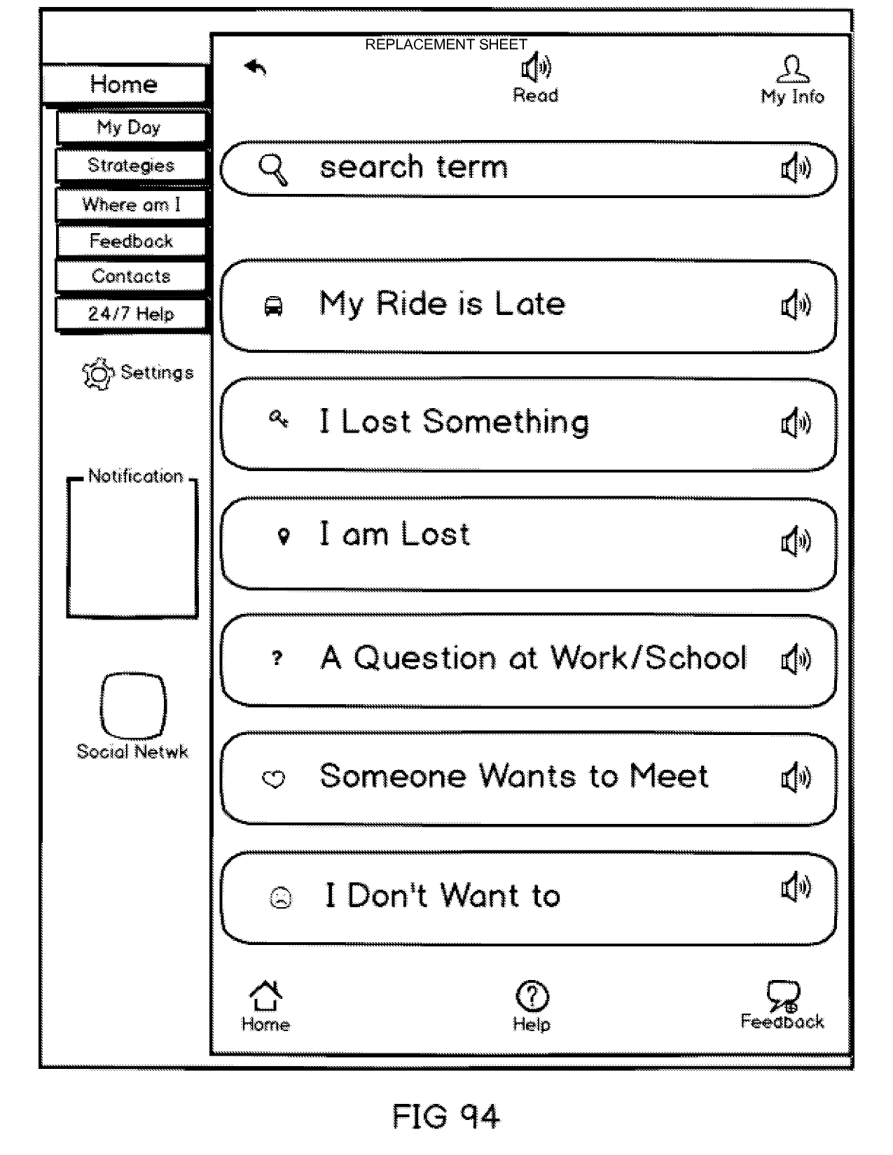

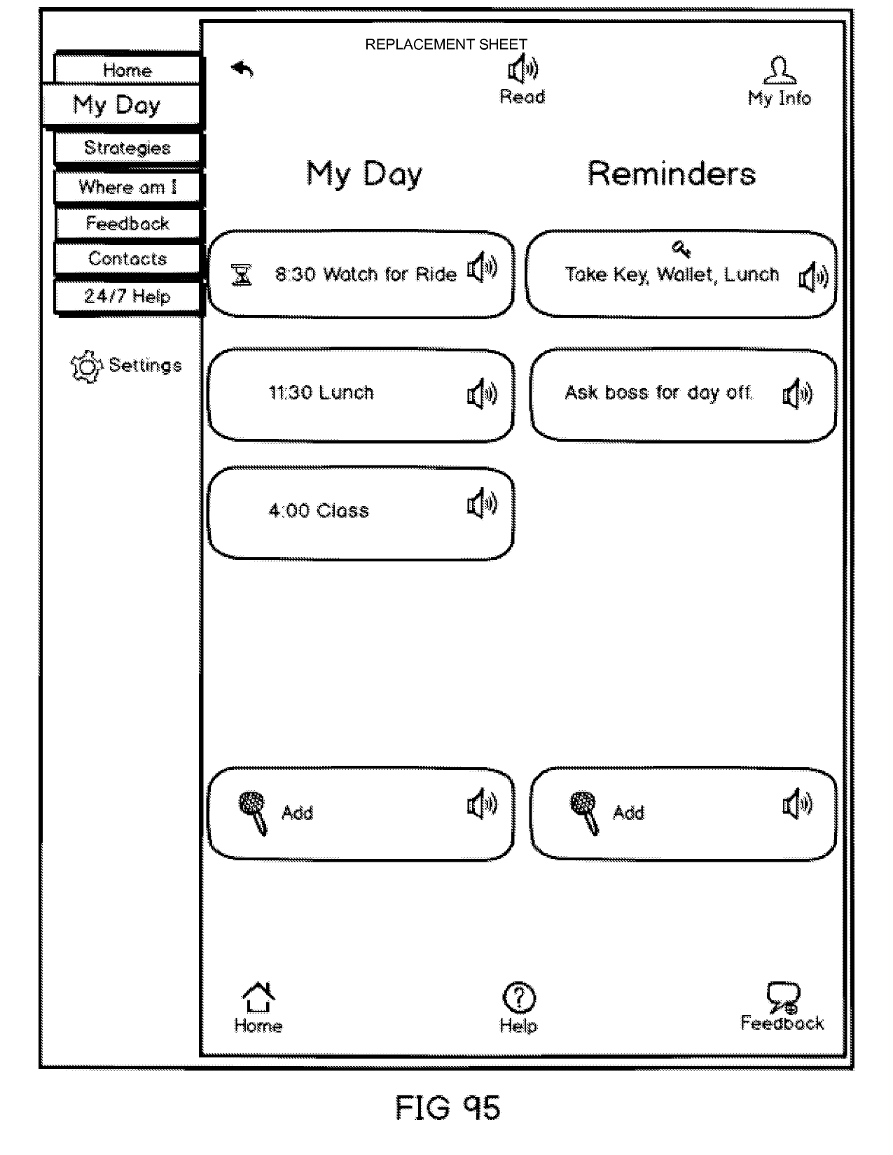

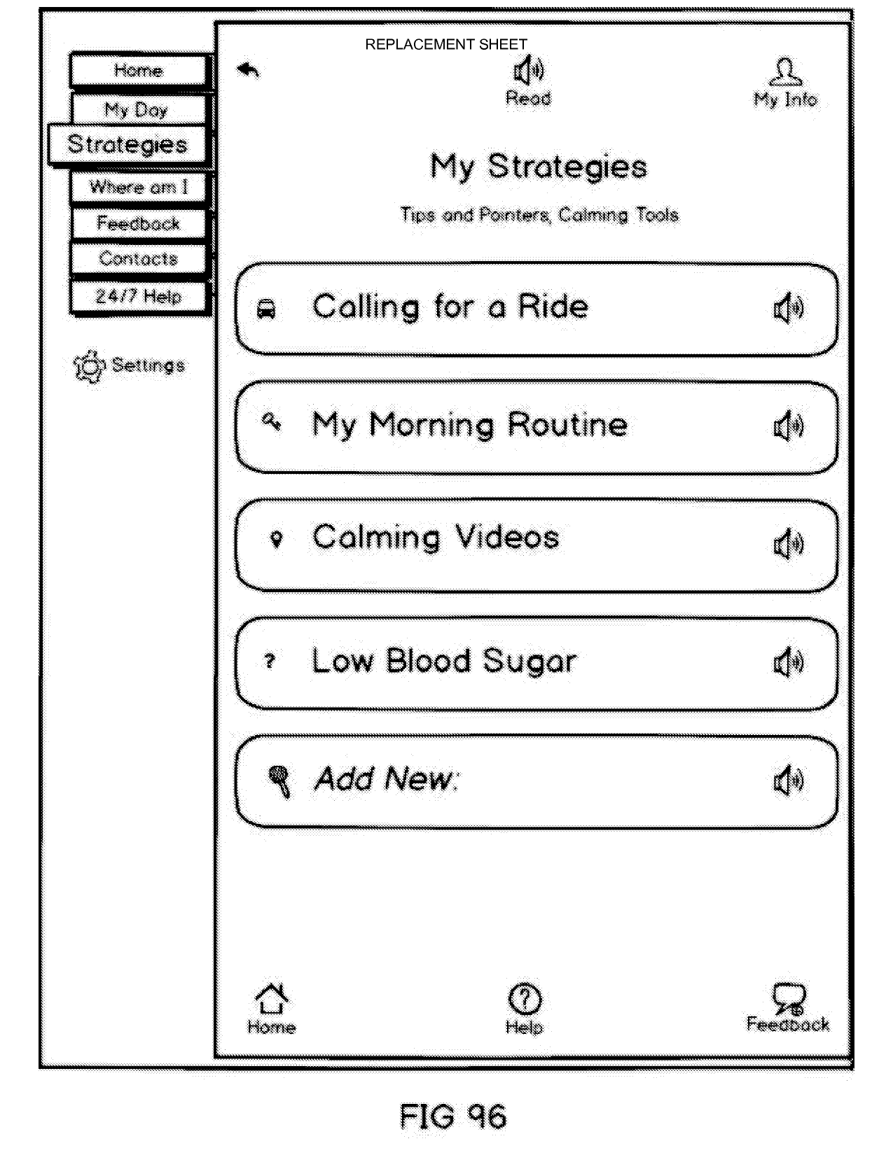

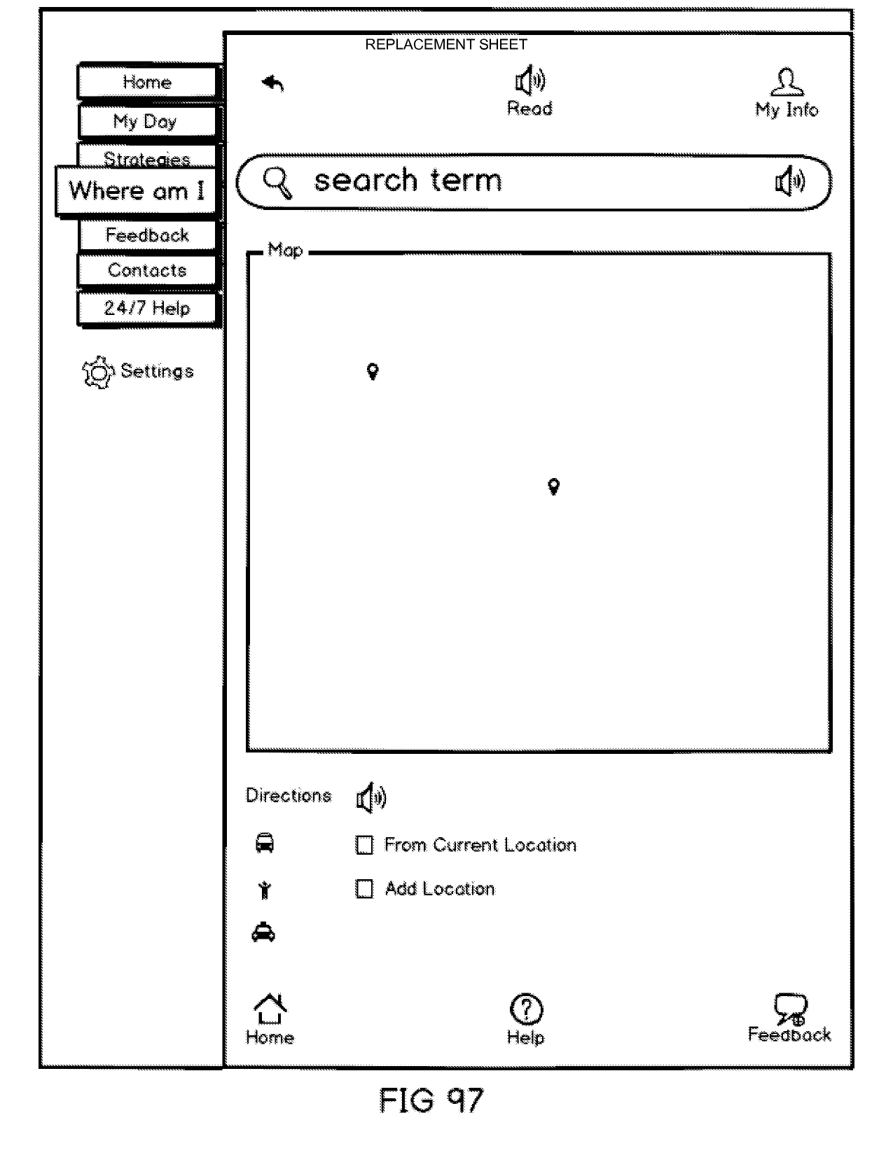

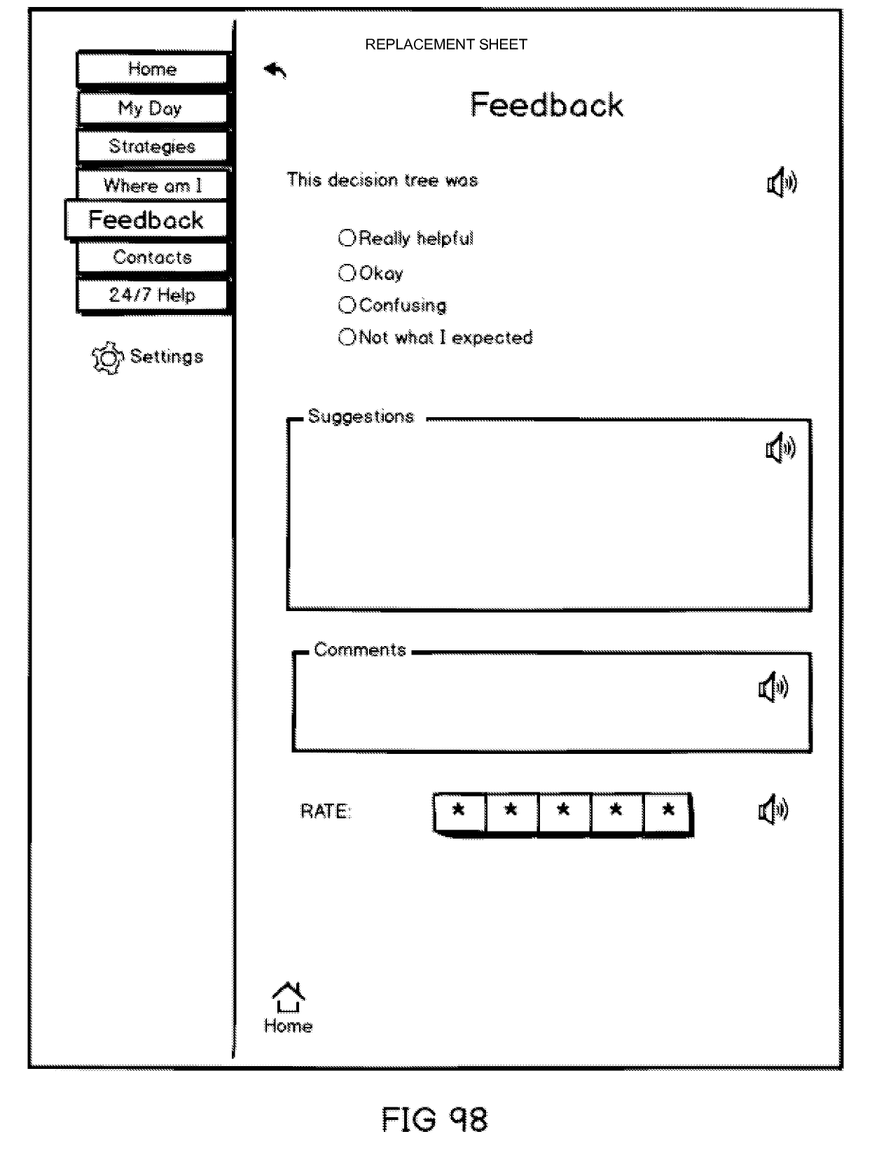

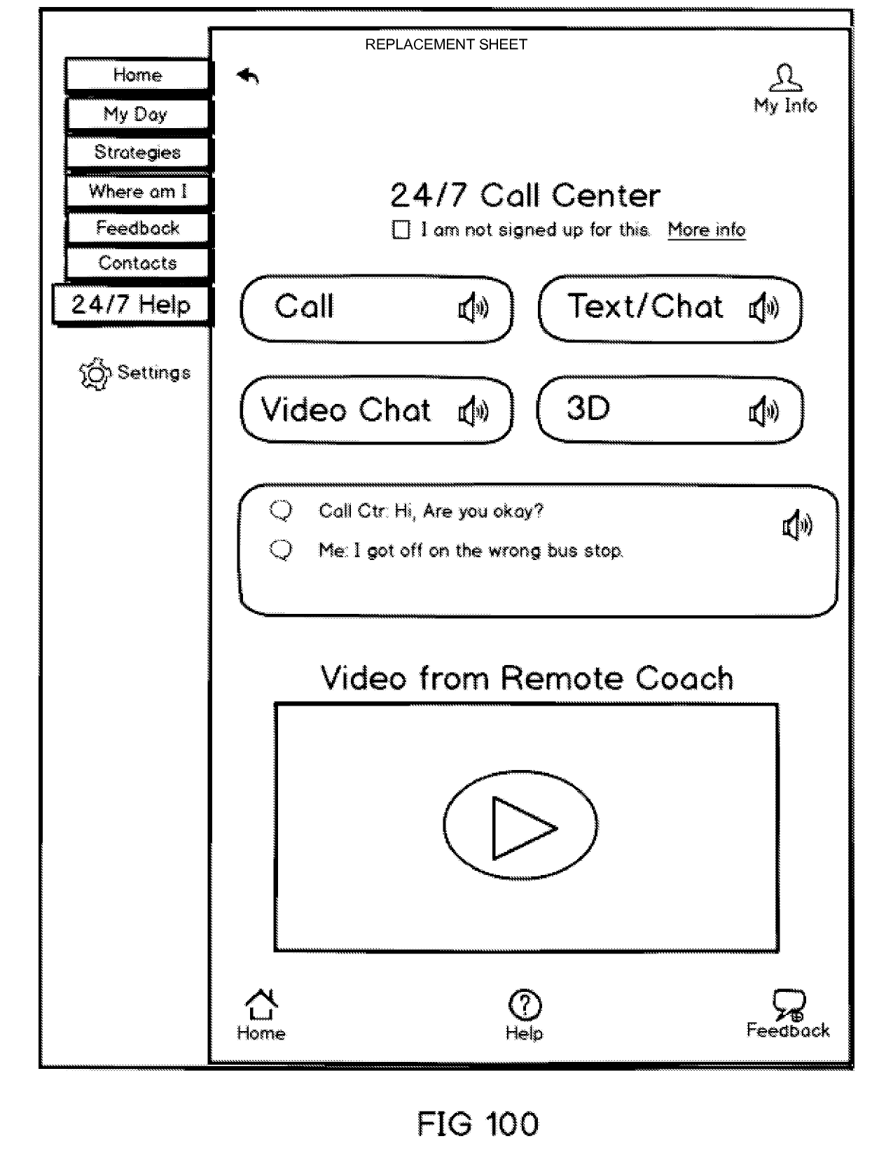

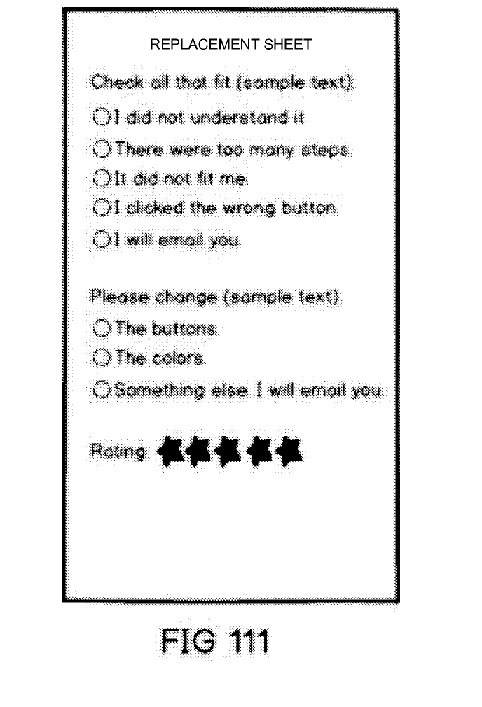

FIG. 14 illustrates an exemplary screen flow process 540 for the system user 128 whereby the system user 128 such as a parent, guardian, relative, caregiver or even the cognitively disabled user 117 may utilize various system 110 features further discussed above and below. As illustrated in FIG. 13, a system splash screen 542 may be displayed allowing the user to login 544. The system splash screen 542 may include some message to reduce anxiety which the user may be feeling such as a sound or message like “TAKE A BREATH.” Once the cognitively disabled user 117 is logged into the system 110, they will be directed towards the previously configured home screen FIGS. 94 & 51. From the home screen the system user 128 may make a panic call FIGS. 108, 109 and 100, they may review, create or modify their profile 84, 85, 86 and 99, review, modify and organize selected decision trees 87 and 88 or provide various system feedback FIG. 111 and take a system survey FIG. 98, upload pictures (FIG. 86), make purchases (87, 88), view tutorials (FIG. 89), view dashboard (FIG. 90), view/edit colors (FIG. 91), customize avatar (FIG. 92), other settings (voice, location, reports) (FIG. 93), view my location (FIG. 97), my schedule and reminders (FIG. 95), communicate with call center (FIG. 100), my strategies (FIG. 96).

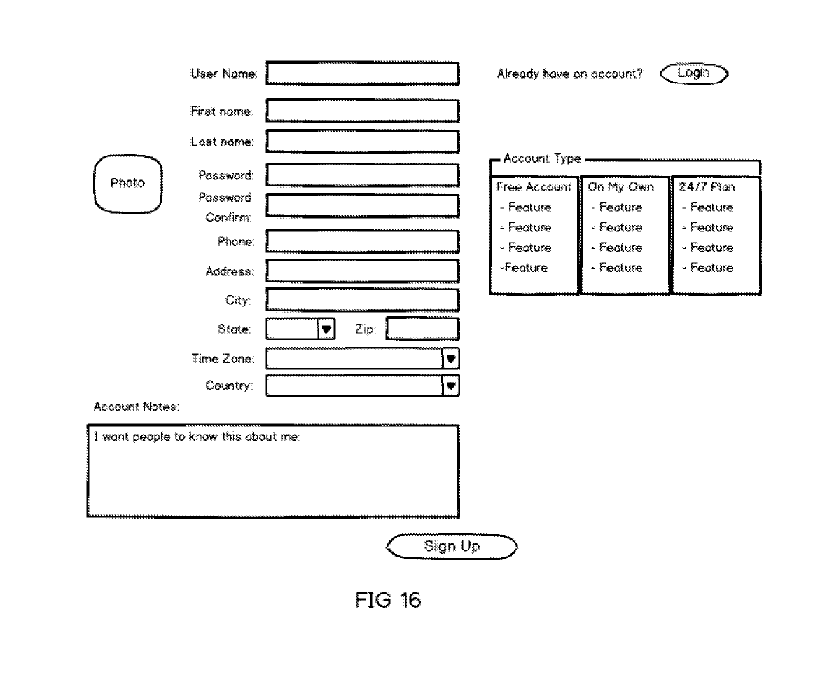

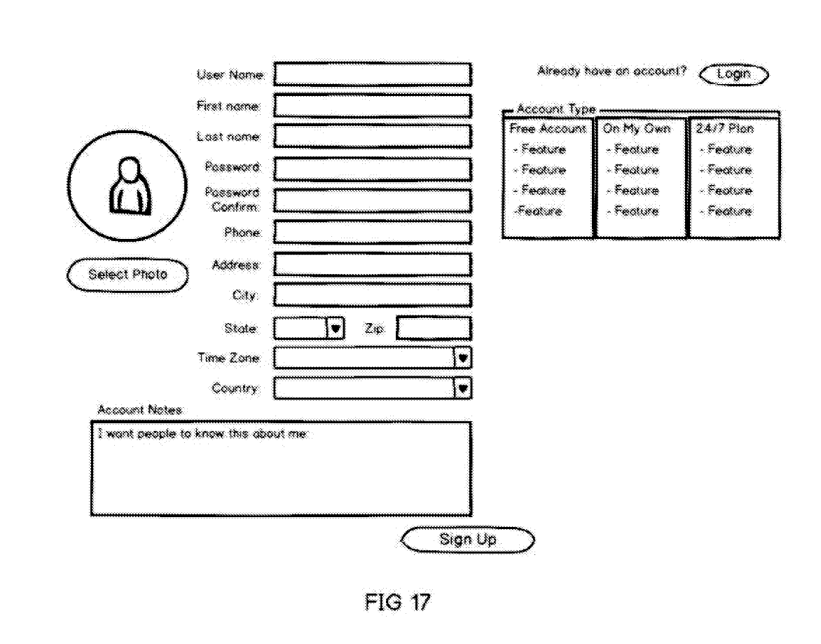

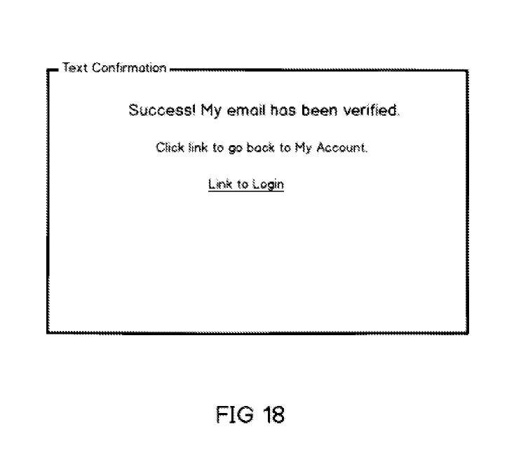

In operation, a non-system user 118 may create an account using the Create a New Account feature illustrated in FIG. 15. Various user information may be provided as illustrated in FIG. 16 by the non-system user 118 in creating an account. Once the user information has been provided, the system 110 may verify the non system user information with for example an email verification as illustrated in FIG. 18. Once the system 110 has verified the user information, the non-system user may be registered as a system user 128.

Once registered as a system user 128 and with the proper security credentials, as illustrated in FIG. 19 the system 110 may present a system user dashboard as illustrated in FIG. 19. Upon the initial display of the system dashboard the system 110 may direct the user 128 to download a client application on the cognitively disabled prosthetic device 114 and watch various system tutorials, and review provided system information.

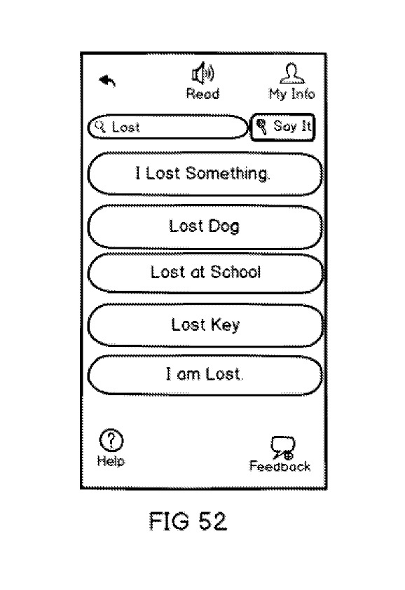

Prior to activation of the cognitively disabled prosthetic device 114 upon the system 110 the system user 128 may create the desired display aids 121 for display by the cognitively disabled prosthetic device 114 by selecting the desired decision trees 123 from the list of available decision trees as illustrated in FIG. 19. The cognitively disabled user 117 may search for decision trees 123 at any time as illustrated in FIG. 52.

FIG. 20 illustrates an exemplary cognitively disabled user profile screen, which allows for receipt of information related to the system user 128 including the selection of a plurality of decision trees 123 for processing by the system 110 to correspond to the display aids 121 presented by the cognitive prosthetic support device 114 by the system 110 to provide various user profile information and select from a list of preconfigured decision trees 123 to process the desired display aids 121.

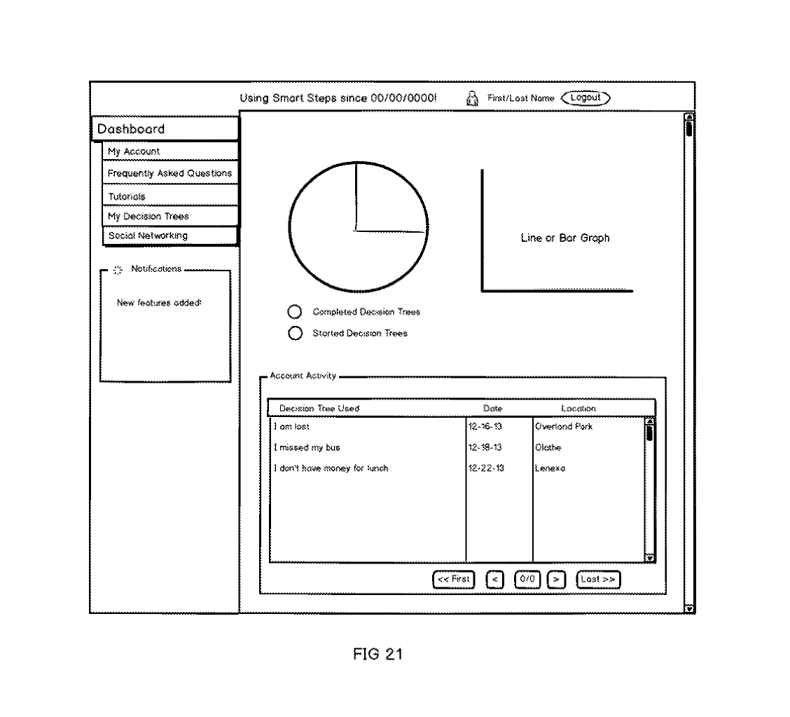

FIG. 21 is an exemplary user dashboard screen which presents a graphical interface for the system user 128 to view the system 110 configuration status. In addition to configuration status, the dashboard provides a listing of decision trees which have been utilized for creating display aids 121 on the cognitive prosthetic support device 114 along with information collected from the cognitive prosthetic support device 114 such as geolocation information and chronological information. The display aids 121 are transmitted from the storage device 113a connected to the content server 113 using the communication network illustrated in FIG. 1.

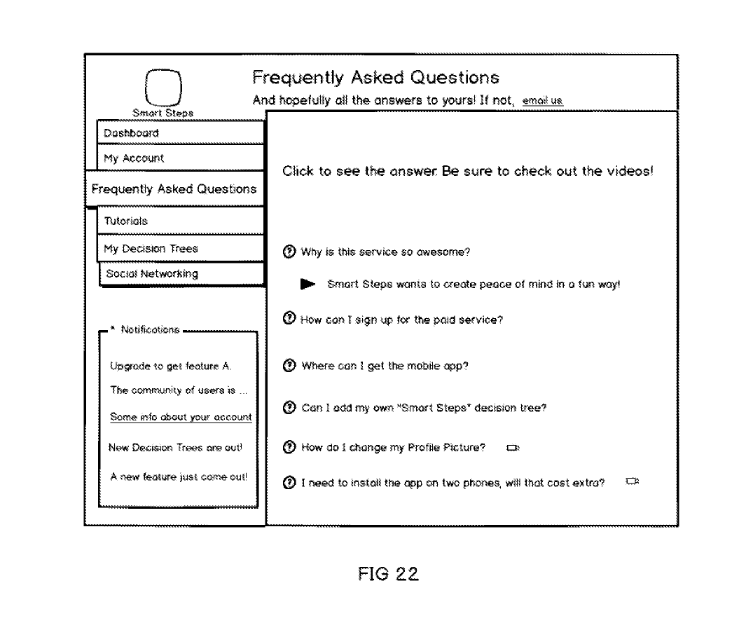

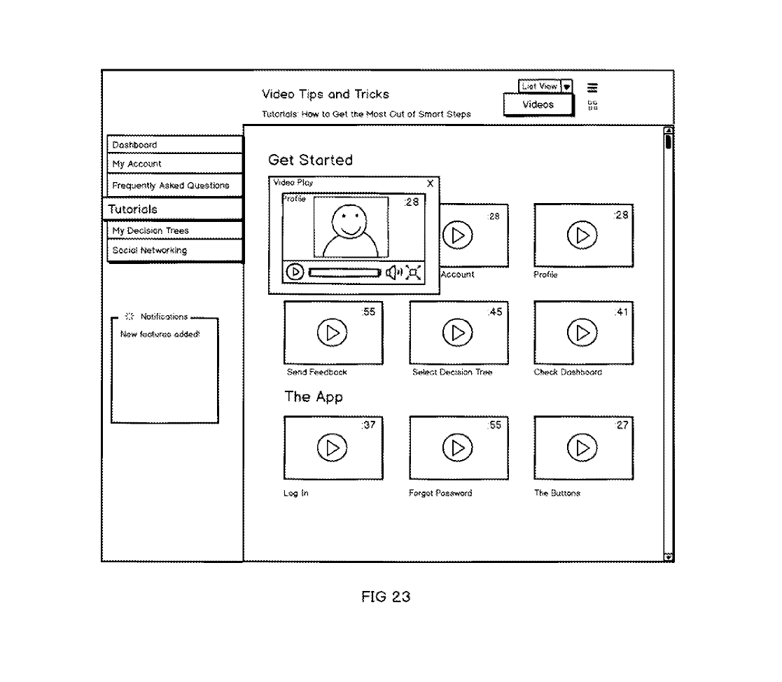

In one embodiment, the system 110 provides support and configuration assistance for various system users 128. FIG. 22 illustrates and exemplary FREQUENTLY ASKED QUESTIONS screen which can be used to provide answers to commonly asked questions or concerns. FIG. 23 provides an example of various tutorials and videos to assist system users 128 get started.

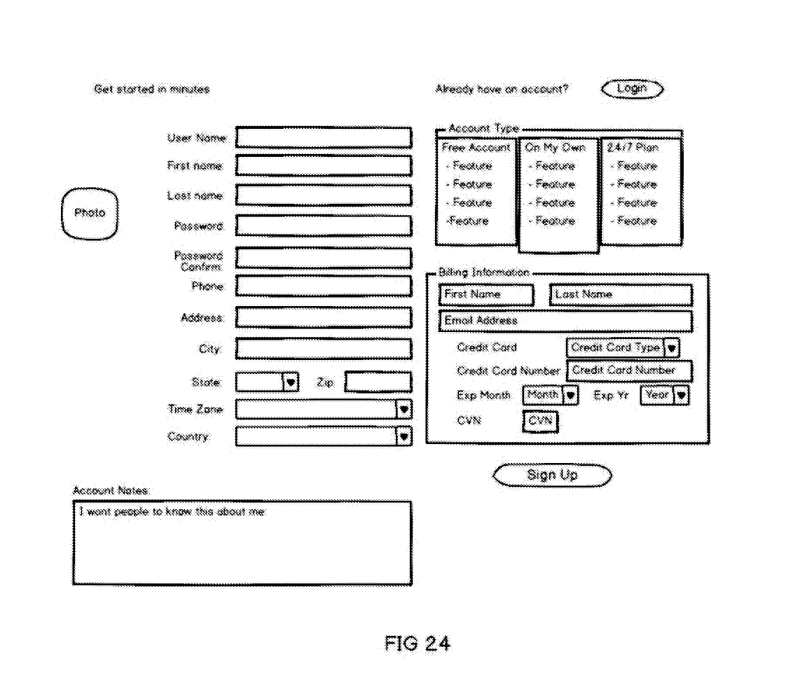

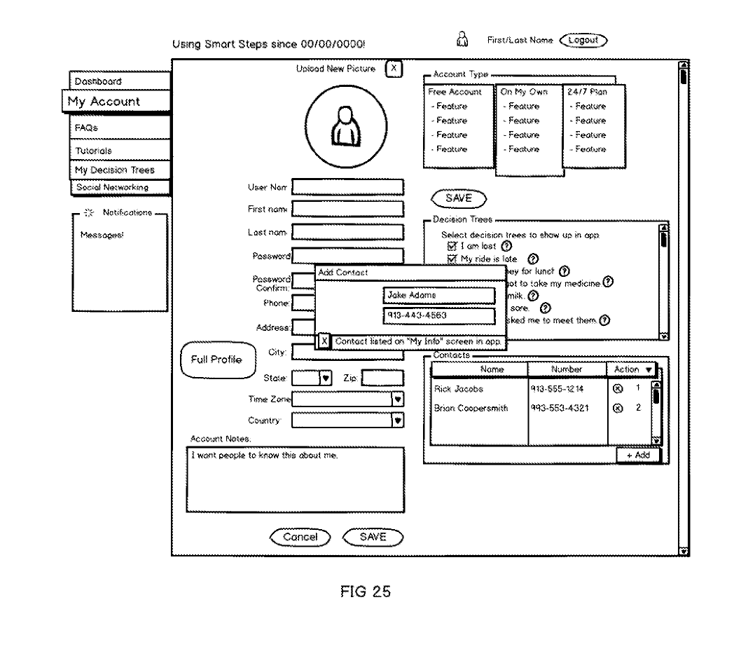

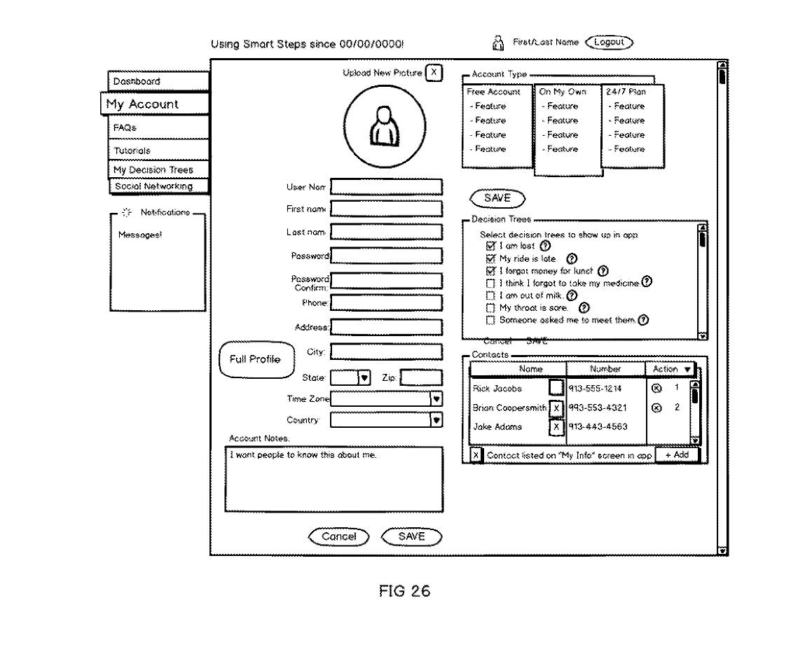

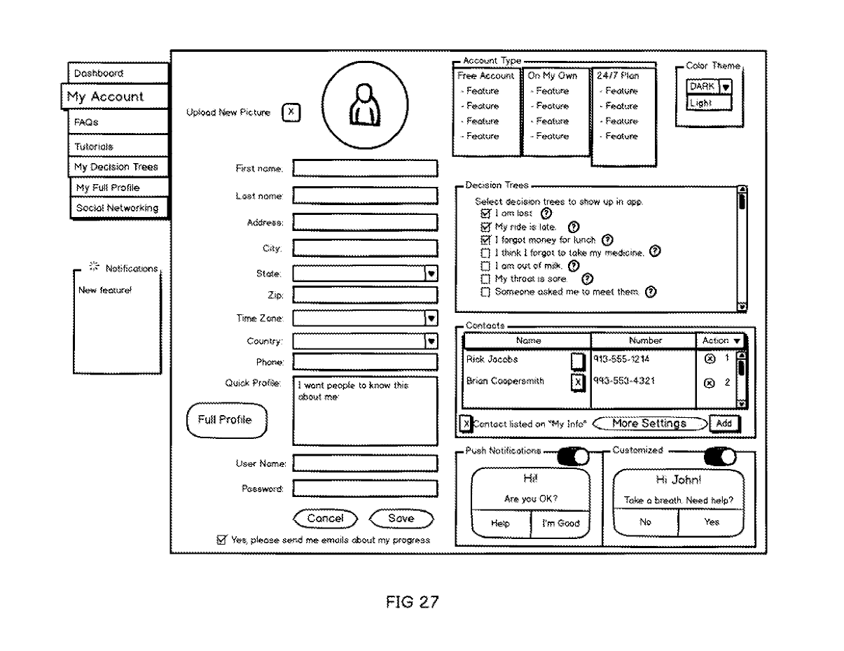

A system user 128 may be configured to have varying access levels. For example the system user 128 may have a free account or they may sign up to receive a premium account which may have additional features not otherwise provided with a basic membership. For example, FIGS. 24-26 are exemplary system user screens in accordance with a premium registration where FIG. 24 is an alternative user information screen like, FIG. 16 which also allows for the collection of user billing information which may be used in connection with a paid subscription. FIG. 25 is an alternative My Account screen which like FIG. 20 allows for various account information but includes the feature of having the option of adding information for contacts which can be stored within a listing of contacts, with the listing of contacts being further illustrated in FIG. 26. FIG. 27 includes additional contact options and allows the user to configure the notification feature which may be configured based upon a receipt of system notification that notifications are present. In addition, FIG. 27 allows for a customized notice to be transmitted by the content server 113 to the cognitive prosthetic support device 114 upon receipt of the system notification by the system 110.

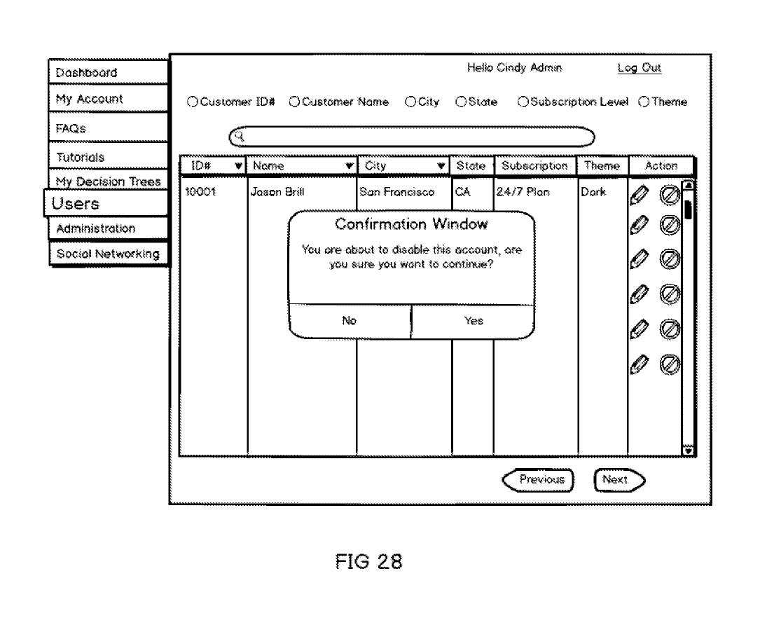

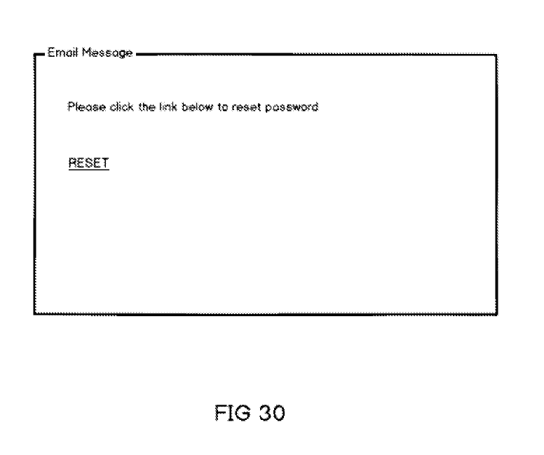

FIG. 27 is an illustrative login screen which may be utilized by plural system users 128 or the administrative user 129a. FIG. 28 is an exemplary administrative dashboard screen where the administrative user 129a is able to view and manipulate access of a plurality of users. FIG. 29 is an exemplary email notification screen where the system can generate an electronic message to a user based upon an email address. FIG. 30 is an exemplary password reset screen with FIG. 31 being an exemplary password confirmation screen.

FIG. 32 is an exemplary admin user 129a dashboard screen. In this screen various system statistics may be provided to the admin user visually or statistically. FIG. 33 is an alternative admin user customer listing summary screen where the admin user 129a can review various customer information, make edits, delete accounts, send emails to the account holder and other actions.

FIG. 34 is an alternative Account Profile screen similar to FIGS. 20 and 27, with FIG. 34 being an example of what the system user Account Profile screen may appear to the admin user 129a. FIG. 35 is an alternative My Account add contact window, similar to FIG. 25, as it may appear to a system user 128a with a paid subscription to include premium features such as custom push notifications.

FIG. 36 is an alternative admin user system user summary listing screen, similar to FIG. 33, but being sorted by Customer ID#, but it could also have been sorted based upon Customer Name, City, State, Subscription Level or Theme.

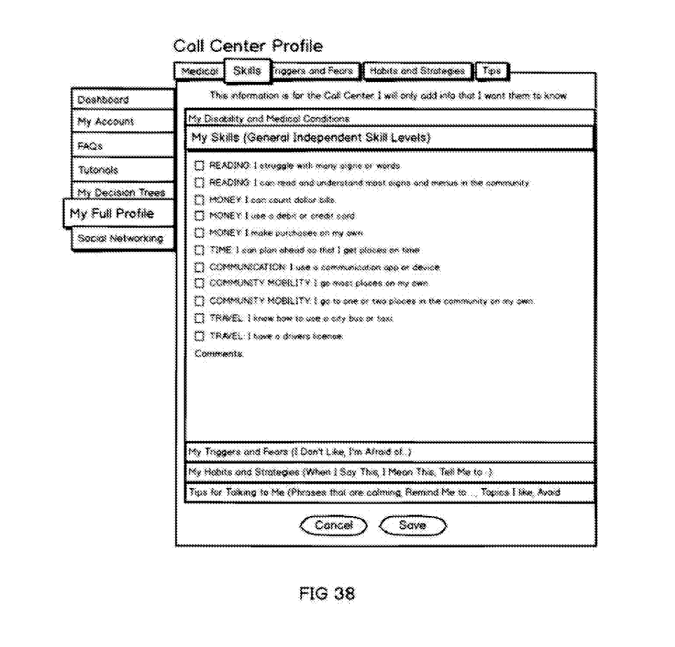

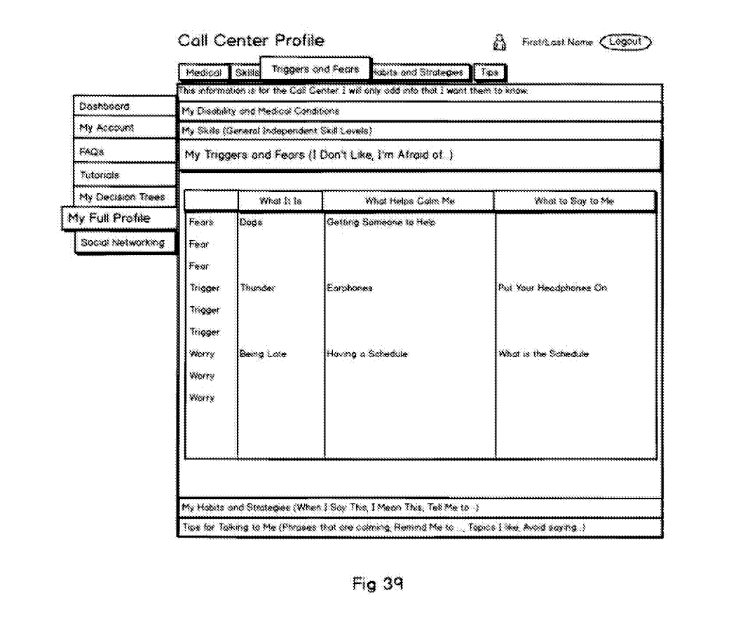

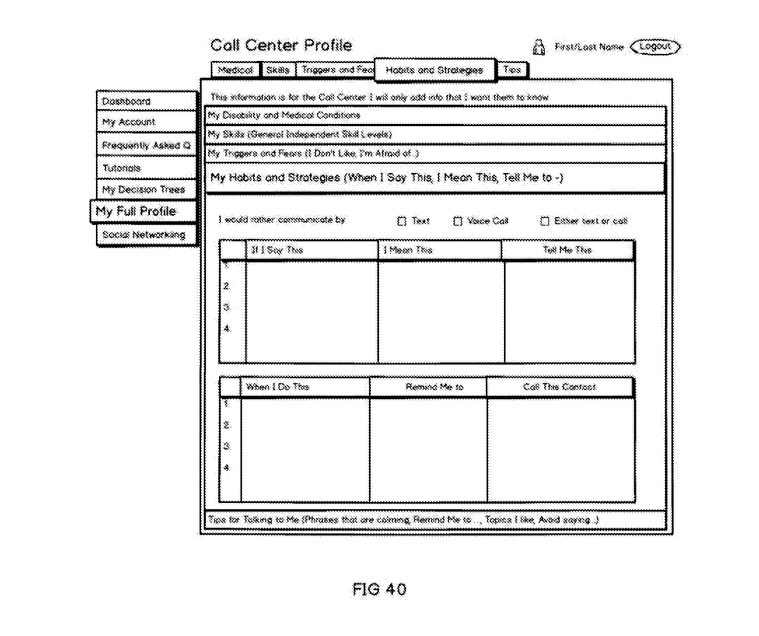

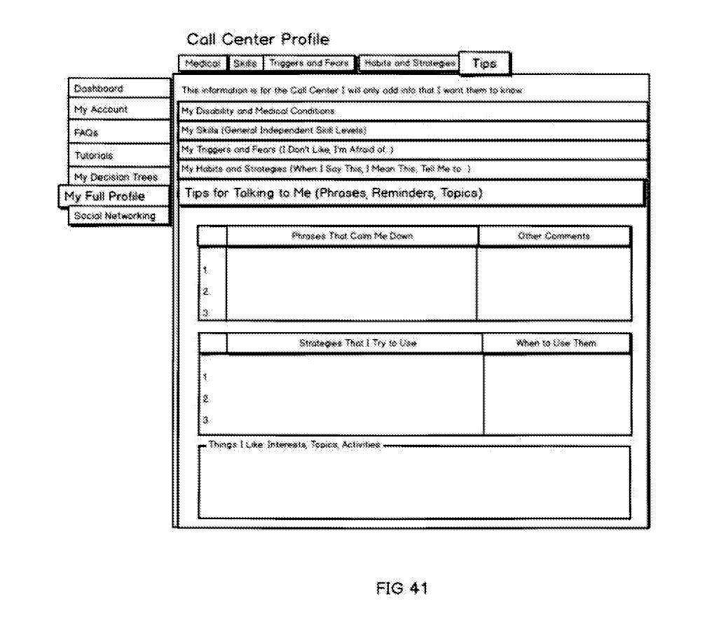

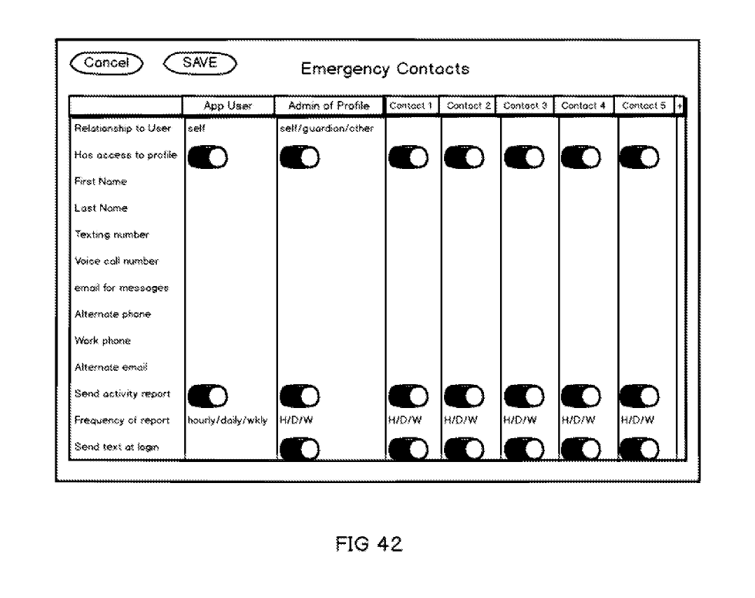

FIG. 37 is a Call Center Profile Screen for receipt of information associated with the Cognitively Disabled User 117 for use by a Remote Operator 130 in association with a Remote Call Center Server 116 in monitoring and guiding the cognitively disabled user 117 during performance of the display aid 121. FIG. 37 provides an exemplary listing of various disability and medical information associated with the cognitively disabled user 117 associated with a specific system user. FIG. 38 provides an exemplary listing of various skill related information associated a particular cognitively disabled user 117 associated with the specific system user. FIG. 39 provides an exemplary listing of call center information related to specific concerns of the particular cognitively disabled user 117 associated with the specific system user. FIG. 40 provides an exemplary listing of various habits and strategies which may be helpful to a remote operator in association with a remote call center server associated to a particular cognitively disabled user 117 associated with the specific system user. FIG. 41 provides an exemplary listing of various skill tips for a remote operator in association with a remote call center server associated to a particular cognitively disabled user 117 associated with the specific system user. FIG. 42 represents an exemplary emergency contact summary screen of a particular cognitively disabled user 117 for the benefit of the remote operator 130. The system user can indicated permissions, access privileges for the user and each contact. They system user can elect to send activity logs to the user and each contact with individual preferences.

The system 110 also provides a variety of visual enhancements to assist the cognitively disabled user in successful completion of the display aid associated with a specific task. FIG. 43 represents a display aid visual elements configuration screen for a system user to enhance the display aids with visual elements for assisting the cognitively disabled user 117 in performing the desired task. Color schemes are important to persons with impaired cognition or other sensory impairments. Other adjustable settings include: geo-location detection, reporting options, voice to text options, push notification edits and timing and editing permissions allowed by the device user. FIG. 44 represents a display aid avatar configuration screen for a system user to enhance the display aids with a custom avatar coach for assisting the cognitively disabled user 117 in performing the desired task. It also allows integration with other technologies such as bio sensors, calendars and reminders.

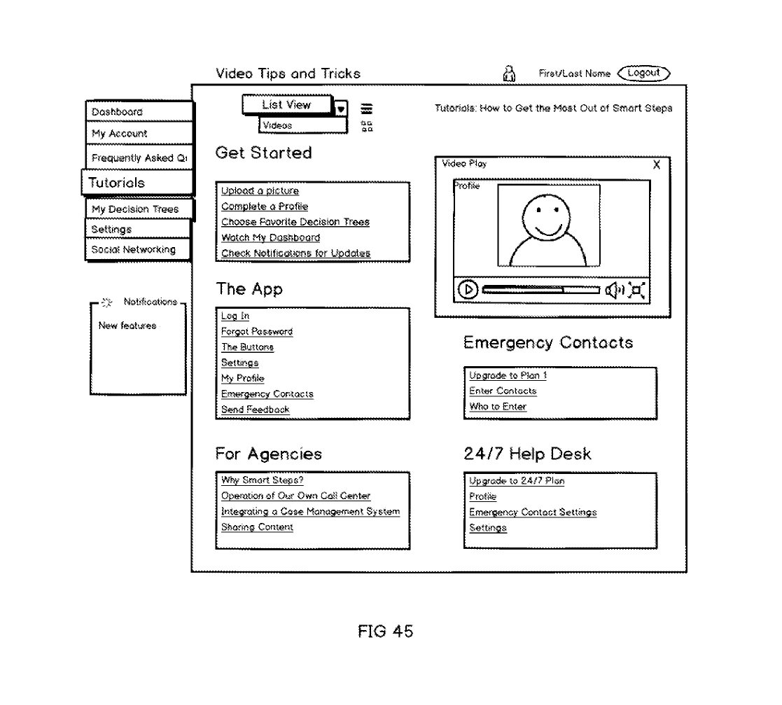

FIG. 45 is a system user 128 tutorial screen which provides a number of resources for selection by the system user 128 to assist in the configuration of the system 110.

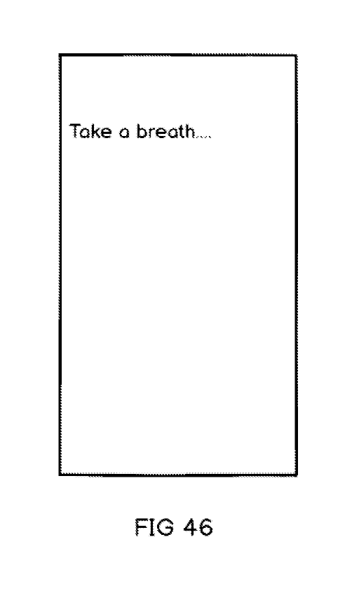

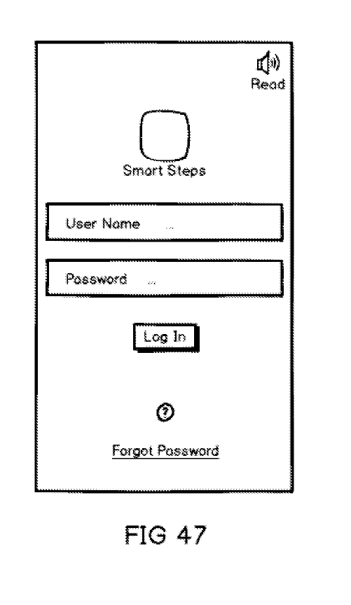

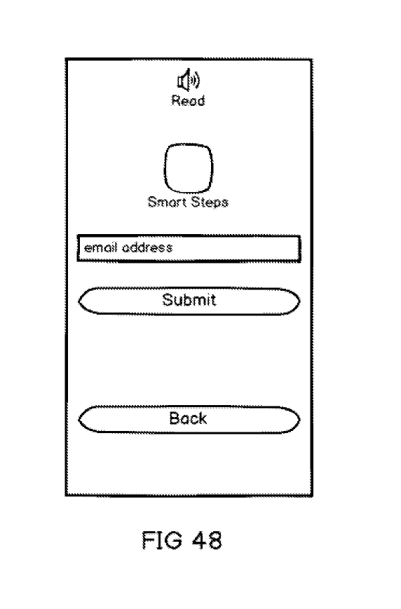

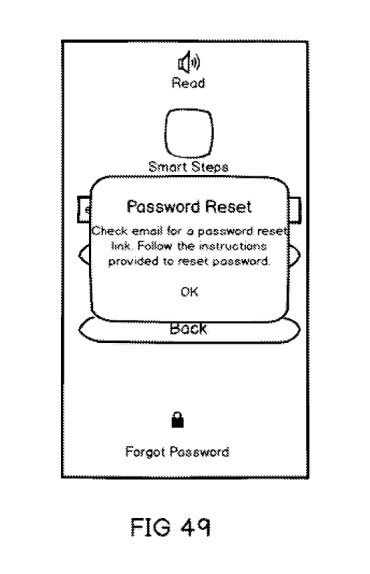

FIGS. 46, 47, 48, 49 and 50 illustrate a series of exemplary registration screens for the cognitive prosthetic support device 114 with FIG. 46 presenting an illustrative opening splash screen. FIG. 47 is a exemplary sign-in screen for the granting the cognitively disabled user 117 authorized access to the system 110. While it is displayed as being textual, the authorization process could involve other verifiable credentials including verbal or biometric means. FIG. 48 is an exemplary password reset screen and FIG. 49 is a password confirmation screen.

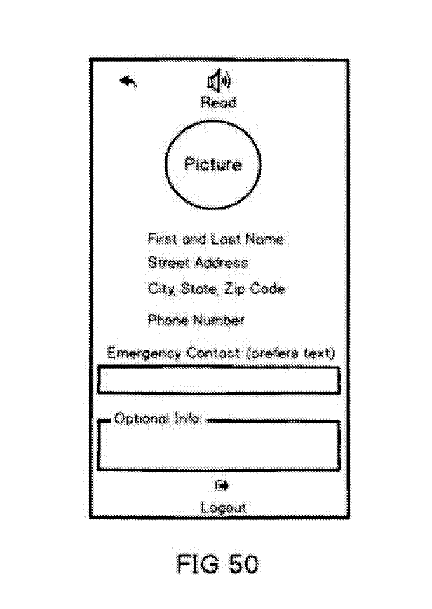

FIG. 50 illustrates an optional profile screen for the cognitively disabled user 117 on the cognitive prosthetic support device 114. The illustrated profile screen may include a photograph, first and last name of the user, contact information and a field for account notes. This same screen may be utilized for setting up additional contacts to be stored in the cognitive prosthetic support device 114 for ready access as desired via text, voice or chat.

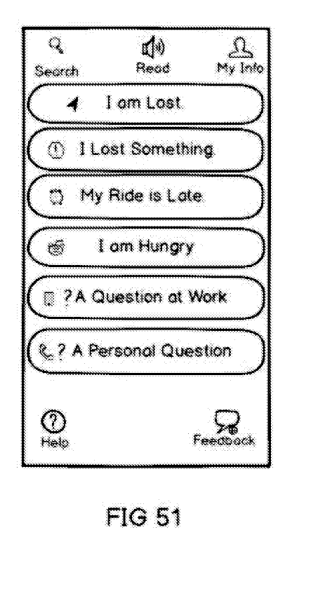

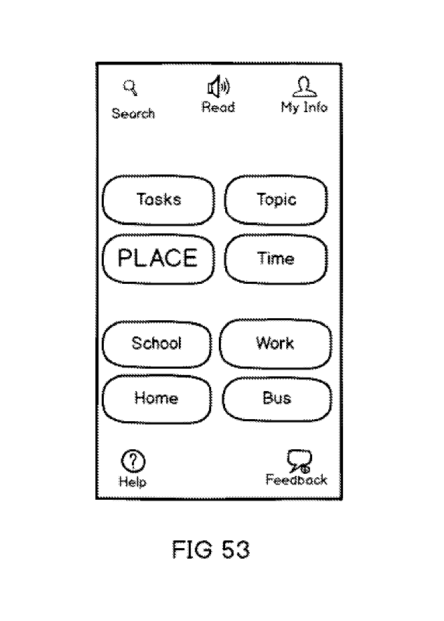

FIGS. 51 and 90 illustrate embodiments of an exemplary display aid 121 home screen. With the illustrated home screen the cognitively disabled user 117 can choose between a number of preconfigured display aids 121, a panic button (not shown) or communicate with a contact. FIG. 52 illustrates a task listing screen which includes a search function which enables the cognitively disabled user 117 to search for a particular display aid 121 via text or voice. FIG. 53 provides a categorical listing of various display aids which can be organized topically or as otherwise desired.

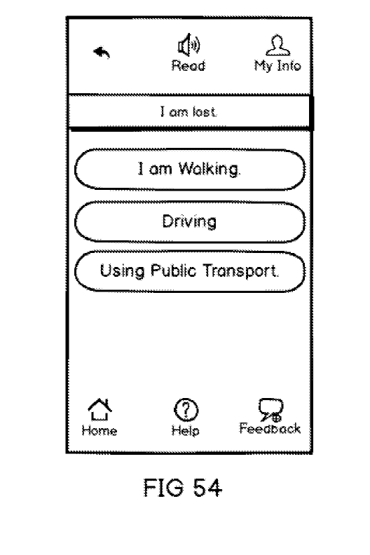

FIG. 54 is represents an embodiment of the present invention with an illustration of the I AM LOST display aid where the user begins to complete a selected task based upon a number of discrete steps and choices which the system 110 has provided based upon the processed decision tree 123. The I AM LOST display screen illustrated in FIG. 38 represents one node corresponding to the progression of a plurality of nodes corresponding to the desired task, where each node progresses to the next node based upon a selection made on the cognitive prosthetic support device 114 by the cognitively disabled user 117. In this way, the cognitive prosthetic support device 114 provides additional nodes through the progression of the selected display aid 121. Each displayed node may utilize visual cues 125. The visual cues 125 may be dynamic and interact with the cognitively disabled user 117 by allowing for receipt of an input from the user. In addition, some of the visual cues 125 may be static such a coloring scheme which may be configured by the system user 128 or the cognitively disabled user 117, as permitted, such as a yellow highlighted text box at the top with two or more user choices displayed vertically below the yellow box within separate blue boxes using readable simple and large fonts. By using simplified graphics and standardized color coding, the illustrated display aids 121 can facilitate improved responses on the cognitive prosthetic support device 114 such as by providing predictability for the cognitive disabled user 117. Additional options may be customized for persons with visual impairments or according to personal preference. Another purpose of color coding would be to color code according to category such as task flows for work, school, home, social, shopping and transportation (317a-317g). The user may also elect to employ an audible prompt of choices in a step-by-step manner to navigate the mobile display screens to assist the user in performing the desired task. Icons or other graphic indicia may also be provided in association with the choices to further assist the user in choosing or performing the desired task. In addition, the mobile display screens may utilize a series of pop-up screens again employing the standardized visual appearance.

By way of example, each user screen may be provided with a panic button or allow for a verbal command to open a support screen 376 and allow the user to select 377 to communicate with a preconfigured contact from a list of contacts or a remote contact in communication with the remote server and chose the preferred method of response 378 from the selected contact such as text, verbal or otherwise. The user may select the profile screen such as the one illustrated in FIG. 50 as needed during times of stress to show to a nearby person for purposes of providing information nonverbally and as a cognitive aid. The profile screen may also include a link to one or more emergency contacts. Additionally, the cognitively disabled user 117 may select to contact 379 the remote operator 130 associated with the remote server 130 who is configured as a backup support user telephonically, through an internet connection or textually using the phone or internet protocols.

As shown in FIGS. 37-45, additional examples of the system 110 for use by an admin-user 128 may include tabbed display screen Emergency Contacts 358, 488, 560 which allow the user to enter various emergency contacts which should be transmitted and displayed on the cognitive prosthetic support device 114 and available to the remote server 130 and/or remote operator 130. An example of an Emergency Contacts display screen is illustrated in FIG. 42 which will be accessed through the Settings tab. Another tabbed display screen Call Center Profile 562, may be utilized by the admin-user to configure the settings for interaction between the device 14 and the remote server 130 and which are available for display to a remote operator 130. Examples of the Call Center Profile displays are illustrated in FIG. 37-41. An example of a Tutorial page is illustrated in 45.

Examples of My Account tab 478 are illustrated in FIGS. 20, 24 and 27. From the my account tab 478 the system user 128 can add contacts 488, adjust basic settings 490, manage user name and password 484a, edit account information 487, select available task flows 488a sign up to receive email notifications 491, sign up for push notifications, create custom push notifications choose a color theme and enter profile info. Using the adjust settings 490 feature, the admin user 128 can utilize the web portal 118 to customize 486 the system 110 default configuration for the display aid 121 such as colors, fonts, sounds, limit editing by the cognitive prosthetic support device 114. In addition, the admin user 129a may select desired task flows 488a associated with desired tasks for generating display aids 121 to be displayed on the device 114. In addition, the admin-user may enter, edit or delete information 487 for each cognitively disabled user 117 associated with the admin user account, which may be one or more. Alternatively, this information may be provided by the cognitively disabled user 117 on the cognitive prosthetic support device 114 as previously indicated. If the information is provided by the admin user 129a on the web portal 118, a link or invitation/code may be transmitted to the cognitive prosthetic support device 114 for automated activation of the device 114 for association of the admin user created account with the cognitively disabled user 117 by the system 110 using standard device activation and linking protocols. In addition, the admin user 129a can use the web portal 118 to manage the user name and password 484a, enter financial information 497 to be associated with the admin user account in order to upgrade plan and sign-up to receive email alerts 491.

By selecting the dashboard tab 480, an example being illustrated in FIG. 21, in the exemplary system 110, the admin user 128 may view usage statistics. Statistics may include the task flows accessed along with date and location; number of task flows completed successfully and unsuccessfully.

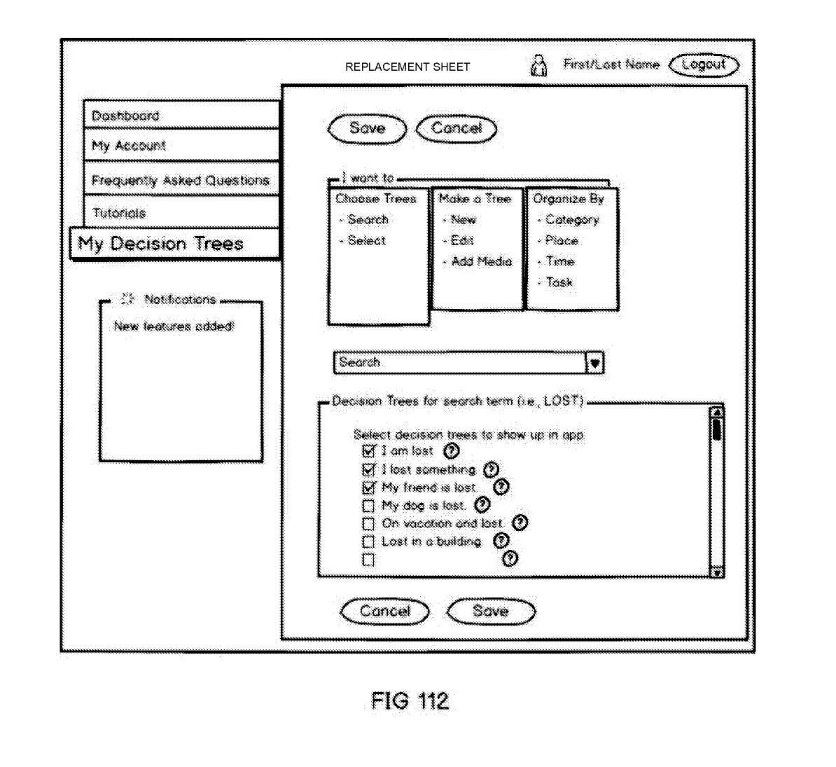

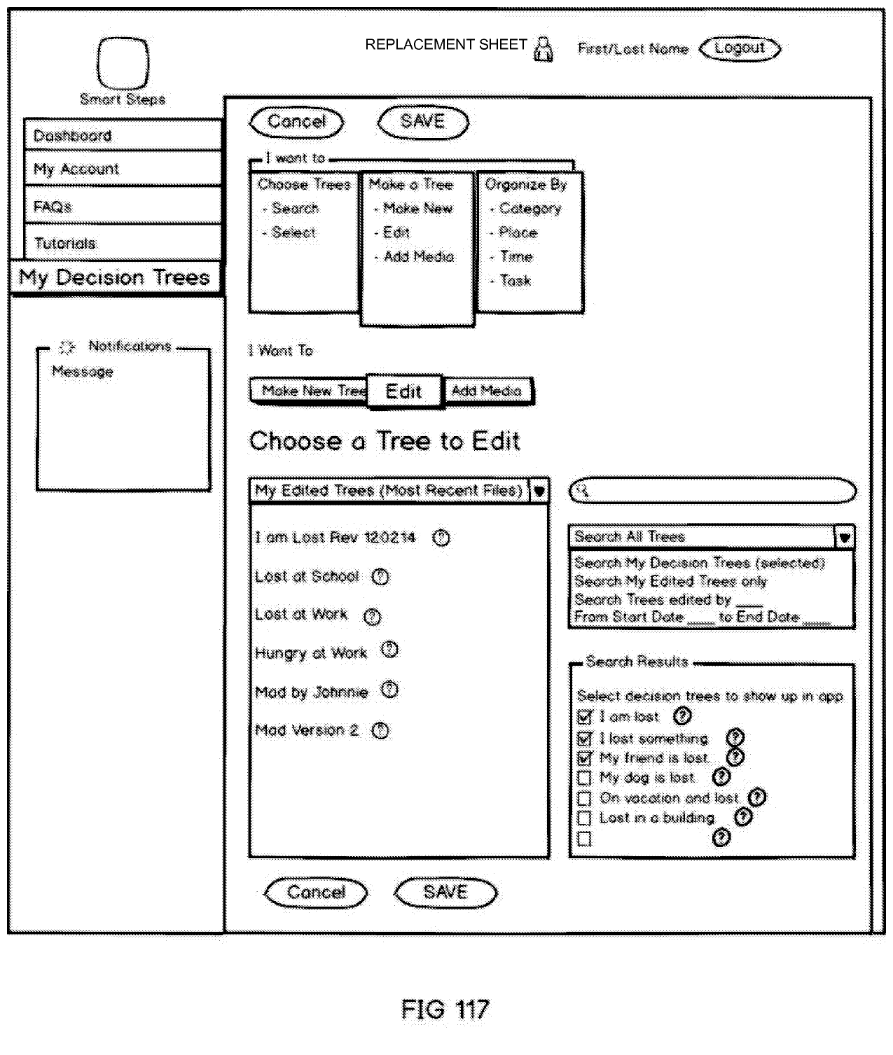

By selecting the decision tree tab 330, examples being illustrated in FIGS. 112-122, the admin user 129a or the remote operator 130 may add, remove, create, and/or customize task flows 492 (also referred to as decision trees) submit, share and receive shared customized task flows 494 and customize, share and receive customized system notifications 496 or switch to a new tab like, FAQs 482, tutorials 484 or select other settings 486. An example FAQ's tab is illustrated in FIG. 22. An example tutorial screen is illustrated in FIG. 23 and FIG. 45 with audio-visual clips being presented for viewing different tutorials on the system 110 and references to other content to provide assistance in configuring and using the system 110. Other settings 486 may include financial information 497 for system required payments like credit card or bank account information. In addition, enablement or disabling in-app purchasing 498 by the cognitively disabled user 117 on the device 114. Additionally, the system 110 may provide configuration parameters for integration with available or later developed biological sensors 499, like temperature, blood pressure, pulse, heart rate etc. In addition, the system 110 may allow for the purchase, roll-over, lending or borrowing of additional minutes, time or costs 500.

Once successfully signed-in, the system 110 may present the cognitively disabled user home screen 546, also referred to as home screen 546, providing a list of configured tasks which correspond to display aids 121 configured for presentation on the cognitive prosthetic support device 114. The display aids 121 are based upon a step-by-step task flow which is stored within the system 110 through the web portal 118 or previously stored within the content server 113 or database server 115.

In addition, from the home screen, the cognitively disabled user 117 may select device settings screen 548, initiate a remote back-up call 550 or select a particular task for its corresponding display aid screens 552. If the particular task is selected, then additional display aids screens 558 will be displayed as determined by the task flow. At any time within the display aids 121, the user will have the option to communicate with a contact such as text message, email, phone call or otherwise or initiate a remote back-up call 550, return to the home screen, or return to the previous screen. The user will have the option to select a profile button illustrated in FIG. 50. In the example illustration 50, the icon “My Info” represents the profile which will display information about the user such as name, address, a photo, emergency contacts, and information about the user with cognitive disabilities. The user can text, email or call a contact from this screen. This screen will be useful to show to a nearby person in times of stress when the user is unable to communicate effectively. Options for contacting the emergency contact are preselected in the Emergency Contacts tab as shown in FIG. 42.

Depending on the use account configuration, the system may allow the cognitively disabled user 117 to select the settings screen 548 to review and/or modify various device settings such as color scheme 554. Additionally, the user 117 may manage contacts 556 such as review, modify, add, delete or communicate with a contact from a listing of contacts which may be configured using the web portal or using the device 114.

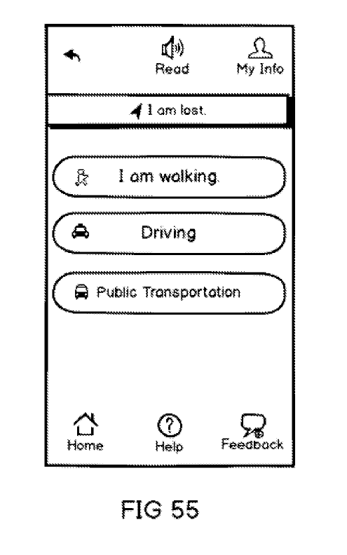

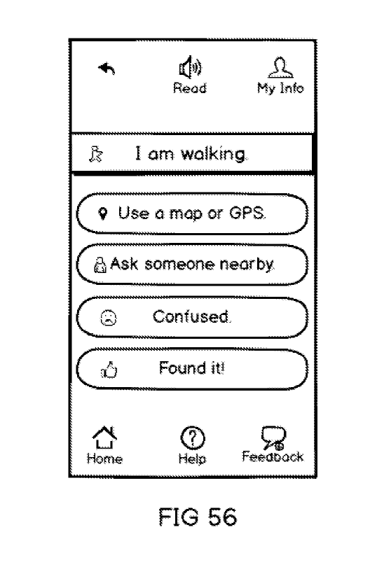

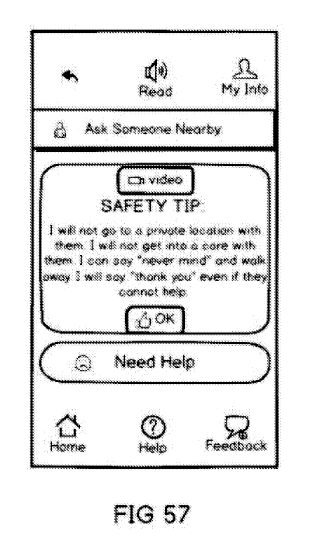

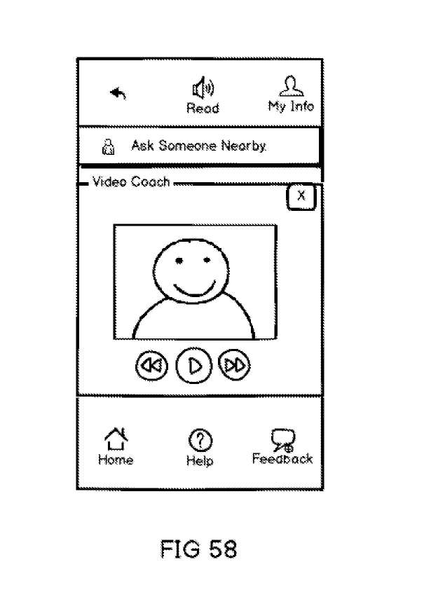

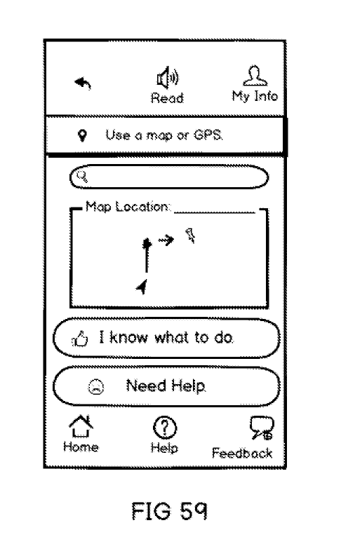

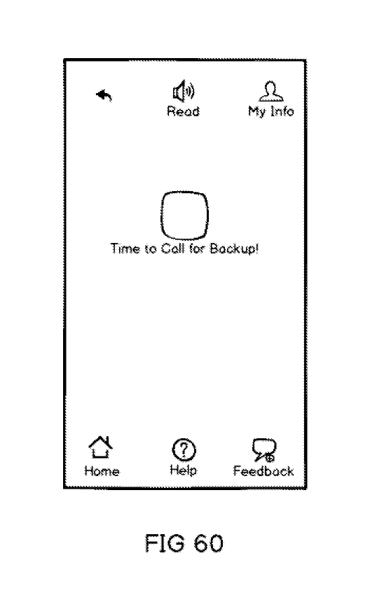

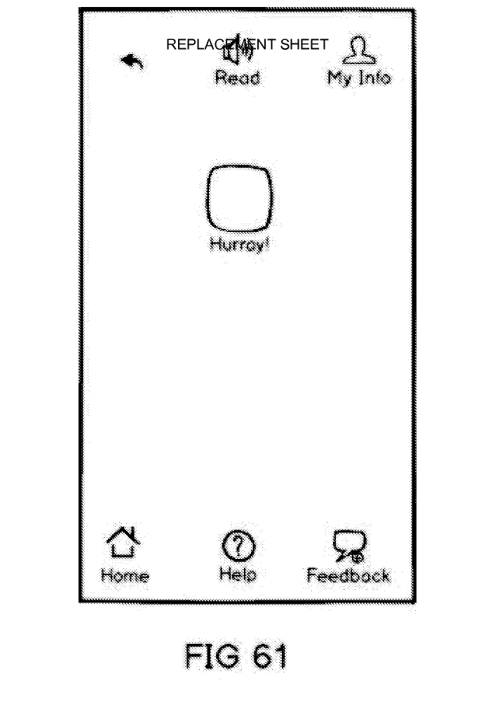

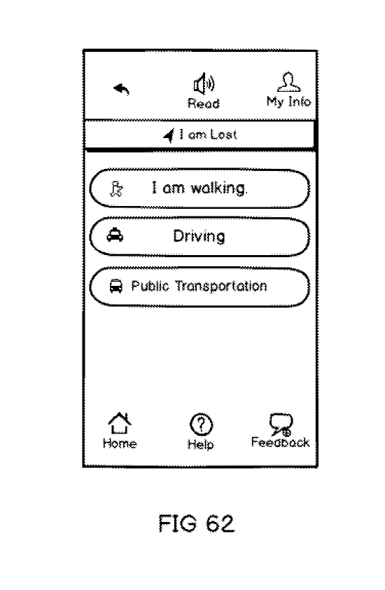

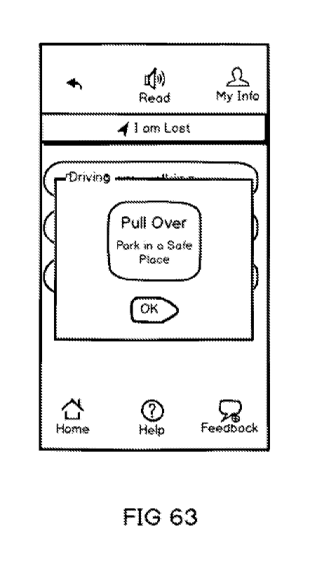

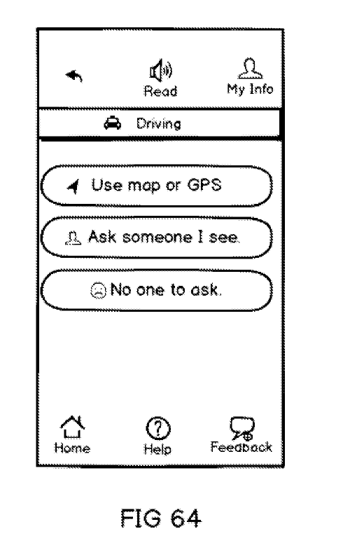

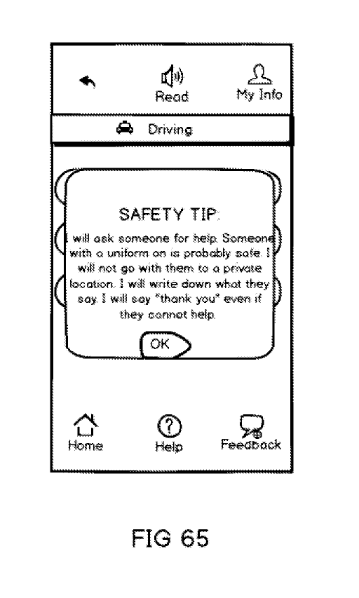

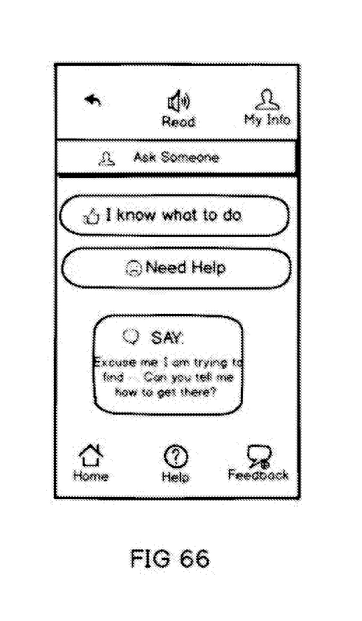

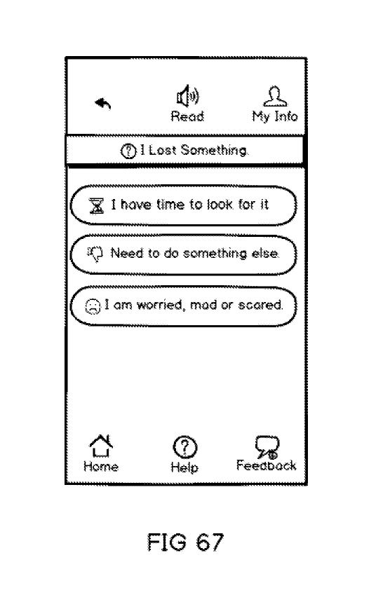

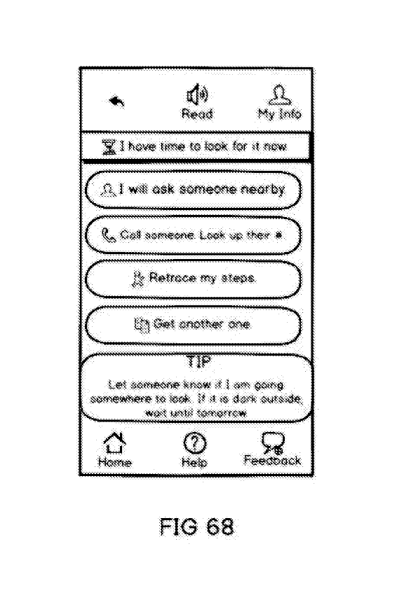

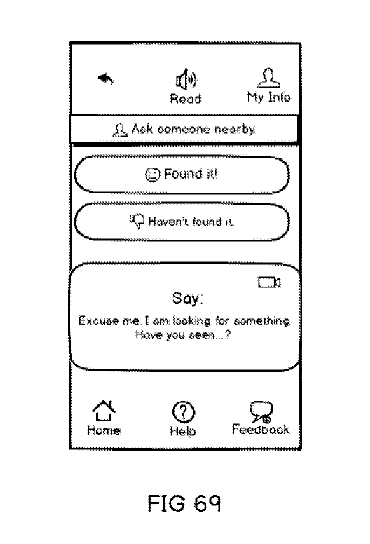

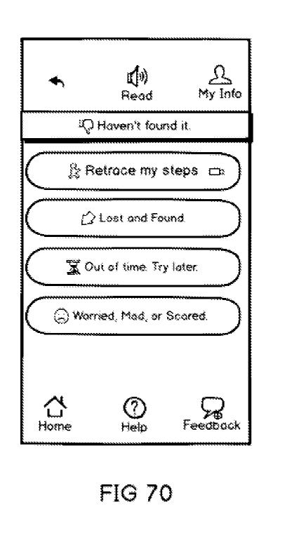

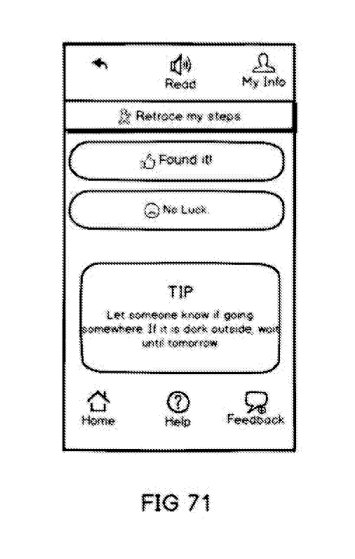

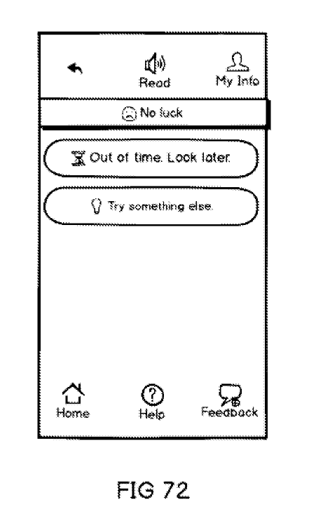

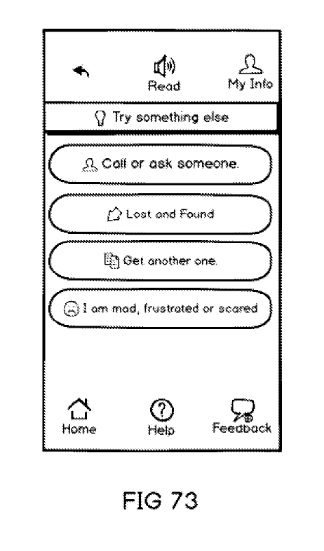

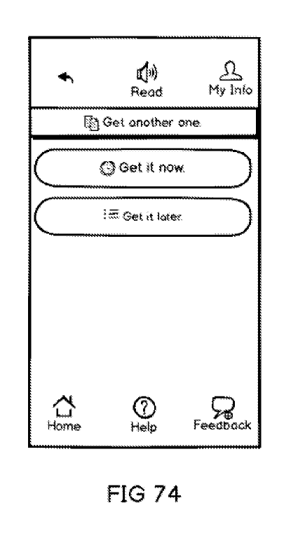

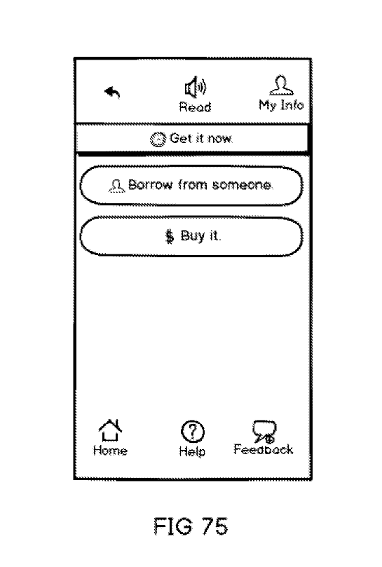

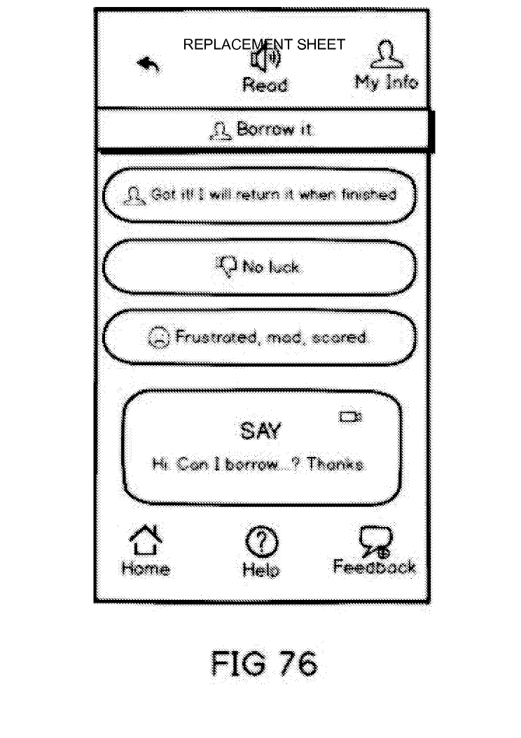

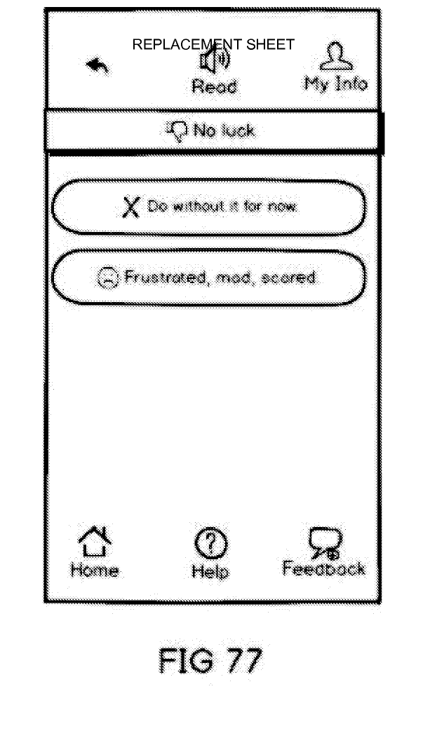

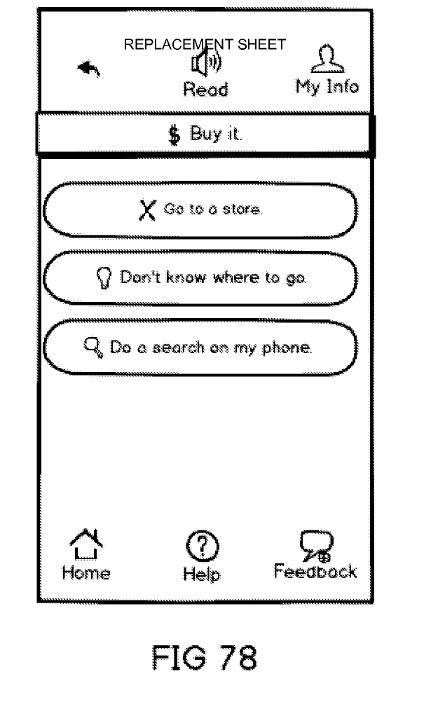

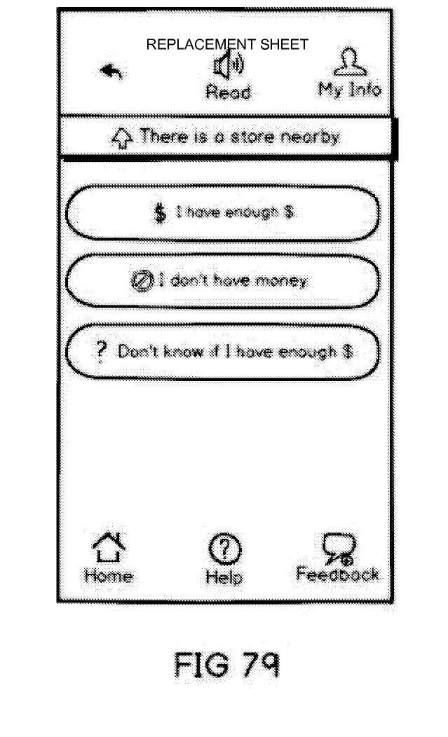

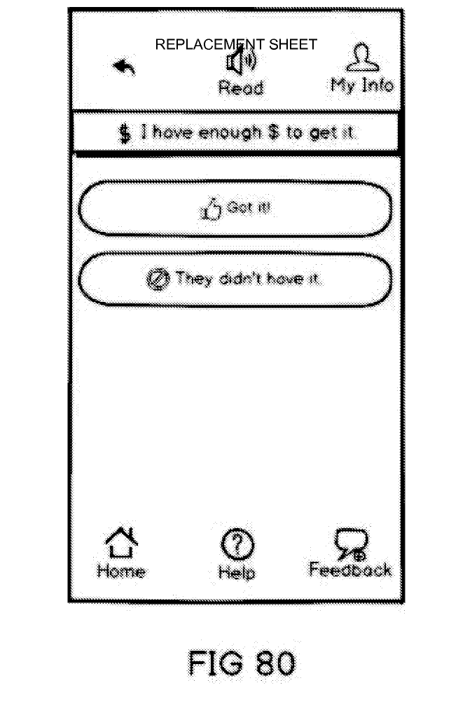

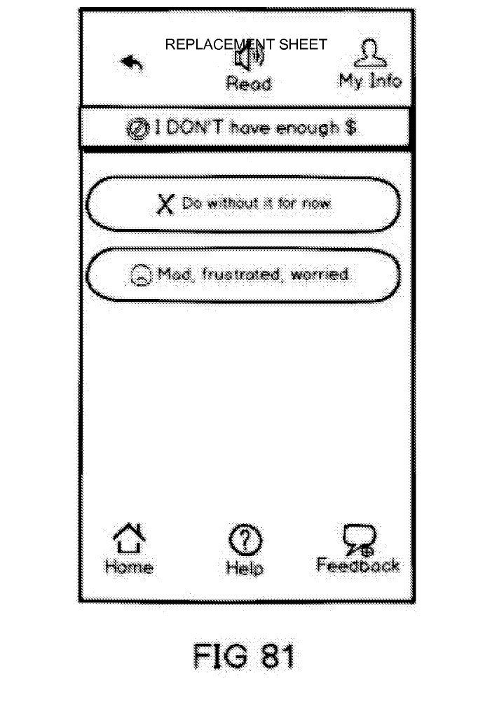

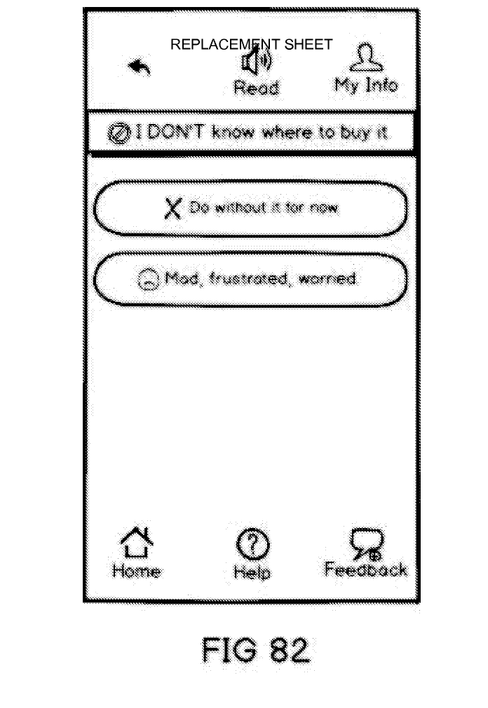

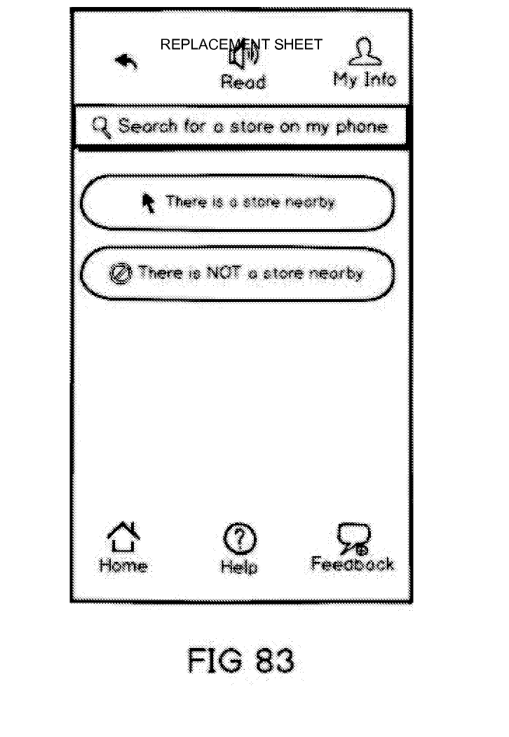

By way of example only and not as a limitation, FIGS. 55-66, 67-83, 84, 85, 86, 87, 88, 89-99, 100, 101, 102-104, 105, 106, 107, 108, 109, 110, 111 are additional nodes associated with the various display aids 121 including the I AM LOST and the I LOST SOMETHING display aids 121 for display on the cognitive prosthetic support device 114 or an alternative cognitive prosthetic support device 114a. However, the illustrated nodes are simply a representative and may be modified in a variety of ways as desired by system users 128 or for a different type of cognitive prosthetic support device 114, 114a which may include different size or types of portable devices.

FIG. 90 illustrates My Dashboard with information also found on the web portal dashboard. The user may view usage data, such as the percentage of times the user reaches the success (Hurray) screen, the frequency of logins over time, task flows accessed along with the location, date, and other useful information. The Feedback button allows the User to voice their response to the technology immediately, alleviating a sense of urgency they may have and providing feedback that would improve the User experience.

FIG. 91 illustrates the Color options that allows the User to customize the appearance of the app. Often persons with disabilities have preferences or sensory needs for certain colors or color combinations. A person who is blind or visually impaired can select a high contrast theme or create a personal theme. Persons with autism often have a strong color preference, so color would be a motivational tool. Colors can be assigned to task flow categories or specific task flows, such as frequently used or those that carry particular importance. For one person, a variety of colors would be over stimulating and confusing, but for another person, having all buttons the same color could be overwhelming to the eye. This allows the personalization that each User requires.

FIG. 92 illustrates the Buddy tab which allows the User to create a custom sidekick, mascot, or hero character. Persons with disabilities often do not have close friends so this option provides a virtual friend to encourage and coach the User. They may choose the type of character and give the character a name, viewing and listening to their choices to the side of the menu. Then the User can decide when and if the Buddy appears on the screen. The messages from the Buddy are programmed on the Settings (FIGS. 43-44) screen on the website and also can be customized by the Remote operator 130 in real time.

FIG. 93 illustrates some of the Settings which are also available on the website version of Settings (FIGS. 43-44). The User can choose a voice for the Read Aloud button. The custom voice can link to a source for custom voices. The User can choose task flows that are useful. The User has control over visibility through the Activity Monitoring options. Activity in the app, activity when away from home, location detection, and near point features may be turned on or off, giving the User more control over visibility. The links go to an additional page for further settings. The User can decide how activity is reported, how often, and to whom it is reported. Communications can be sent to Emergency Contacts or other names associated with the User's account. A Caregiver or other person may assist the User in setting up their account or may set it up through the web portal.

FIG. 94 is a tablet view of the home screen. It includes graphic images to supplement the text, making it easier for those who prefer visual input. The tabs on the left are described in the following paragraphs. In general they are meant to provide an overall organizer to assist the User in managing his or her day. Persons with cognitive disabilities struggle with executive functioning; these tabs are meant to provide easy access so the User can stay in the current application to get the help needed.

FIG. 95 illustrates My Day, a place to view the daily schedule and timed reminders. The User can add reminders on the go by speaking or by text on this screen. Caregivers can also add these through the web portal.

FIG. 96 illustrates the Strategies tab. Many persons with cognitive issues have personalized strategies or routines which have not been memorized. This is an easy way to access these tools. The User may also create a quick strategy or list of steps, such as walking directions from a college dorm to a building on campus. They may load a video or a link to a video. The Caregiver may add these remotely through the web portal. The Remote Operator 130 may push strategies to the device which may be viewed in real time or stored here.

FIG. 97 illustrates Where Am I, or the current location of the mobile device. The number one concern of families is that their loved one might get lost. This provides quick access to navigational information for the User.

FIG. 98 is the Feedback screen which allows the User to communicate to the admin user regarding their app experience.

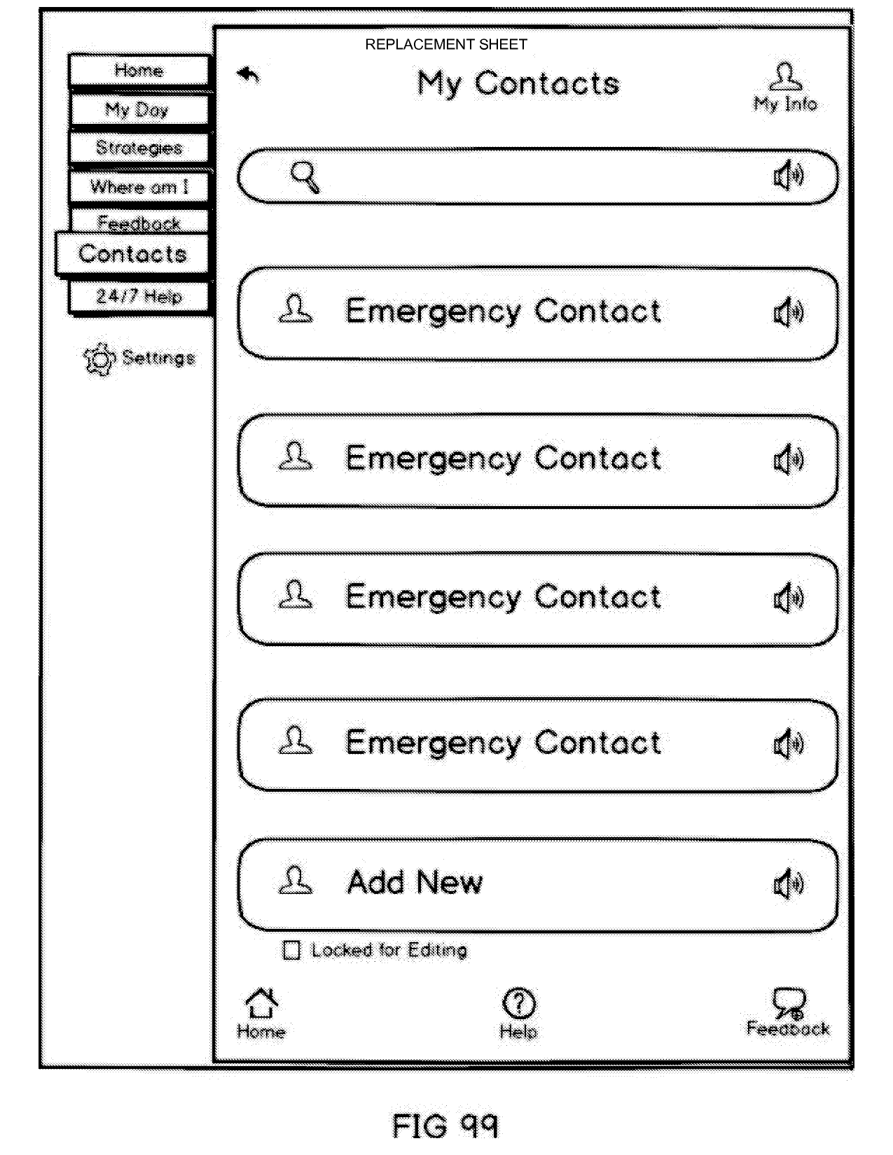

FIG. 99 is the Contact page where the User may view, add, or call Emergency Contacts. A picture of the Emergency Contact is viewable. The User can search for a name. The Agency Admin or Caregiver with guardian status may lock this screen for editing because of safety, to prevent accidental deletion, to prevent addition of unscreened contacts, or for other reasons.

FIG. 100 illustrates the 24/7 Help screen, viewable if the person has subscribed to this subscription level. The User has several options for contacting the Remote operator 130 depending on personal preference and ability level: text, chat, video, or a 3D image of the Remote operator 130 or Buddy. The 3D image allows the Remote operator 130 to model a particular strategy or social skill or provide extra reassurance if the User is agitated. The Remote operator 130, in real time, can push a helpful video or picture to this screen.

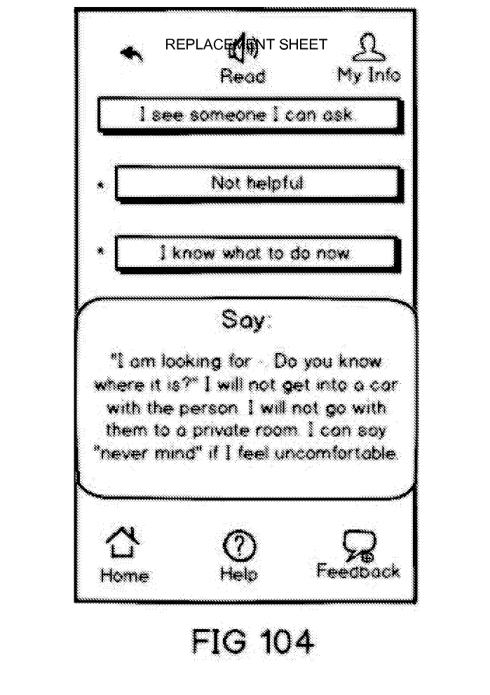

FIG. 101 is a Remote Operator view. The Remote operator 130 can view current activity of an individual User, communicate with the User, view prompts for conducting a help session, create and push a message through the Buddy character, search for and push a video to the User's mobile device, and assist the User in communicating with Emergency Contacts or the local emergency response services via a conference call. This allows communication and support via a variety of methods and provides the most efficient support possible. On a mobile device, these prompts may be viewed as shown in FIG. 104, 105, 106.

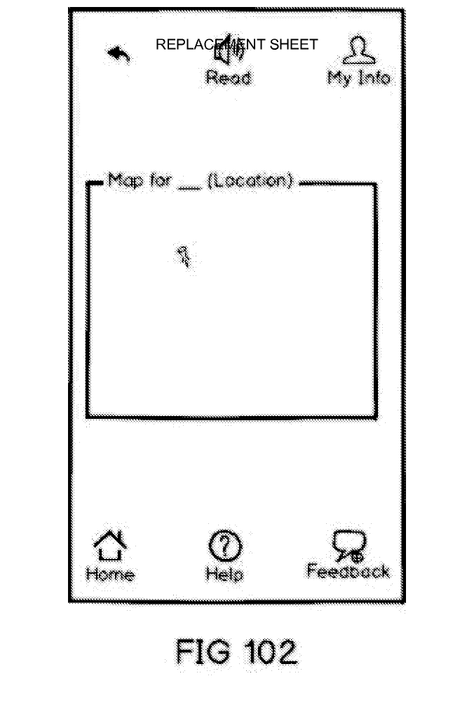

FIG. 102-111 are illustrative nodes which collectively are referred to herein as a display aid. Each node includes a plurality of visual cues 125 which provide for interactive display. FIG. [90] 102 is a link to a map. The cognitively disabled user 117 (also referred to simply as the user) can either use the illustrative map node displayed in FIG. 102 to find their destination using typical routing techniques or speak with the Remote Operator 130 while looking at the node.

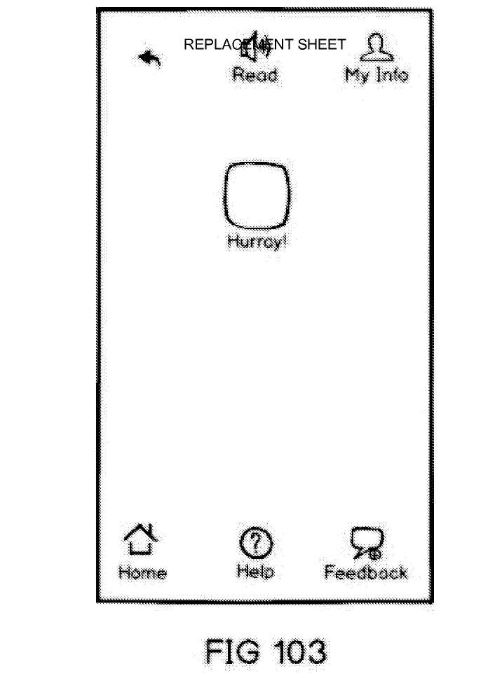

FIG. 103 is a Hurray screen or task celebration screen which is displayed upon successful completion of the desired task associated with the display aid 123. This will be counted in the database as a completed task.

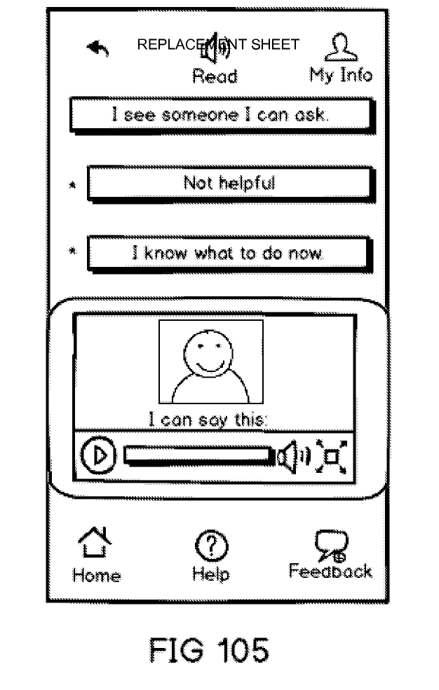

FIGS. 104 and 105 illustrate a sample safety tip for the cognitively disabled user 114. Other messages may be practical tips or social skills. It may be on the screen or it may be a popup screen. Videos or pictures may be included as shown in FIG. 105 to supplement the information for more in-depth explanations or modeling. The video can be a link or the Remote operator 130 may push it to the device during a call.

FIG. 106 is a sample push notification. This may be pre-programmed in Settings to be pushed according to predetermined rules and messages, or the Remote Operator 130 can push it to the mobile device in real time.

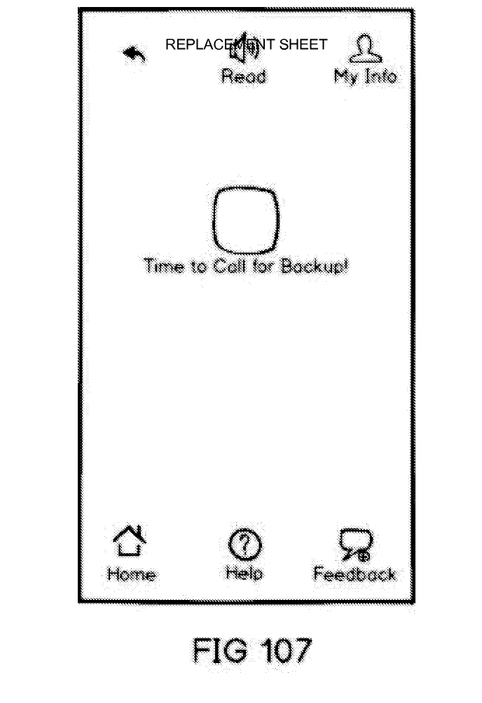

FIG. 107 is a prompt to call for help. This step assists the cognitively disabled user 117 to call for help. For those who ask for help before trying to make a decision or solve a problem, the system 110 provides encouragement and cognitive support to do so; the help screen node indicates to the cognitively disabled user 117 that it is time to ask a contact or the remote operator 130 for assistance.

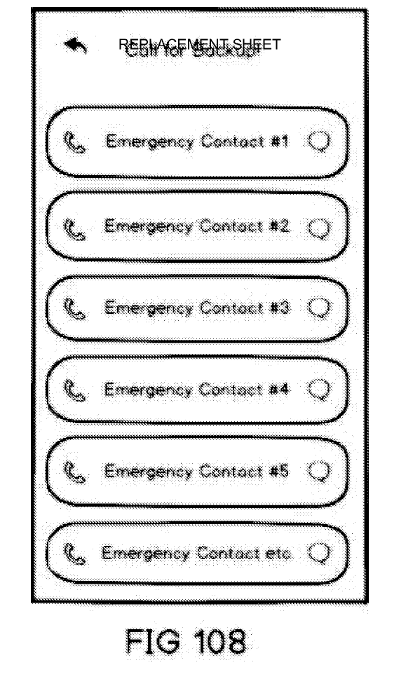

FIG. 108 is a screen with Emergency Contacts. Emergency Contacts can be ordered (FIG. 42). The cognitively disabled user 117 can choose which Emergency Contact to call. The calls can be routed so that if one Emergency Contact does not answer, the system automatically starts dialing the remaining contacts in the order listed.

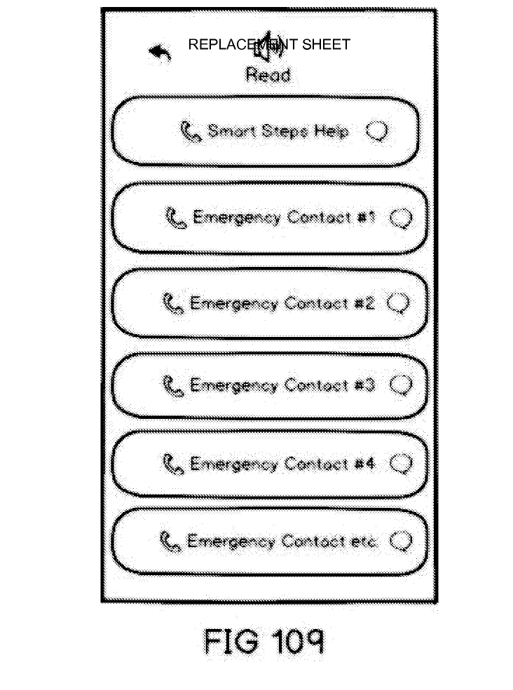

FIG. 109 has an additional button for the 24/7 Remote Operator 130 support. Alternatively, the cognitively disabled user 117 still has the option to call or text an Emergency Contact.

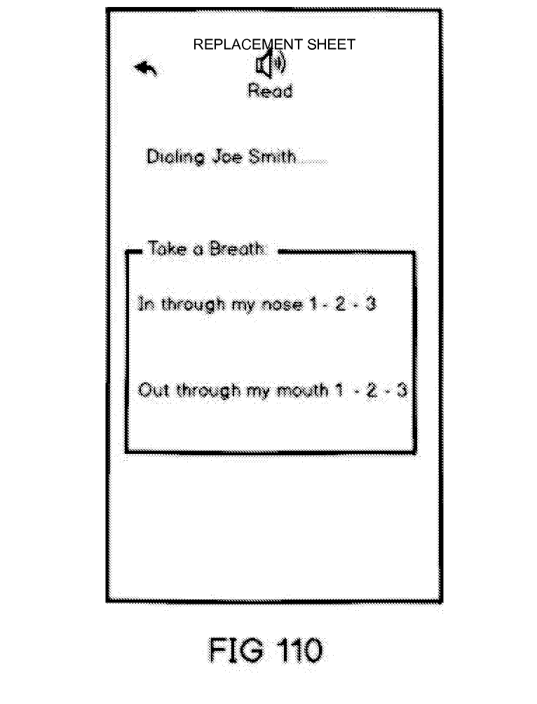

FIG. 110 illustrates a calming strategy to assist the cognitively disabled user 117 while waiting for a response. FIG. 111 illustrates a sample survey so that the cognitively disabled user 117 can provide feedback directly to the company.

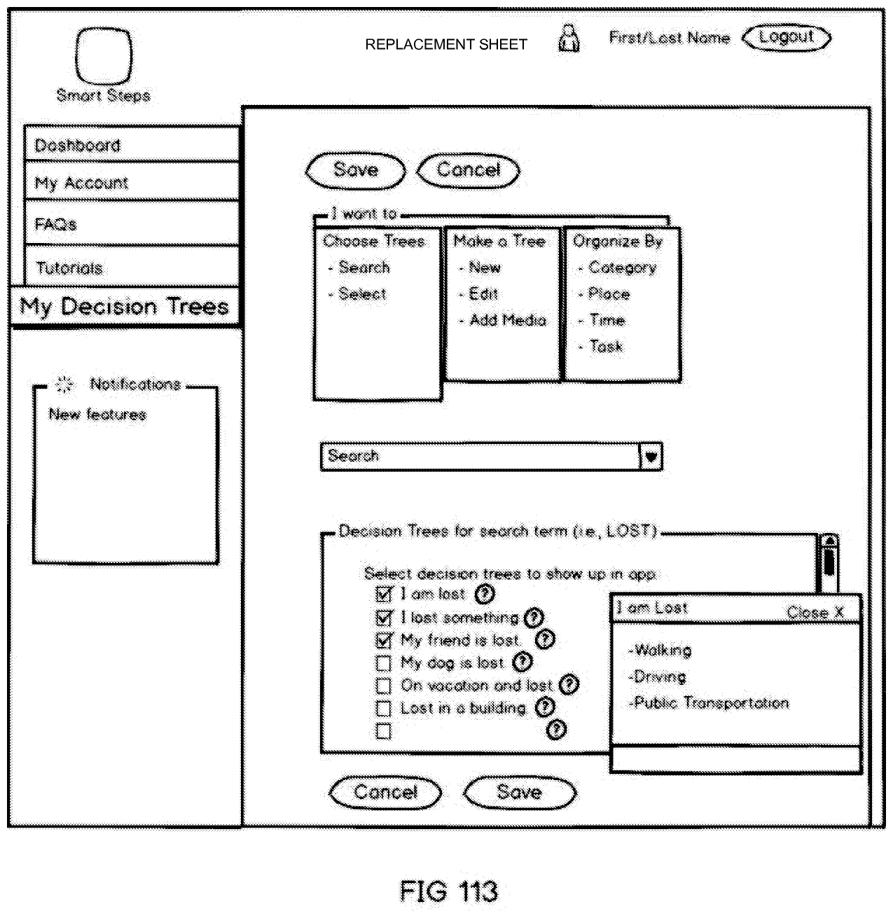

FIG. 112 illustrates a screen whereby the cognitively disabled user 117 can log in to his or her account and choose which of the provided task flows are to be visible on the home screen of the app. This enables simplification of the home screen by eliminating task flows that will not be useful to the cognitively disabled user 114. The cognitively disabled user 117 may also search for task flows. When tapping on the question mark icon following each task flow, the cognitively disabled user 117 can review the brief overviews to see if it is a task flow that fits their needs. FIG. 113 illustrates the type of information that might be included.

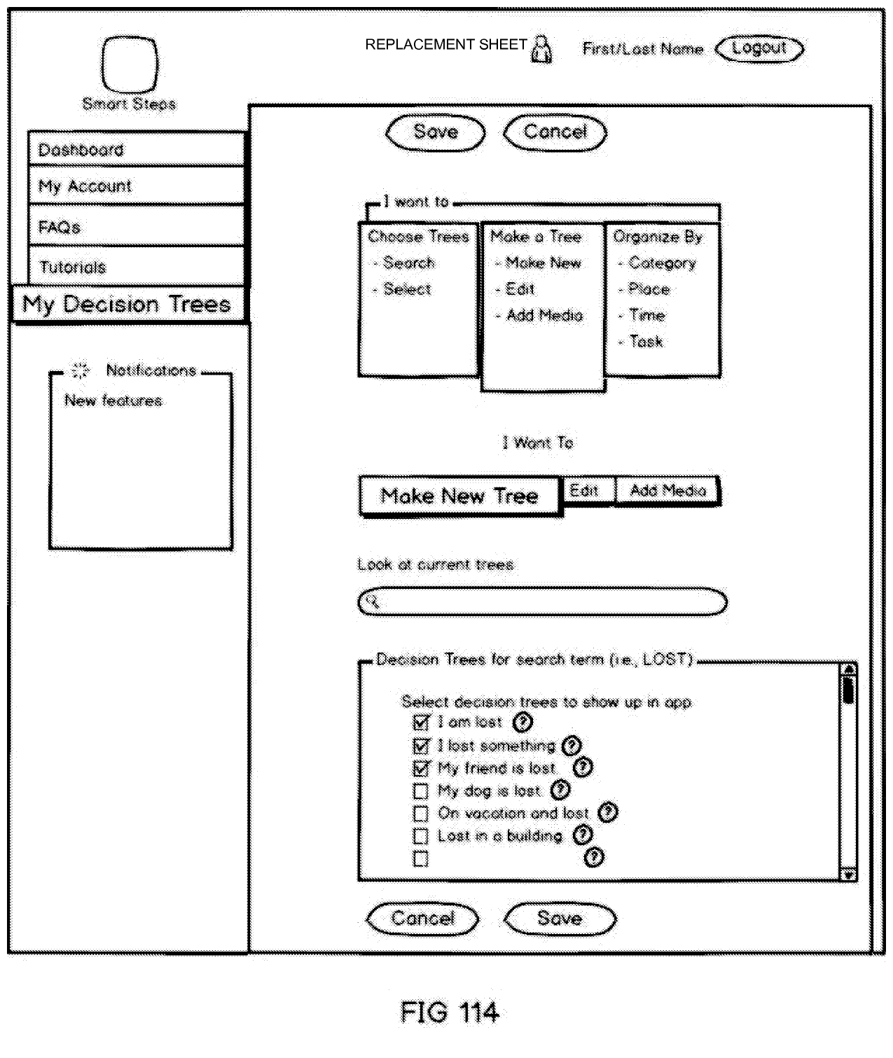

FIG. 114 illustrates some representative task flows (also referred to herein as decision trees 123) which may be searched for, created and edited. FIG. 114 illustrates an example screen indicating options. The work flow is structured for the cognitively disabled user 114. In this case, the user sees a search bar to look for existing task flows. Editing an existing task flow would potentially be a simpler task than creating an original one. Caregivers or others associated with the Account, such as Emergency Contacts or an Agency Admin, would also be able to perform editing tasks.

FIGS. 115 and 116 illustrate a portal in which the cognitively disabled user 114, Caregiver, Agency Admin, or Emergency Contact may create a decision tree 123 using the decision tree creation screen. They may use the left side to create it in outline form while it appears on the right side in graphic form. Alternatively, they may click on the right side and add text boxes. Text boxes may be moved, copied, and deleted. As the task flow increases in size, scroll bars allow the cognitively disabled user 117 to view the entire task flow. By not limiting the task flow to a certain size screen, the task flow can extend as needed without shrinking to fit the screen size.

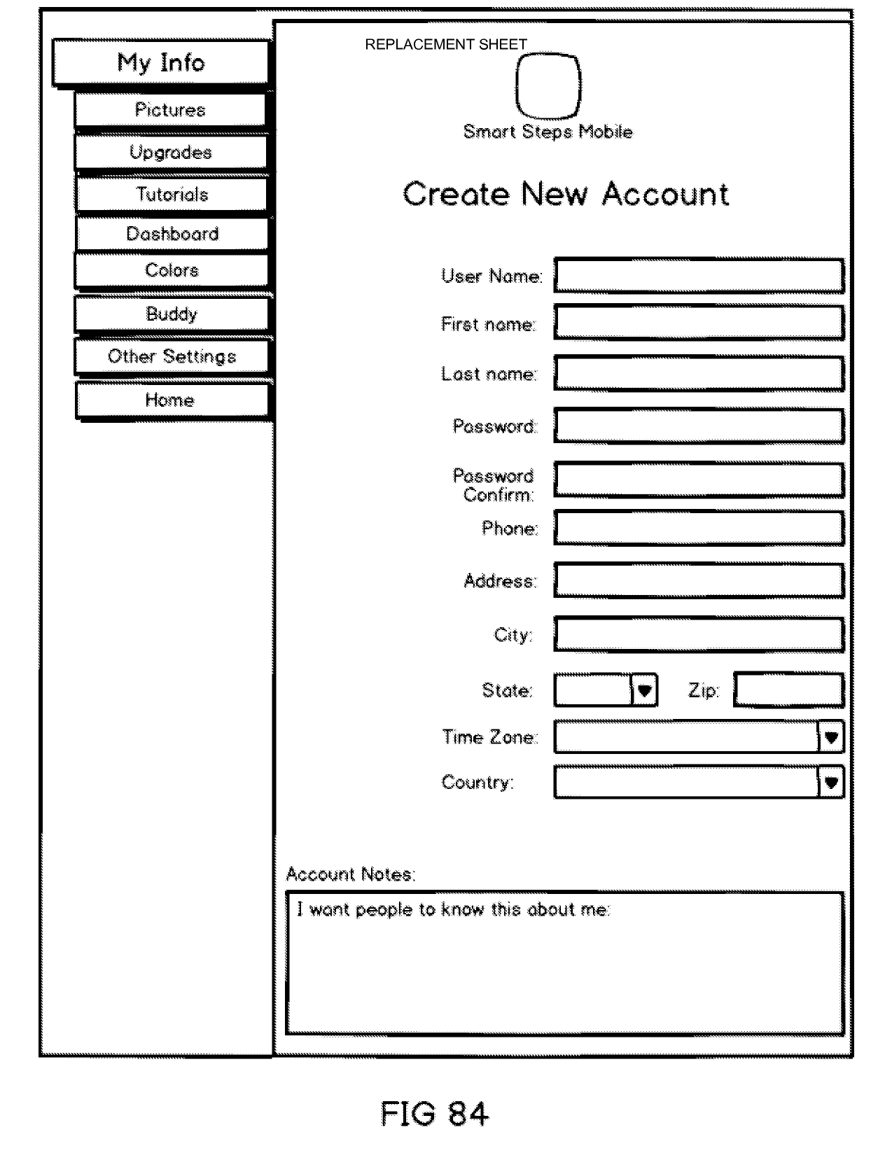

FIGS. 84, 85, 86, 87, 88, 91-93 are representative user settings screens which allows the system user 128 to add visual enhancements including an avatar guide, review, modify or create a user profile or review, edit, add or delete contacts.

In FIG. 84, the system user 128 can create a new account, or a caregiver can assist the user by creating an account. FIG. 85 illustrates a user profile that has been created. The account may be locked or disabled from editing in cases where a caregiver may have guardianship rights and wants the information and settings to remain intact. This may be helpful in cases where a person would make changes, and because of a variety of reasons, would not be in their best interest to do so. For example, they may accidentally make a change that makes the app less useful, or they may wish to delete info that the guardian entered. They may accidentally change subscription plans or make unauthorized purchases. When a caregiver locks the screen, a box will be checked indicating to the User that they cannot make changes. The tabs on this screen (My Info, Pictures, Upgrades, Tutorials, Dashboard, Colors, Buddy, Other Settings, Home) are described in the paragraphs to follow.

FIG. 86 illustrates the Pictures tab. The system user 128 can upload a) pictures of the cognitively disabled user 117 that would appear on the Profile node from the cognitive prosthetic support device 114; b) pictures of Emergency Contacts that would appear by their names on the help screen, c) pictures, audio files, or video files that will be stored in the User's Media Library. Files recently added will be displayed in order to confirm successful uploads. In the illustration, files labeled Work and My School are sample pictures that were recently uploaded.

FIG. 87 is the Upgrade tab which may be accessed by the cognitively disabled user 117 or other system user 128 such as a caregiver (with permission or by helping the cognitively disabled user 117), system user or admin user. The person accessing this page can change the subscription plan, purchase additional task flows or packages, save desired purchases in a wish list, or buy a set of licenses for a group of cognitively disabled users 117.

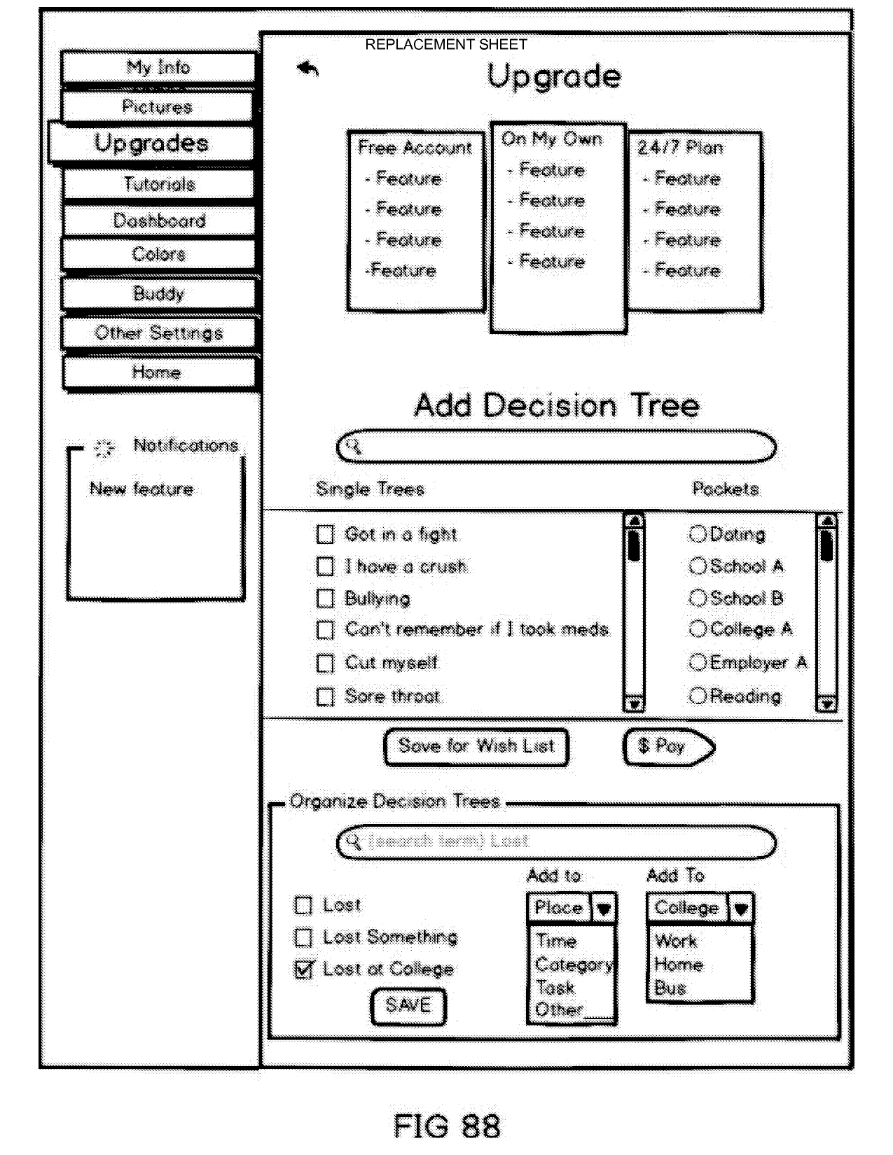

FIG. 88 illustrates a quick way to search, select, and organize task flows using a mobile device view. The cognitively disabled user 117 can search based on a term (such as Lost), select the task flow desired, choose a category, and finally choose a subcategory where the task flow is stored. This mechanism is also available on a web portal where task flows are organized in a more visual display. The tablet provides immediate access when the cognitively disabled user 117 is traveling.

FIG. 89 illustrates Tutorials which are also viewable on the website (FIGS. 23 and 45). Tutorials help the user with cognitive disabilities to access the features of the website. If the User wants to know how to work with task flows, a tutorial video will model the steps.

FIGS. 100, 101 illustrates an example of a resource that will allow for the transmission of messages, including videos from or to a contact or remote operator 130 to assist in progression of the display aid 121 or to provide general assistance as desired. In this way, the system 110 may provide links to audio, video, or multimedia files which provide additional explanation, cues, or models for the cognitively disabled user 117 to address the specific node which will allow for completion of the desired task associated with the selected display aid 121. Push notifications may be sent as shown in FIG. 106 that cue a user after, for example, a period of inactivity.

FIGS. 100, 101, 107, 108, 109, and 110 illustrate an example of a resource that will allow for the transmission of messages, including videos from or to a contact or remote operator 130 to assist in progression of the display aid 121 or to provide general assistance as desired. In this way, the system 110 may provide links to audio, video, or multimedia files which provide additional explanation, cues, or models for the cognitively disabled user 117 to address the specific node which will allow for completion of the desired task associated with the selected display aid 121. If the cognitively disabled user 117 becomes confused or needs additional assistance they may contact a contact from their list of contacts or they may contact the remote operator 130 associated with the remote call center server 116 using either text or vocal requests. In this way, the system 110 allows the cognitively disabled user 117 to utilize the programmed display aids 121 while providing the flexibility to overcome an obstacle with a realtime request for support to a remote operator 130 or pre-programmed contact which may also include emergency responders who can come to the aid of the cognitively disabled user 117. Optionally, one of the remote operators 130 may contact an emergency responder based upon received device data, including but not limited to account data, geolocation information like GPS coordinates, and display aid information or system status. In one embodiment, this information may be electronically transmitted to the emergency responders via the communications network.

As illustrated in FIG. 92 the system 110 may provide visual aids which may take the form of an avatar guide, buddy, hero character, sidekick or mascot. The avatar may be customized and given a name. Another display aid may be a live chat or live video call or a live holographic image of the remote operator 130 or guide. Another display aid may be a prerecorded 3D or holographic image of the avatar guide or other guide providing an explanation or demonstrating an action for the user. As an example, the cognitively disabled user 117 may chose to ask someone nearby for directions but they are not sure how to ask. The avatar guide can visually demonstrate how to preform the desired choice by providing animated movement such as, but not limited to, body language, tone, facial expression, and verbiage as a guide for the user to perform the task. This may be configured by the system user 128 during system configuration as indicated in FIG. 92.

FIGS. 98, 104, 105, 106 and 111 allow the cognitively disabled user 117 to provide adaptive feedback to the system 110 or the remote operator 130. In this way, the system 110 may collect statistical information about usage of display aids 121 by plural cognitively disabled users 117 for refinement or alteration of the display aid 121, to help refine the system 110 or improve the cognitive disability user's 117 system experience and performance of the task associated with the particular display aid 121. If a user is successful in completing a particular display aid 121, then the system 110 may record the success and provide a celebration notification to the user 117. If the user is unsuccessful, then the user feedback screen may be provided for the cognitively disabled user 117 to provide a reason for the lack of success. A feedback button is provided on each screen as shown in FIGS. 54, 103, and 107 which links to survey items provided during configuration of the system 110. For example, in FIG. 111, the cognitively disabled user 117 can select that they did not understand the display aid 121, it contained the wrong information, it was confusing or the user 117 made an error during the node progression. Depending on the selected reason, the system 110 may notify an admin user 129a to review or make changes to the particular decision tree 123, the display aid 121 or the system 110. The collected data may, upon review, provide sufficient information to help the admin user 129a improve the system 110, refine the decision tree 123 or the display aid 121. In addition, the collected data may be helpful to a caregiver or other system user 128 associated with a particular cognitively disabled user's 117 account to identify any medical or cognitive issues associated with the user 117.

The web portal 119 may be a computer associated with a system user 128 or non system user 118 in communication with the system 110 through a networked connection which can be used by a system user 128 for selecting, customizing and creating new decision trees 123 which can be processed by the system 110 to create display aids 121 using the system provided configuration tools available on the user interface through the web portal 119. Starting with the standardized templates, the system 128 user can add, create or customize the selected decision trees 123 which are generally based upon a specific task to be performed by the cognitively disabled user 117 using the cognitive prosthetic support device 114. While in the illustrated embodiment the decision trees reside on the database 115a and the display aids 121 which are processed by the system 110 from the decision trees 123 are generally stored on the content data storage device 113a they may retrievably alternatively retrievably stored on other known and generally understood data storage devices or manners.

The web portal 119 may be utilized to configure the system with various visual elements including providing a particular color scheme as illustrated in FIG. 91. In addition, it may be used to provide relevant user data and contact data which will be retrievably stored within the database 115a for access to the cognitive prosthetic device 114 (in communication with the system 110).

In general, a system and method for computer guided interaction for cognitively disabled users to perform structured tasks using a cognitive prosthetic support device is provided. In one implementation, the system 110 may refer to software executing on a single prosthetic support device 114. In another implementation, the system 110 may refer to software executing on a prosthetic support device 114 and a remote terminal. In another implementation, the system 110 may refer to software executing on a prosthetic support device 114 and a remote server device, the server device associated with the web portal. FIG. 2 is a high level block diagram of a computer device including a system processor which includes static and dynamic memory, a storage device 113a, a display device, an input device and a network connection. An audio device may also be included for real-time assistance. The cognitive prosthetic support device may also include a interactive display, a network connection, a processor, memory and a variety of inputs. The mobile display provides guidance to the cognitively disabled user and allows the user to make selections from displayed choices which are represented by virtual buttons on the display as will be described in more detail later. System memory, read-only memory, flash memory, a battery and a network antenna are coupled to the system processor using a standard circuitry. The network connection allows for receipt and transmission of data to the system or remote terminal as desired.

Table 5, provided below provides a chart with an outline of various possible features for different system components including the Cognitively Disabled User 117, the System User 128, the remote operator 130 or remote call center server 116 and the admin user 129a. Table 5 includes a description of the various processes for each of the listed system components including the Cognitive Disabled User 117, the system user 128, the Remote Operator 130, and the admin user 129a. Although it is understood and intended to be a general description of various processes and may not contain every function described in the above narrative.

TABLE 5
Can Do Chart

| | The System User (user, | | |
|---|---|---|---|
| The Cognitively | guardian, or authorized | | |
| Disabled | person) through the | Remote Operator | The Admin User |
| User (117): | Web Portal (119) to: | (130)/Help Desk: | 129a: |
| 1. Download the | 1. Purchase 1+ | 1. Access | 1. Access |
| mobile app from app stores. | subscriptions for self | profile if account | financial |
| 2. View introductory | or others (various | is active; if user is | information. |
| tutorial. | financial models) | actively using the | 2. Access all |
| 3. Request that tutorial | 2. View tutorials. | app; or if customer | data stored by call |
| not be shown again. | 3. Enter and edit | calls in. | center. |
| 4. View landing screen | profile information for | 2. Information | 3. Access all |
| while pages load (include | each user on a secure | available is limited | data stored by |
| choice of hero character as a | website. | to whether the | user/web portal |
| coach and companion). | 4. Freeze account. | account is | 4. Access |
| 5. Change SETTINGS | 5. Enter and edit | currently active, | usage data for |
| which can be overridden or | contact information, | call center history. | analysis (# users, |
| disabled through the admin | which can also be done | Financial | # customers, |
| portal. | within the app. | information cannot | decision trees |
| 6. SETTINGS: Install | 6. Allow user to | be viewed, only | being used, where |
| personal contacts as support | access a license by | whether the | decision trees are |
| team in the app. | sending an | account is active. | being abandoned, |
| 7. SETTINGS: Opt in | invitation/code which | If account is about | new decision trees |
| to have activity monitored | can be used by one | to go inactive due | added by users or |
| in real time by help desk | device. | to cancellation or | customers) |
| (Visibility) | 7. Adjust | non-payment, this | 5. Access call |
| 8. SETTINGS: Choose | SETTINGS on the app | will appear so the | center response |
| color scheme for personal | (colors, contact list, | call center can | data (# rings or |
| preference or for better | turn edit mode on/off | answer questions | seconds for call |
| visibility for users with | within the app; | or mention it to the | center to respond, |
| visual impairments. | location tracking; push | user when they call | comments per |
| 9. SETTINGS: Choose | notifications, visibility, | in. | staff member, user |
| whether to receive push | voice, font type and | 3. View user | history, usage by |
| notifications. | size, hero character, | when they log into | user in |
| 10. Use search (text or | 3D, wearables, near | the app. | minutes/texts, |
| speech) function to find | point technology, | 4. View | decision tree |
| appropriate decision tree. | biosensors) through a | sequence of steps | usage per user and |
| 11. Choose relevant | website. | the user has tried | aggregate) |
| decision tree by pressing | 8. Add decision | in real time and | 6. Access |
| button. | trees to favorites. | when they request | community site |
| 12. EDIT: Add decision | 9. Remove | help, at user's | where decision |
| trees to favorites. | decision trees. | option. | trees are |
| 13. EDIT: Remove | 10. Customize | 5. Send push | submitted and |
| decision trees not needed | existing decision trees | notification to | shared |
| through the edit mode. | (edit text, adjust | encourage user to | 7. Access |
| 14. Categorize decision | options, add | call for help if | multimedia clips |
| trees in folders. | personalized audio | predetermined | submitted for |
| 15. Utilize text to | clip, video clip, | amount of time has | sharing. |
| speech function to read | picture, enable and edit | passed with no | 8. Review |
| aloud by pressing a button | push notification). | action. | and delete |
| on the screen or verbal | 11. Create custom, | 6. Send push | decision trees as |
| command. This allows | original decision trees | notification as a | needed. |
| choice in the moment. | with audio, video, | celebration when | 9. Review |
| 16. From selection of 2+ | pictures, text, push | user has indicated | and delete |
| choices per screen, make | notifications. | the problem was | multimedia clips |
| choice. | 12. SUBMIT and | solved. | as needed. |
| 17. Go back a screen by | share original decision | 7. Send | 10. Add |
| pressing a back arrow or | tree for community | customized push | extensions of |
| verbal command. | use. | notifications | days, minutes or |
| 18. Return to home | 13. SUBMIT and | designed and | texts on individual |
| screen by pressing a button | share modified | scheduled through | accounts (override |
| or verbal command. | decision tree for | the admin portal. | cancellation or |
| 19. Press panic button to | community use. | 8. Send | frozen accounts). |
| open up backup support | 14. Sort and | custom push | 11. Create/add |
| screen or through a verbal | organize decision trees | notifications | new decision |
| commend.. | into predetermined | during a coaching | trees. |
| 20. On backup support | categories. | call to help with a | 12. Create/add |
| screen, choose personal | 15. Sort and | specific | multimedia clips. |
| contacts or help desk | organize decision trees | circumstance. | 13. Create and |
| button. | into custom categories. | 9. Respond to | add tutorials. |
| 21. Choose which | 16. Activate | user requests for | 14. Manage |
| contact would be preferred | decision trees | help using app | community |
| in the moment | according to location | 10. Respond to | sharing of |
| 22. Choose to text or | triggered by location- | user request for | decision trees |
| make a live call, chat, video | based technology. | help with | (approve, evaluate |
| chat, or 3D image to contact | 17. Determine wait | technology | usage, delete). |
| the backup support | time before sending | 11. Sign in | 15. Manage |
| person/call center. | push notifications | with credentials so | list of users: view, |
| 23. Tell whether the live | regarding inaction. | notes are tied to | add, edit, delete, |
| help desk is available by | 18. Create custom | staff person. | email. |
| seeing grayed out buttons | push notifications. | 12. User | |
| and a link to the website for | 19. Determine a | history will include | |
| more information about | schedule for custom | # calls, length of | |
| subscribing. | push notifications. | calls, # texts on an | |
| 24. Automatically | 20. Push | hourly basis and | |
| receive prompts for social | notifications can be | tied to decision | |
| skills, safety tips, or | text, video, audio, live | trees selected, | |
| practical suggestions related | chat, holographic | decision trees | |
| to a specific step through a | images. | created, decision | |
| popup screen. | 21. Push | trees modified by | |
| 25. Access location- | notifications can be | user. | |
| based technology (map, | selected from the | 13. Can modify | |
| nearby business, person) to | portal or original. | decision tree at | |
| assist. | 22. Share push | user request. | |
| 26. Receive prompt to | notifications on the | 14. Use script | |
| call within the decision tree | community sharing tab | for coaching per | |
| when unable to resolve the | 23. Tie app into bio | call center manual. | |
| issue. | sensors that come | 15. Contact | |
| 27. Receive push out | available (heartrate, | backup support | |
| notification after a | respiration, etc.) | contacts as needed. | |
| determined length of time. | 24. Sign up to | 16. Contact | |
| 28. Receive assistance | receive email alerts for | local emergency | |
| from the call center by | user activity in real | response as | |
| viewing a video clip, | time and/or | needed. | |
| picture, 3D image, or | periodically. | | |
| holographic image. | 25. Sign up to | | |
| 29. Listen to tips via | receive email/call/text | | |
| audio clip. | if usage rate is | | |
| 30. Watch demos or tips | reaching the monthly | | |
| via video clips, live chat, | limit. | | |
| 3D or holographic images. | 26. SETTINGS: | | |
| 31. See picture cues for | Turn on/off in-app | | |
| relevant steps. | purchases. | | |
| 32. View celebratory | 27. Option to pay | | |
| screen when problem is | for additional minutes | | |
| solved. | or upgrade for the | | |
| 33. EDIT: Customize | month on a one time | | |
| wording for a particular step | basis or as an in-app | | |
| by entering an edit mode if | purchase. | | |
| turned on in settings. | 28. When setting | | |
| 34. EDIT: Add video | up account, set login | | |
| clips by entering an edit | name, password and | | |
| mode if turned on in | privacy questions. | | |
| settings. | 29. Enter | | |
| 35. EDIT: Add audio | Emergency Contacts | | |
| clips by entering an edit | and number in order to | | |
| mode if turned on in | appear in app. | | |
| settings. | Determine contact to | | |
| 36. EDIT: Add original | appear on My Info | | |
| decision tree in edit mode | screen and | | |
| through the app if turned on | communication mode | | |
| in edit mode. Use voice, | preferred (text, voice, | | |
| text, pics, video. | email). | | |
| 37. FOR FLIP | 30. Assign | | |
| PHONES, text messaging | permission to | | |
| option | emergency contacts to | | |
| 38. SETTINGS: Choose | access or edit profile | | |
| voice. | and settings, receive | | |
| 39. Learn if account is | emergency alerts, etc. | | |
| going inactive in the near | | | |
| future due to nonpayment or | | | |
| cancellation (push | | | |
| notification). | | | |
| 40. Receive push | | | |
| notification if plan limit is | | | |
| about to be reached, has | | | |
| been reached. | | | |
| 41. SETTINGS: in app | | | |
| purchases on/off can be | | | |
| overridden through web | | | |
| portal | | | |
| 52. Log into app | | | |
| 43. Change password. | | | |
| 44. Use forgot password | | | |
| feature. | | | |
| 45. Respond to change | | | |
| or forgot password | | | |
| questions. | | | |
| 46. Press a profile ” | | | |
| button which displays user | | | |
| name and emergency phone | | | |
| number. This can be shown | | | |
| to a person in the immediate | | | |
| environment. Button allows | | | |
| immediate communication | | | |
| with emergency contact via | | | |
| voice or text. | | | |
| 47. Choose hero | | | |
| character, mascot, or | | | |
| sidekick. Give it a name. | | | |

It is to be understood that while certain forms of the present invention have been illustrated and described herein, it is not to be limited to the specific forms or arrangement of parts described and shown.

What is claimed and desired to be secured by Letters Patent:

1. A computer-implemented system configured by a system user for guided interaction on a cognitive prosthetic support device of a cognitively disabled user whereby the system provides guidance in the performance of a selected task, said system comprising:
a computer store processing and retrievably storing system data for each of a plurality of interactive nodes wherein each said node presents a plurality of visual cues, said nodes being sequentially arranged and said visual cues being interactive and corresponding to a discrete subpart of the selected task to be preformed;
said plurality of interactive nodes comprising at least a first node, a second node and a success node guide said cognitively disabled user in preforming the selected task;
wherein said first node is presented on the cognitive prosthetic support device with a first visual cue;
said first visual cue being adapted for selection by the cognitively disabled user, whereupon selection of said first interactive visual cue presents a second node on the cognitive prosthetic support device having a second interactive visual cue; said second node being sequential to said first node; and
said second interactive visual cue being adapted for selection by the cognitively disabled user, whereupon selection of said second interactive visual cue presents a success node on the cognitive prosthetic support device having a task completion cue corresponding to the performance of the selected task by the cognitively disabled user.

2. The computer-implemented system of claim 1 further comprising a display aid comprising said first interactive node, said second interactive node and said success node wherein each of said nodes are discrete subparts of the selected task to be performed by the cognitively disabled user.

3. The computer-implemented system of claim 1 further wherein said display aid is processed by said computer store from a decision tree selected from a list of decision trees corresponding to one task selected from a list of tasks to be performed sequentially by the cognitively disabled user.

4. The computer-implemented system of claim 2 further comprising a remote operator with remote access to the computer store for receipt of system data, said remote operator in response to a request for remote assistance, providing assistance to one of a plurality of cognitive prosthetic support devices.
